(19) United States
(12) Patent Application Publication
(10) Pub. No.: US 2018/0192651 A1
(43) Pub. Date: Jul. 12, 2018

(54) THERMAL VOLATILIZATION OF ORCO AGONISTS

(71) Applicant: VANDERBILT UNIVERSITY, Nashville, TN (US)

(72) Inventors: Laurence J. Zwiebel, Nashville, TN (US); Gregory Pask, Riverside, CA (US)

(21) Appl. No.: 15/741,999

(22) PCT Filed: Jul. 12, 2016
(86) PCT No.: PCT/US2016/041918

§ 371 Date: Jan. 4, 2018

Related U.S. Application Data
(60) Provisional application No. 62/191,960, filed on Jul. 13, 2015.

(51) Int. Cl. A01N 43/653; A01N 43/84

(52) U.S. Cl. CPC A01N 43/653; A01M 29/12; A01N 43/84

(57) ABSTRACT

In one aspect, the invention relates to chemical modulators of insect olfactory receptors. In particular, compounds and compositions are provided that can inhibit sensory (e.g., host targeting) functions in airborne insects such as mosquitos. Method of employing such agents, and articles incorporating the same, are also provided. This abstract is intended as a scanning tool for purposes of searching in the particular art and is not intended to be limiting of the present invention.

### CROSS-REFERENCE TO RELATED APPLICATIONS

This Application claims the benefit of U.S. Provisional Application No. 62/191,960, filed on Jul. 13, 2015, which is incorporated herein by reference in its entirety.

### BACKGROUND

Olfaction plays a critical role in insect behaviors among agricultural pests, nuisance insects and disease vectors (Hildebrand et al. (1997) Annu. Rev. Neurosci. 20:595-631). Insect behavior is largely directed by the sensation of environmental olfactory cues (Gilliot, C. (2005) Entomology, 3rd Edition). The ability of an insect to respond to chemical stimuli is necessary for the insect to reproduce, mate, and feed. For example, insects respond to certain chemical stimuli by moving up a chemical gradient to identify and target a host.

This chemotactic behavior contributes to the spread of diseases in humans, such as malaria, encephalitis, and dengue fever; as well as, animal and livestock diseases and can result in severe agricultural crop damage. With regard to human health, the destructive behaviors of disease vector mosquitoes and other insects are driven by the sensory modality of olfaction, making it an important area of study (Carey and Carlson (2011) Proc Natl Acad Sci USA 108: 12987-12995). Mosquitoes, in particular, are believed to principally use olfaction to identify and target sources of bloodmeal for reproductive purposes.

Currently, the primary tool against insect borne diseases and crop damage due to insects is the use of insecticides and other chemicals that kill, attract (to a trap), or repel the insect. However, each of the various forms of insecticide treatment—residual house spraying, crop dusting, insecticide treated clothes, bedding and netting, and chemical larviciding—have drawbacks, including environmental and host toxicity, limited duration, and need for insect contact. Biological larviciding can avoid toxicity issues, but takes time and is quite expensive. Chemoprophylaxis is also expensive and may have unacceptable side effects. Finally, segregating populations is expensive and in many cases, such as in third world countries, impractical.

Thus, while there are many different ways to attack insect pests, and each have contributed substantially to limiting the spread of disease and/or crop damage, they also each have limitations that leave room for substantial improvement. Despite advances in the field, there is still a scarcity of compounds that modulate the insect sensory systems that drive behavior. This need and other needs are satisfied by the present invention.

### SUMMARY

In accordance with the purpose(s) of the invention, as embodied and broadly described herein, the invention, in one aspect, relates to entomology and infectious disease. More particular, the invention relates to methods and compositions for disrupting olfactory processes that underlie many critical behaviors (e.g., host- and plant-targeting) in insects (e.g., mosquitoes and agricultural pests).

Disclosed are methods comprising thermally volatizing a compound having a structure represented by a formula:

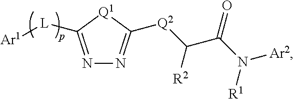

wherein p is an integer selected from 0 and 1; wherein each of Q¹ and Q² is independently selected from O, S, and NR³; wherein R³, when present, is selected from hydrogen, C1-C5 alkyl, and Cy¹; wherein Cy¹, when present, is selected from C1-C5 cycloalkyl and C1-C5 heterocycloalkyl and wherein Cy¹, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino; wherein L is a divalent organic group having from 1 to 9 non-hydrogen members; wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocycloalkyl ring; wherein R² is selected from hydrogen and optionally substituted C1-C4 alkyl; and wherein Ar¹ is selected from aryl and heteroaryl and wherein Ar¹ is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino, or a derivative thereof, thereby forming a volatilization product.

Also disclosed are methods comprising thermally volatizing an insect ORco ion channel agonist, thereby forming a volatilization product, and exposing an ORco ion channel to the volatilization product.

Also disclosed are methods for disrupting odor sensing behavior in an animal having an ORco ion channel, the method comprising thermally volatizing a compound having a structure represented by a formula:

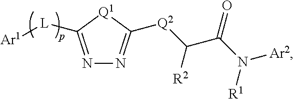

wherein p is an integer selected from 0 and 1; wherein each of Q¹ and Q² is independently selected from O, S, and NR³; wherein R³, when present, is selected from hydrogen, C1-C5 alkyl, and Cy¹; wherein Cy¹, when present, is selected from C1-C5 cycloalkyl and C1-C5 heterocycloalkyl and wherein Cy¹, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino; wherein L is a divalent organic group having from 1 to 9 non-hydrogen members; wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocycloalkyl ring; wherein R² is selected from hydrogen and optionally substituted C1-C4 alkyl; and wherein Ar¹ is selected from aryl and heteroaryl and wherein Ar¹ is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino, or a derivative thereof, thereby forming a volatilization product, and exposing the animal to the volatilization product.

Also disclosed are methods for disrupting odorant sensing in an animal having an ORco ion channel, the method comprising thermally volatizing an ORco ion channel agonist, thereby forming a volatilization product, and exposing the animal to the volatilization product.

Also disclosed are devices comprising: (a) means for thermally volatizing organic compounds; and (b) an ORco ion channel agonist.

Also disclosed are kits comprising an ORco ion channel agonist, and one or more of: (a) means for thermally volatizing organic compounds; and (b) an insect repellant.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1A and FIG. 1B show representative images indicating that thermally volatized compound 3 (1B) elicits odorant receptor-mediated (OR-mediated) electrophysiological responses (transculticular voltage differentials) compared to DCM control (1A) in electroantenoograms from the malaria vector mosquito Anopheles gambiae.

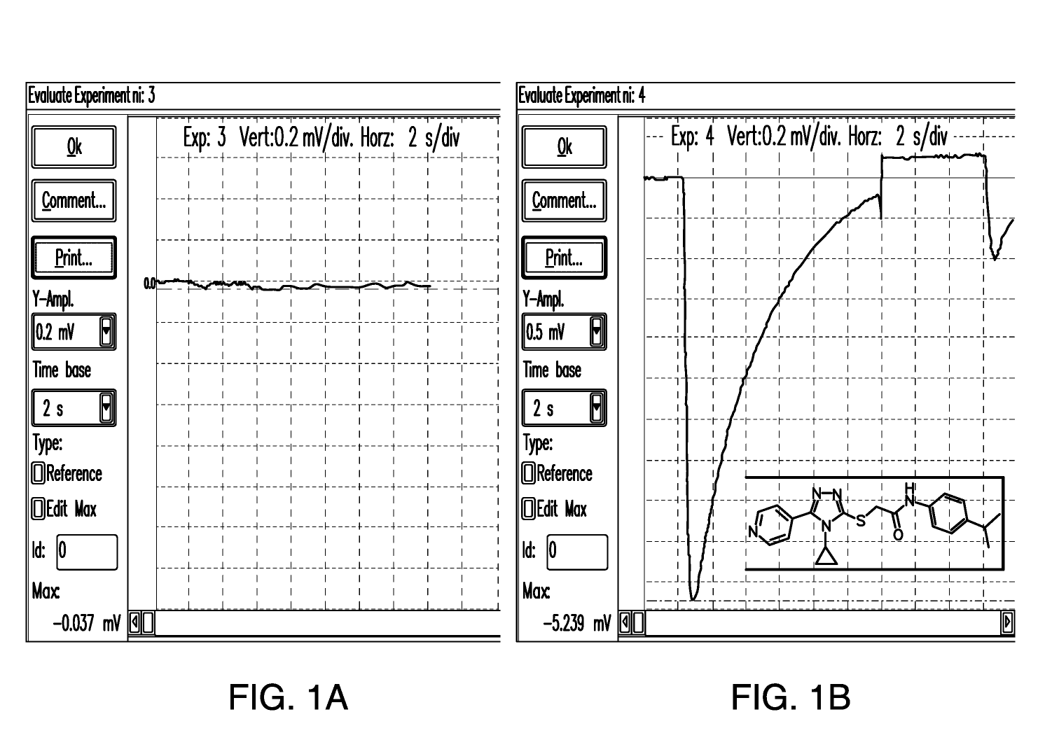

FIG. 2 shows a representative image illustrating the effect of thermally volatized compound 1 on OR-mediated odorant receptor neuron (ORN) action potentials compared to DCM, 1-octen-3-ol, and carbon dioxide in ORN cells expressing OR co-receptor (Orco) from An. gambiae. The large amplitude spikes in response to CO₂ come from ORN cells that do not express Orco.

FIG. 3 shows a representative image illustrating currents induced by thermally volatized compound 2 in odorant receptor neuronal cells expressing Orco from the fruit fly Drosophila melanogaster.

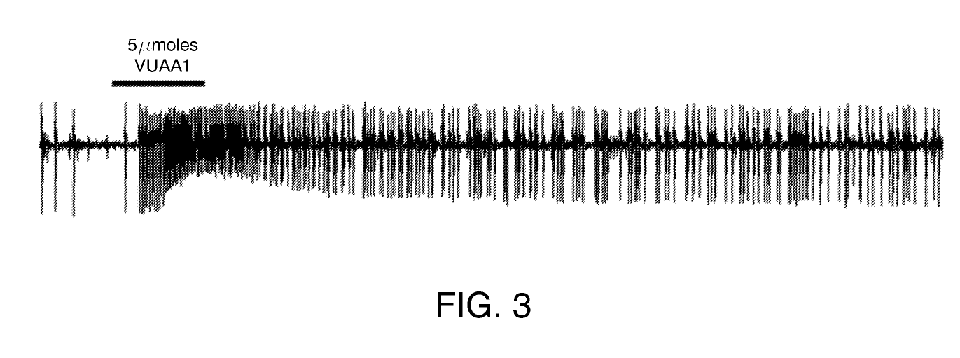

FIG. 4 shows representative data illustrating the effect of thermally volatized compounds 1-4 on OR-mediated currents in maxillary palp cells from An. gambiae.

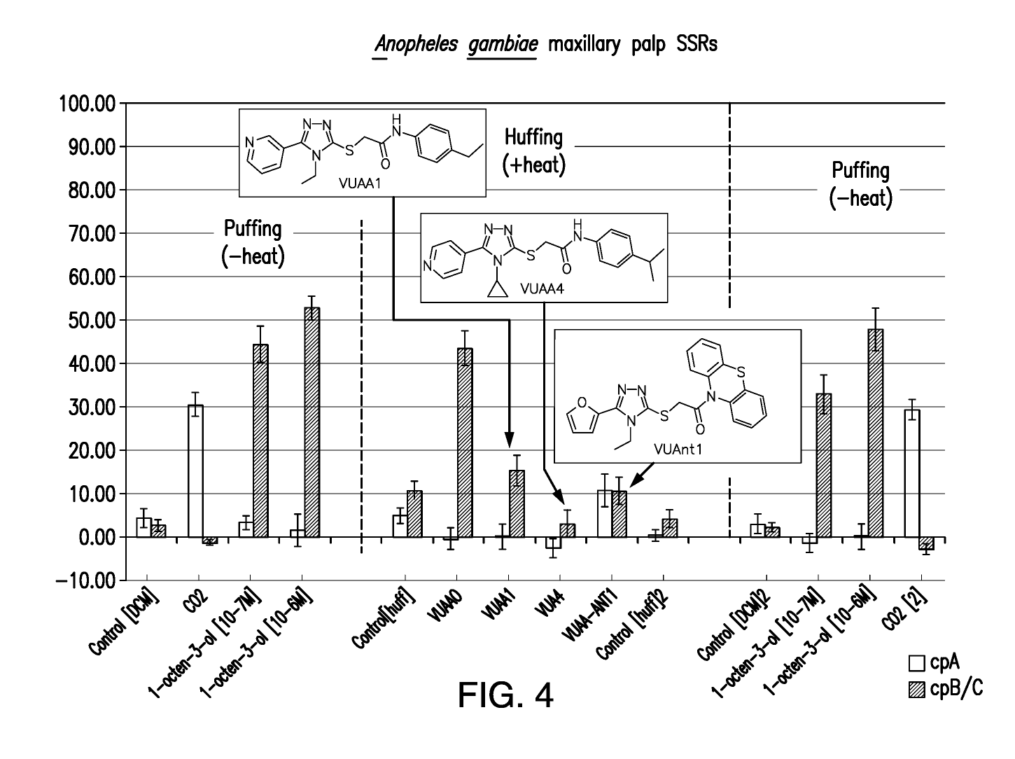

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### A. DEFINITIONS

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or can not occur, and that the description includes instances where said event or circumstance occurs and instances where it does not.

As used herein, the term “allosteric site” refers to a ligand-binding or activation site that is topographically distinct from the orthosteric binding or activation site.

As used herein, the term “modulator” refers to a molecular entity (e.g., but not limited to, a ligand and a disclosed compound) that modulates the activity of the target receptor protein.

As used herein, the term “ligand” refers to a natural or synthetic molecular entity that is capable of associating or binding to a receptor to form a complex and mediate, prevent or modify a biological effect. Thus, the term “ligand” encompasses allosteric modulators, inhibitors, activators, agonists, antagonists, natural substrates and analogs of natural or synthetic substrates.

As used herein, the terms “natural ligand” and “endogenous ligand” are used interchangeably, and refer to a naturally occurring ligand, found in nature, which binds to a receptor.

As used herein, the term “orthosteric site” refers to the primary binding site on a receptor that is recognized by the endogenous ligand or agonist for that receptor.

The term “contacting” as used herein refers to bringing a disclosed compound and a cell, a target receptor, or other biological entity together in such a manner that the compound can affect the activity of the target, either directly; i.e., by interacting with the target itself, or indirectly; i.e., by interacting with another molecule, co-factor, factor, or protein on which the activity of the target is dependent.

As used herein, the terms “effective amount” and “amount effective” refer to an amount that is sufficient to achieve the desired result or to have an effect on an undesired condition.

As used herein, “kit” means a collection of at least two components constituting the kit. Together, the components constitute a functional unit for a given purpose. Individual member components may be physically packaged together or separately. For example, a kit comprising an instruction for using the kit may or may not physically include the instruction with other individual member components. Instead, the instruction can be supplied as a separate member component, either in a paper form or an electronic form which may be supplied on computer readable memory device or downloaded from an internet website, or as recorded presentation.

As used herein, “instruction(s)” means documents describing relevant materials or methodologies pertaining to a kit. These materials may include any combination of the following: background information, list of components and their availability information (purchase information, etc.), brief or detailed protocols for using the kit, trouble-shooting, references, technical support, and any other related documents. Instructions can be supplied with the kit or as a separate member component, either as a paper form or an electronic form which may be supplied on computer readable memory device or downloaded from an internet website, or as recorded presentation. Instructions can comprise one or multiple documents, and are meant to include future updates.

As used herein, “EC₅₀,” is intended to refer to the concentration of a substance (e.g., a compound or a drug) that is required for 50% activation or enhancement of a biological process, or component of a process. For example, EC₅₀ can refer to the concentration of agonist that provokes a response halfway between the baseline and maximum response in an appropriate assay of the target activity.

As used herein, “IC₅₀,” is intended to refer to the concentration of a substance (e.g., a compound or a drug) that is required for 50% inhibition of a biological process, or component of a process. For example, IC₅₀ refers to the half maximal (50%) inhibitory concentration (IC) of a substance as determined in a suitable assay.

In the context of chemical formulas, the symbol “ [symbol] ” means a single bond, “ [symbol] ” means a double bond, and “ [symbol] ” means triple bond. The symbol “ [symbol] ” represents an optional bond, which if present is either single or double. The symbol “ [symbol] ” represents a single bond or a double bond. Thus, for example, the structure

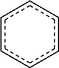

includes the structures

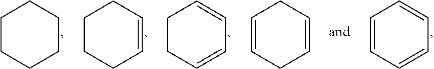

As will be understood by a person of skill in the art, no one such ring atom forms part of more than one double bond. The symbol “ [symbol] ”, when [symbol] drawn perpendicularly across a bond, indicates a point of attachment of the group. It is noted that the point of attachment is typically only identified in this manner for larger groups in order to assist the reader in rapidly and unambiguously identifying a point of attachment. The symbol “ [symbol] ” means a single bond where the group attached to the thick end of the wedge is “out of the page.” The symbol “ [symbol] ” means a single bond where the group attached to the thick end of the wedge is “into the page”. The symbol “ [symbol] ” means a single bond where the conformation (e.g., either R or S) or the geometry is undefined (e.g., either E or Z).

For the groups and classes below, the following parenthetical subscripts further define the group/class as follows: “(Cn)” defines the exact number (n) of carbon atoms in the group/class. “(C≤n)” defines the maximum number (n) of carbon atoms that can be in the group/class, with the minimum number as small as possible for the group in question, e.g., it is understood that the minimum number of carbon atoms in the group “alkenyl_{(C≤8)}” or the class “alkene_{(C≤8)}” is two. For example, “alkoxy_{(C≤10)}” designates those alkoxy groups having from 1 to 10 carbon atoms (e.g., 1, 2, 3, 4, 5, 6, 7, 8, 9, or 10), or any range derivable therein (e.g., 3 to 10 carbon atoms). (Cn-n′) defines both the minimum (n) and maximum number (n′) of carbon atoms in the group. Similarly, “alkyl_{(C2-10)}” designates those alkyl groups having from 2 to 10 carbon atoms (e.g., 2, 3, 4, 5, 6, 7, 8, 9, or 10, or any range derivable therein (e.g., 3 to 10 carbon atoms)).

As used herein, the term “derivative” refers to a compound having a structure derived from the structure of a parent compound (e.g., a compound disclosed herein) and whose structure is sufficiently similar to those disclosed herein and based upon that similarity, would be expected by one skilled in the art to exhibit the same or similar activities and utilities as the claimed compounds, or to induce, as a precursor, the same or similar activities and utilities as the claimed compounds. Exemplary derivatives include salts, esters, amides, salts of esters or amides, and N-oxides of a parent compound.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

In defining various terms, “A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “saturated” as used herein means the compound or group so modified has no carbon-carbon double and no carbon-carbon triple bonds, except as noted below. The term does not preclude carbon-heteroatom multiple bonds, for example a carbon oxygen double bond or a carbon nitrogen double bond. Moreover, it does not preclude a carbon-carbon double bond that may occur as part of keto-enol tautomerism or imine/enamine tautomerism.

When used in the context of a chemical group, “hydrogen” means —H; “hydroxy” and “hydroxyl” can be used interchangeably and mean —OH; “oxo” means ═O; “halo,” “halogen” and “halide”, as used herein can be used interchangeably, mean independently —F, —Cl, —Br or —I; “amino” means —NH₂; “hydroxyamino” means —NHOH; “nitro” means —NO₂; imino means ═NH; “cyano” and “nitrile” can be used interchangeably and mean —CN; “isocyanate” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” and “thiol” can be used interchangeably and mean —SH; and “thio” means ═S; “sulfonyl” means —S(O)₂—; and “sulfinyl” means —S(O)—.

The term “acyl” when used without the “substituted” modifier refers to the group —C(O)R, in which R is a hydrogen, alkyl, aryl, aralkyl or heteroaryl, as those terms are defined above. The groups, —CHO, —C(O)CH₃ (acetyl, Ac), —C(O)CH₂CH₃, —C(O)CH₂CH₂CH₃, —C(O)CH(CH₃)₂, —C(O)CH(CH₂)₂, —C(O)C₆H₅, —C(O)C₆H₄CH₃, —C(O)CH₂C6H₅, —C(O)(imidazolyl) are non-limiting examples of acyl groups. A “thioacyl” is defined in an analogous manner, except that the oxygen atom of the group —C(O)R has been replaced with a sulfur atom, —C(S)R. When either of these terms are used with the “substituted” modifier one or more hydrogen atom (including the hydrogen atom directly attached the carbonyl or thiocarbonyl group) has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂. The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups.

The term “aliphatic” when used without the “substituted” modifier signifies that the compound/group so modified is an acyclic or cyclic, but non-aromatic hydrocarbon compound or group. In aliphatic compounds/groups, the carbon atoms can be joined together in straight chains, branched chains, or non-aromatic rings (alicyclic). Aliphatic compounds/groups can be saturated, that is joined by single bonds (alkanes/alkyl), or unsaturated, with one or more double bonds (alkenes/alkenyl) or with one or more triple bonds (alkynes/alkynyl). When the term “aliphatic” is used without the “substituted” modifier only carbon and hydrogen atoms are present. When the term is used with the “substituted” modifier one or more hydrogen atoms has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂.

The term “alkyl” when used without the “substituted” modifier refers to a monovalent saturated aliphatic group with a carbon atom as the point of attachment, a linear or branched, cyclo, cyclic or acyclic structure, and no atoms other than carbon and hydrogen. Thus, as used herein cycloalkyl is a subset of alkyl. The groups —CH₃ (Me), —CH₂CH₃ (Et), —CH₂CH₂CH₃ (n-Pr), —CH(CH₃)₂(iso-Pr), —CH(CH₂)₂(cyclopropyl), —CH₂CH₂CH₂CH₃ (n-Bu), —CH(CH₃)CH₂CH₃ (sec-butyl), —CH₂CH(CH₃)₂(iso-butyl), —C(CH₃)₃(tert-butyl), —CH₂C(CH₃)₃(neo-pentyl), cyclobutyl, cyclopentyl, cyclohexyl, and cyclohexylmethyl are non-limiting examples of alkyl groups. The term “alkanediyl” when used without the “substituted” modifier refers to a divalent saturated aliphatic group, with one or two saturated carbon atom(s) as the point(s) of attachment, a linear or branched, cyclo, cyclic or acyclic structure, no carbon-carbon double or triple bonds, and no atoms other than carbon and hydrogen. The groups, —CH₂-(methylene), —CH₂CH₂—, —CH₂C(CH₃)₂CH₂—, —CH₂CH₂CH₂—, and

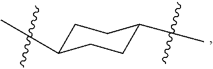 [SMILES: *C1CCC(*)CC1]

are non-limiting examples of alkanediyl groups. The term “alkylidene” when used without the “substituted” modifier refers to the divalent group ═CRR′ in which R and R′ are independently hydrogen, alkyl, or R and R′ are taken together to represent an alkanediyl having at least two carbon atoms. Non-limiting examples of alkylidene groups include: ═CH₂, ═CH(CH₂CH₃), and ═C(CH₃)₂. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂. The following groups are non-limiting examples of substituted alkyl groups: —CH₂OH, —CH₂C1, —CF₃, —CH₂CN, —CH₂C(O)OH, —CH₂C(O)OCH₃, —CH₂C(O)NH₂, —CH₂C(O)CH₃, —CH₂OCH₃, —CH₂OC(O)CH₃, —CH₂NH₂, —CH₂N(CH₃)₂, and —CH₂CH₂C1. An “alkane” refers to the compound H—R, wherein R is alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. The term “halogenated alkyl” or “haloalkyl” is a subset of substituted alkyl, in which one or more hydrogens has been substituted with a halo group (i.e., fluorine, chlorine, bromine, or iodine) and no other atoms aside from carbon, hydrogen and halogen are present. The group, —CH₂C1 is a non-limiting example of a haloalkyl. The term “fluoroalkyl” is a subset of substituted alkyl, in which one or more hydrogens has been substituted with a fluoro group and no other atoms aside from carbon, hydrogen and fluorine are present. The groups, —CH₂F, —CF₃, and —CH₂CF₃ are non-limiting examples of fluoroalkyl groups. An “alkane” refers to the compound H—R, wherein R is alkyl. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbomyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, cycloalkyl, alkoxy, amino, ether, halide, hydroxy, nitro, silyl, sulfo-oxo, or thiol as described herein.

The term “alkoxy” when used without the “substituted” modifier refers to the group —OR, in which R is an alkyl, as that term is defined above. Non-limiting examples of alkoxy groups include: —OCH₃, —OCH₂CH₃, —OCH₂CH₂CH₃, —OCH(CH₃)₂, —OCH(CH₂)₂, —O-cyclopentyl, and —O-cyclohexyl. The terms “alkenyloxy”, “alkynyloxy”, “aryloxy”, “aralkoxy”, “heteroaryloxy”, and “acyloxy”, when used without the “substituted” modifier, refers to groups, defined as —OR, in which R is alkenyl, alkynyl, aryl, aralkyl, heteroaryl, and acyl, respectively. The term “alkoxydiyl” refers to the divalent group —O-alkanediyl-, —O— alkanediyl-O—, or -alkanediyl-O-alkanediyl-. The term “alkylthio” when used without the “substituted” modifier refers to the group —SR, in which R is an alkyl, as that term is defined above. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂. The term “alcohol” corresponds to an alkane, as defined above, wherein at least one of the hydrogen atoms has been replaced with a hydroxy group.

The term “alkenyl” when used without the “substituted” modifier refers to an monovalent unsaturated aliphatic group with a carbon atom as the point of attachment, a linear or branched, cyclo, cyclic or acyclic structure, at least one nonaromatic carbon-carbon double bond, no carbon-carbon triple bonds, and no atoms other than carbon and hydrogen. Non-limiting examples of alkenyl groups include: —CH═CH₂ (vinyl), —CH═CHCH₃, —CH═CHCH₂CH₃, —CH₂CH═CH₂ (allyl), —CH₂CH═CHCH₃, and —CH═CH—C₆H₅. The term “alkenediyl” when used without the “substituted” modifier refers to a divalent unsaturated aliphatic group, with two carbon atoms as points of attachment, a linear or branched, cyclo, cyclic or acyclic structure, at least one nonaromatic carbon-carbon double bond, no carbon-carbon triple bonds, and no atoms other than carbon and hydrogen. The groups, —CH═CH—, —CH═C(CH₃)CH₂—, —CH═CHCH₂—, and

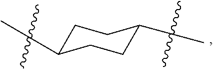 [SMILES: *C1CCC(*)CC1]

are non-limiting examples of alkenediyl groups. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂. The groups, —CH═CHF, —CH═CHCl and —CH═CHBr, are non-limiting examples of substituted alkenyl groups. An “alkene” refers to the compound H—R, wherein R is alkenyl.

The term “cycloalkenyl” as used herein is a non-aromatic carbon-based ring composed of at least three carbon atoms and containing at least one carbon-carbon double bound, i.e., C═C. Cycloalkenyl is a subset of alkenyl. Examples of cycloalkenyl groups include, but are not limited to, cyclopropenyl, cyclobutenyl, cyclopentenyl, cyclopentadienyl, cyclohexenyl, cyclohexadienyl, norbomenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” as used herein is a hydrocarbon group of 2 to 24 carbon atoms with a structural formula containing at least one carbon-carbon triple bond. The alkynyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “alkynyl” when used without the “substituted” modifier refers to a monovalent unsaturated aliphatic group with a carbon atom as the point of attachment, a linear or branched, cyclo, cyclic or acyclic structure, at least one carbon-carbon triple bond, and no atoms other than carbon and hydrogen. As used herein, the term alkynyl does not preclude the presence of one or more non-aromatic carbon-carbon double bonds. The groups, —C≡CH, —C≡CCH₃, and —CH₂C≡CCH₃, are non-limiting examples of alkynyl groups. When alkynyl is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂. An “alkyne” refers to the compound H—R, wherein R is alkynyl.

The term “cycloalkynyl” as used herein is a non-aromatic carbon-based ring composed of at least seven carbon atoms and containing at least one carbon-carbon triple bound, and is a subset of those groups specified by the term “alkynyl.” Examples of cycloalkynyl groups include, but are not limited to, cycloheptynyl, cyclooctynyl, cyclononynyl, and the like. The term “heterocycloalkynyl” is a type of cycloalkenyl group as defined above, and is included within the meaning of the term “cycloalkynyl,” where at least one of the carbon atoms of the ring is replaced with a heteroatom such as, but not limited to, nitrogen, oxygen, sulfur, or phosphorus. The cycloalkynyl group and heterocycloalkynyl group can be substituted or unsubstituted. The cycloalkynyl group and heterocycloalkynyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aromatic group” as used herein refers to a ring structure having cyclic clouds of delocalized π electrons above and below the plane of the molecule, where the π clouds contain (4n+2) π electrons. A further discussion of aromaticity is found in Morrison and Boyd, Organic Chemistry, (5th Ed., 1987), Chapter 13, entitled “Aromaticity,” pages 477-497, incorporated herein by reference. The term “aromatic group” is inclusive of both aryl and heteroaryl groups.

The term “aryl” when used without the “substituted” modifier refers to a monovalent unsaturated aromatic group with an aromatic carbon atom as the point of attachment, said carbon atom forming part of a one or more six-membered aromatic ring structure, wherein the ring atoms are all carbon, and wherein the group consists of no atoms other than carbon and hydrogen. If more than one ring is present, the rings may be fused or unfused. As used herein, the term does not preclude the presence of one or more alkyl group (carbon number limitation permitting) attached to the first aromatic ring or any additional aromatic ring present. Non-limiting examples of aryl groups include phenyl (Ph), methylphenyl, (dimethyl)phenyl, —C₆H₄CH₂CH₃ (ethylphenyl), naphthyl, and the monovalent group derived from biphenyl. The term “arenediyl” when used without the “substituted” modifier refers to a divalent aromatic group, with two aromatic carbon atoms as points of attachment, said carbon atoms forming part of one or more six-membered aromatic ring structure(s) wherein the ring atoms are all carbon, and wherein the monovalent group consists of no atoms other than carbon and hydrogen. As used herein, the term does not preclude the presence of one or more alkyl group (carbon number limitation permitting) attached to the first aromatic ring or any additional aromatic ring present. If more than one ring is present, the rings may be fused or unfused. Non-limiting examples of arenediyl groups include:

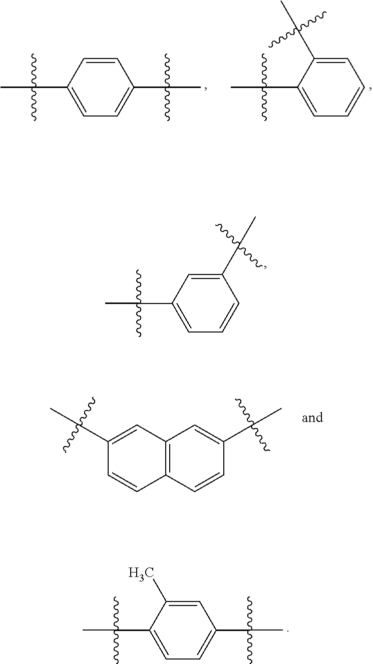

When the term “aryl” is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂. An “arene” refers to the compound H—R, wherein R is aryl.

The term “aldehyde” as used herein is represented by the formula —C(O)H. Throughout this specification “C(O)” is a short hand notation for a carbonyl group, i.e., C═O.

The term “alkylamino” when used without the “substituted” modifier refers to the group —NHR, in which R is an alkyl, as that term is defined above. Non-limiting examples of alkylamino groups include: —NHCH₃ and —NHCH₂CH₃. The term “dialkylamino” when used without the “substituted” modifier refers to the group —NRR′, in which R and R′ can be the same or different alkyl groups, or R and R′ can be taken together to represent an alkanediyl. Non-limiting examples of dialkylamino groups include: —N(CH₃)₂, —N(CH₃)(CH₂CH₃), and N-pyrrolidinyl. The terms “alkoxyamino”, “alkenylamino”, “alkynylamino”, “arylamino”, “aralkylamino”, “heteroarylamino”, and “alkylsulfonylamino” when used without the “substituted” modifier, refers to groups, defined as —NHR, in which R is alkoxy, alkenyl, alkynyl, aryl, aralkyl, heteroaryl, and alkylsulfonyl, respectively. A non-limiting example of an arylamino group is —NHC₆H₅. The term “amido” (acylamino), when used without the “substituted” modifier, refers to the group —NHR, in which R is acyl, as that term is defined above. A non-limiting example of an amido group is —NHC(O)CH₃. The term “alkylimino” when used without the “substituted” modifier refers to the divalent group ═NR, in which R is an alkyl, as that term is defined above. The term “alkylaminodiyl” refers to the divalent group —NH-alkanediyl-, —NH-alkanediyl-NH—, or -alkanediyl-NH-alkanediyl-. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂. The groups —NHC(O)OCH₃ and —NHC(O)NHCH₃ are non-limiting examples of substituted amido groups.

The term “aralkyl” when used without the “substituted” modifier refers to the monovalent group-alkanediyl-aryl, in which the terms alkanediyl and aryl are each used in a manner consistent with the definitions provided above. Non-limiting examples of aralkyls are: phenylmethyl (benzyl, Bn) and 2-phenyl-ethyl. When the term is used with the “substituted” modifier one or more hydrogen atom from the alkanediyl and/or the aryl has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂. Non-limiting examples of substituted aralkyls are: (3-chlorophenyl)-methyl, and 2-chloro-2-phenyl-eth-1-yl.

The term “carboxylic acid” as used herein is represented by the formula —C(O)OH.

The term “dialkylamino” as used herein is represented by the formula —N(-alkyl)₂ where alkyl is a described herein. Representative examples include, but are not limited to, dimethylamino group, diethylamino group, dipropylamino group, diisopropylamino group, dibutylamino group, diisobutylamino group, di(sec-butyl)amino group, di(tert-butyl)amino group, dipentylamino group, diisopentylamino group, di(tert-pentyl)amino group, dihexylamino group, N-ethyl-N-methylamino group, N-methyl-N-propylamino group, N-ethyl-N-propylamino group and the like.

The term “ester” as used herein is represented by the formula —OC(O)A¹ or —C(O)OA¹, where A¹ can be alkyl, cycloalkyl, alkenyl, cycloalkenyl, alkynyl, cycloalkynyl, aryl, or heteroaryl group as described herein. The term “polyester” as used herein is represented by the formula -(A¹O(O)C-A²-C(O)O)ₐ— or -(A¹O(O)C-A²-OC(O))ₐ—, where A¹ and A² can be, independently, an alkyl, cycloalkyl, alkenyl, cycloalkenyl, alkynyl, cycloalkynyl, aryl, or heteroaryl group described herein and “a” is an integer from 1 to 500. “Polyester” is as the term used to describe a group that is produced by the reaction between a compound having at least two carboxylic acid groups with a compound having at least two hydroxyl groups.

The term “ether” as used herein is represented by the formula A¹OA², where A¹ and A² can be, independently, an alkyl, cycloalkyl, alkenyl, cycloalkenyl, alkynyl, cycloalkynyl, aryl, or heteroaryl group described herein. The term “polyether” as used herein is represented by the formula -(A¹O-A²O)ₐ—, where A¹ and A² can be, independently, an alkyl, cycloalkyl, alkenyl, cycloalkenyl, alkynyl, cycloalkynyl, aryl, or heteroaryl group described herein and “a” is an integer of from 1 to 500. Examples of polyether groups include polyethylene oxide, polypropylene oxide, and polybutylene oxide.

The term “heteroalkyl,” as used herein refers to an alkyl group containing at least one heteroatom. Suitable heteroatoms include, but are not limited to, O, N, Si, P and S, wherein the nitrogen, phosphorous and sulfur atoms are optionally oxidized, and the nitrogen heteroatom is optionally quaternized. Heteroalkyls can be substituted as defined above for alkyl groups.

The term “heteroaryl” when used without the “substituted” modifier refers to a monovalent aromatic group with an aromatic carbon atom or nitrogen atom as the point of attachment, said carbon atom or nitrogen atom forming part of one or more aromatic ring structures wherein at least one of the ring atoms is nitrogen, oxygen or sulfur, and wherein the heteroaryl group consists of no atoms other than carbon, hydrogen, aromatic nitrogen, aromatic oxygen and aromatic sulfur. As used herein, the term does not preclude the presence of one or more alkyl, aryl, and/or aralkyl groups (carbon number limitation permitting) attached to the aromatic ring or aromatic ring system. If more than one ring is present, the rings may be fused or unfused. Non-limiting examples of heteroaryl groups include furanyl, imidazolyl, indolyl, indazolyl (Im), isoxazolyl, methylpyridinyl, oxazolyl, phenylpyridinyl, pyridinyl, pyrrolyl, pyrimidinyl, pyrazinyl, quinolyl, quinazolyl, quinoxalinyl, triazinyl, tetrazolyl, thiazolyl, thienyl, and triazolyl. The term “heteroarenediyl” when used without the “substituted” modifier refers to an divalent aromatic group, with two aromatic carbon atoms, two aromatic nitrogen atoms, or one aromatic carbon atom and one aromatic nitrogen atom as the two points of attachment, said atoms forming part of one or more aromatic ring structure(s) wherein at least one of the ring atoms is nitrogen, oxygen or sulfur, and wherein the divalent group consists of no atoms other than carbon, hydrogen, aromatic nitrogen, aromatic oxygen and aromatic sulfur. As used herein, the term does not preclude the presence of one or more alkyl, aryl, and/or aralkyl groups (carbon number limitation permitting) attached to the aromatic ring or aromatic ring system. If more than one ring is present, the rings may be fused or unfused. Non-limiting examples of heteroarenediyl groups include:

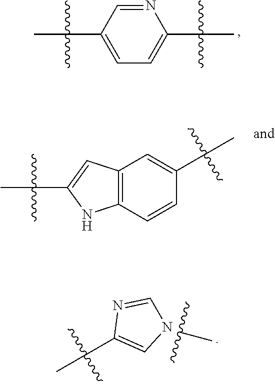

When the term “heteroaryl” is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂.

The terms “heterocycle” or “heterocyclyl,” as used herein can be used interchangeably and refer to single and multi-cyclic aromatic or non-aromatic ring systems in which at least one of the ring members is other than carbon. Thus, the term is inclusive of, but not limited to, “heterocycloalkyl”, “heteroaryl”, “bicyclic heterocycle” and “polycyclic heterocycle.” Heterocycle includes pyridine, pyrimidine, furan, thiophene, pyrrole, isoxazole, isothiazole, pyrazole, oxazole, thiazole, imidazole, oxazole, including, 1,2,3-oxadiazole, 1,2,5-oxadiazole and 1,3,4-oxadiazole, thiadiazole, including, 1,2,3-thiadiazole, 1,2,5-thiadiazole, and 1,3,4-thiadiazole, triazole, including, 1,2,3-triazole, 1,3,4-triazole, tetrazole, including 1,2,3,4-tetrazole and 1,2,4,5-tetrazole, pyridazine, pyrazine, triazine, including 1,2,4-triazine and 1,3,5-triazine, tetrazine, including 1,2,4,5-tetrazine, pyrrolidine, piperidine, piperazine, morpholine, azetidine, tetrahydropyran, tetrahydrofuran, dioxane, and the like. The term heterocyclyl group can also be a C2 heterocyclyl, C2-C3 heterocyclyl, C2-C4 heterocyclyl, C2-C5 heterocyclyl, C2-C6 heterocyclyl, C2-C7 heterocyclyl, C2-C8 heterocyclyl, C2-C9 heterocyclyl, C2-C10 heterocyclyl, C2-C11 heterocyclyl, and the like up to and including a C2-C18 heterocyclyl. For example, a C2 heterocyclyl comprises a group which has two carbon atoms and at least one heteroatom, including, but not limited to, aziridinyl, diazetidinyl, dihydrodiazetyl, oxiranyl, thiiranyl, and the like. Alternatively, for example, a C5 heterocyclyl comprises a group which has five carbon atoms and at least one heteroatom, including, but not limited to, piperidinyl, tetrahydropyranyl, tetrahydrothiopyranyl, diazepanyl, pyridinyl, and the like. It is understood that a heterocyclyl group may be bound either through a heteroatom in the ring, where chemically possible, or one of carbons comprising the heterocyclyl ring.

The term “bicyclic heterocycle” or “bicyclic heterocyclyl,” as used herein refers to a ring system in which at least one of the ring members is other than carbon. Bicyclic heterocyclyl encompasses ring systems wherein an aromatic ring is fused with another aromatic ring, or wherein an aromatic ring is fused with a non-aromatic ring. Bicyclic heterocyclyl encompasses ring systems wherein a benzene ring is fused to a 5- or a 6-membered ring containing 1, 2 or 3 ring heteroatoms or wherein a pyridine ring is fused to a 5- or a 6-membered ring containing 1, 2 or 3 ring heteroatoms. Bicyclic heterocyclic groups include, but are not limited to, indolyl, indazolyl, pyrazolo[1,5-a]pyridinyl, benzofuranyl, quinolinyl, quinoxalinyl, 1,3-benzodioxolyl, 2,3-dihydro-1,4-benzodioxinyl, 3,4-dihydro-2H-chromenyl, 1H-pyrazolo[4,3-c]pyridin-3-yl; 1H-pyrrolo[3,2-b]pyridin-3-yl; and 1H-pyrazolo[3,2-b]pyridin-3-yl.

The term “heterocycloalkyl” when used without the “substituted” modifier refers to a monovalent non-aromatic group with a carbon atom or nitrogen atom as the point of attachment, said carbon atom or nitrogen atom forming part of one or more non-aromatic ring structures wherein at least one of the ring atoms is nitrogen, oxygen or sulfur, and wherein the heterocycloalkyl group consists of no atoms other than carbon, hydrogen, nitrogen, oxygen and sulfur. As used herein, the term does not preclude the presence of one or more alkyl groups (carbon number limitation permitting) attached to the ring or ring system. If more than one ring is present, the rings may be fused or unfused. Non-limiting examples of heterocycloalkyl groups include aziridinyl, pyrrolidinyl, piperidinyl, piperazinyl, morpholinyl, thiomorpholinyl, tetrahydrofuranyl, tetrahydrothiofuranyl, tetrahydropyranyl, and pyranyl. When the term “heterocycloalkyl” is used with the “substituted” modifier, one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —N(CH₃)₂, —C(O)NH₂, —OC(O)CH₃, or —S(O)₂NH₂.

The term “ketone” as used herein is represented by the formula A¹C(O)A², where A¹ and A² can be, independently, an alkyl, cycloalkyl, alkenyl, cycloalkenyl, alkynyl, cycloalkynyl, aryl, or heteroaryl group as described herein.

The term “polyalkylene group” as used herein is a group having two or more CH₂ groups linked to one another. The polyalkylene group can be represented by the formula —(CH₂)ₐ—, where “a” is an integer of from 2 to 500.

The terms “pseudohalide,” “pseudohalogen” or “pseudohalo,” as used herein can be used interchangeably and refer to functional groups that behave substantially similar to halides. Such functional groups include, by way of example, cyano, thiocyanato, azido, trifluoromethyl, trifluoromethoxy, perfluoroalkyl, and perfluoroalkoxy groups.

The term “silyl” as used herein is represented by the formula —SiA¹A²A³, where A¹, A², and A³ can be, independently, hydrogen or an alkyl, cycloalkyl, alkoxy, alkenyl, cycloalkenyl, alkynyl, cycloalkynyl, aryl, or heteroaryl group as described herein.

The term “sulfo-oxo” as used herein is represented by the formulas —S(O)A¹, —S(O)₂A¹, —OS(O)₂A¹, or —OS(O)₂OA¹, where A¹ can be hydrogen or an alkyl, cycloalkyl, alkenyl, cycloalkenyl, alkynyl, cycloalkynyl, aryl, or heteroaryl group as described herein. Throughout this specification “S(O)” is a short hand notation for S═O. The term “sulfone” as used herein is represented by the formula A¹S(O)₂A², where A¹ and A² can be, independently, an alkyl, cycloalkyl, alkenyl, cycloalkenyl, alkynyl, cycloalkynyl, aryl, or heteroaryl group as described herein. The term “sulfoxide” as used herein is represented by the formula A¹S(O)A², where A¹ and A² can be, independently, an alkyl, cycloalkyl, alkenyl, cycloalkenyl, alkynyl, cycloalkynyl, aryl, or heteroaryl group as described herein.

“R¹,” “R²,” “R³,” “Rⁿ,” where n is an integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

As described herein, compounds of the invention may contain “optionally substituted” moieties. In general, the term “substituted,” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. It is also contemplated that, in certain aspects, unless expressly indicated to the contrary, individual substituents can be further optionally substituted (i.e., further substituted or unsubstituted).

Suitable monovalent substituents on a substitutable carbon atom of an “optionally substituted” group are independently halogen; —(CH₂)₀₋₄R^{∘}; —(CH₂)₀₋₄OR^{∘}; —O(CH₂)₀₋₄R^{∘}, —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —(CH₂)₀₋₄O(CH₂)₀₋₁-pyridyl which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘})N(R^{∘})C(O)NR^{∘}₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —(CH₂)₀₋₄OC(O)NR^{∘}₂; —C(O)N(OR^{∘})R^{∘}; —C(O)C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘}₂; —(CH₂)₀₋₄S(O)R^{∘}; —N(R^{∘})S(O)₂NR^{∘}₂; —N(R^{∘})S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘})₂; SiR^{∘}₃; —(C₁₋₄ straight or branched alkylene)O—N(R^{∘})₂; or —(C₁₋₄ straight or branched alkylene)C(O)O—N(R^{∘})₂, wherein each R^{∘} may be substituted as defined below and is independently hydrogen, C₁₋₆ aliphatic, —CH₂Ph, —O(CH₂)₀₋₁Ph, —CH₂-(5-6 membered heteroaryl ring), or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or bicyclic ring having 0-4 heteroatoms independently selected from nitrogen, oxygen, or sulfur, which may be substituted as defined below.

Suitable monovalent substituents on R^{∘} (or the ring formed by taking two independent occurrences of R^{∘} together with their intervening atoms), are independently halogen, —(CH₂)₀₋₂R^{•}, -(haloR^{•}), —(CH₂)₀₋₂OH, —(CH₂)₀₋₂OR, —(CH₂)₀₋₂CH(OR^{•})₂; —O(haloR^{•}), —CN, —N₃, —(CH₂)₀₋₂C(O)R^{•}, —(CH₂)₀₋₂C(O)OH, —(CH₂)₀₋₂C(O)OR^{•}, —(CH₂)₀₋₂SR^{•}, —(CH₂)₀₋₂SH, —(CH₂)₀₋₂NH₂, —(CH₂)₀₋₂NHR^{•}, —(CH₂)₀₋₂NR^{•}₂, —NO₂, —SiR^{•}₃, —OSiR^{•}₃, —C(O)SR^{•}, —(C₁₋₄ straight or branched alkylene)C(O)OR^{•}, or —SSR^{•} wherein each R^{•} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{∘} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, ═NR*, ═NOR*, —O(C(R*₂))₂₋₃O—, or —S(C(R*₂))₂₋₃S—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

The term “stable,” as used herein, refers to compounds that are not substantially altered when subjected to conditions to allow for their production, detection, and, in certain aspects, their recovery, purification, and use for one or more of the purposes disclosed herein.

The term “leaving group” refers to an atom (or a group of atoms) with electron withdrawing ability that can be displaced as a stable species, taking with it the bonding electrons. Examples of suitable leaving groups include halides and sulfonate esters, including, but not limited to, triflate, mesylate, tosylate, and brosylate.

The terms “hydrolysable group” and “hydrolysable moiety” refer to a functional group capable of undergoing hydrolysis, e.g., under basic or acidic conditions. Examples of hydrolysable residues include, without limitation, acid halides, activated carboxylic acids, and various protecting groups known in the art (see, for example, “Protective Groups in Organic Synthesis,” T. W. Greene, P. G. M. Wuts, Wiley-Interscience, 1999).

The term “organic residue” defines a carbon-containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15 carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15 carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-thiazolidinedione radical in a particular compound has the structure:

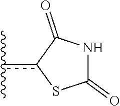

regardless of whether thiazolidinedione is used to prepare the compound. In some embodiments the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5, 6, 7, 8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

“Inorganic radicals,” as the term is defined and used herein, contain no carbon atoms and therefore comprise only atoms other than carbon. Inorganic radicals comprise bonded combinations of atoms selected from hydrogen, nitrogen, oxygen, silicon, phosphorus, sulfur, selenium, and halogens such as fluorine, chlorine, bromine, and iodine, which can be present individually or bonded together in their chemically stable combinations. Inorganic radicals have 10 or fewer, or preferably one to six or one to four inorganic atoms as listed above bonded together. Examples of inorganic radicals include, but not limited to, amino, hydroxy, halogens, nitro, thiol, sulfate, phosphate, and like commonly known inorganic radicals. The inorganic radicals do not have bonded therein the metallic elements of the periodic table (such as the alkali metals, alkaline earth metals, transition metals, lanthanide metals, or actinide metals), although such metal ions can sometimes serve as a pharmaceutically acceptable cation for anionic inorganic radicals such as a sulfate, phosphate, or like anionic inorganic radical. Inorganic radicals do not comprise metalloids elements such as boron, aluminum, gallium, germanium, arsenic, tin, lead, or tellurium, or the noble gas elements, unless otherwise specifically indicated elsewhere herein.

Compounds described herein can contain one or more double bonds and, thus, potentially give rise to cis/trans (E/Z) isomers, as well as other conformational isomers. Unless stated to the contrary, the invention includes all such possible isomers, as well as mixtures of such isomers.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture. Compounds described herein can contain one or more asymmetric centers and, thus, potentially give rise to diastereomers and optical isomers. Unless stated to the contrary, the present invention includes all such possible diastereomers as well as their racemic mixtures, their substantially pure resolved enantiomers, all possible geometric isomers, and pharmaceutically acceptable salts thereof. Mixtures of stereoisomers, as well as isolated specific stereoisomers, are also included. During the course of the synthetic procedures used to prepare such compounds, or in using racemization or epimerization procedures known to those skilled in the art, the products of such procedures can be a mixture of stereoisomers.

Many organic compounds exist in optically active forms having the ability to rotate the plane of plane-polarized light. In describing an optically active compound, the prefixes D and L or R and S are used to denote the absolute configuration of the molecule about its chiral center(s). The prefixes d and 1 or (+) and (−) are employed to designate the sign of rotation of plane-polarized light by the compound, with (−) or meaning that the compound is levorotatory. A compound prefixed with (+) or d is dextrorotatory. For a given chemical structure, these compounds, called stereoisomers, are identical except that they are non-superimposable mirror images of one another. A specific stereoisomer can also be referred to as an enantiomer, and a mixture of such isomers is often called an enantiomeric mixture. A 50:50 mixture of enantiomers is referred to as a racemic mixture. Many of the compounds described herein can have one or more chiral centers and therefore can exist in different enantiomeric forms. If desired, a chiral carbon can be designated with an asterisk (*). When bonds to the chiral carbon are depicted as straight lines in the disclosed formulas, it is understood that both the (R) and (S) configurations of the chiral carbon, and hence both enantiomers and mixtures thereof, are embraced within the formula. As is used in the art, when it is desired to specify the absolute configuration about a chiral carbon, one of the bonds to the chiral carbon can be depicted as a wedge (bonds to atoms above the plane) and the other can be depicted as a series or wedge of short parallel lines is (bonds to atoms below the plane). The Cahn-Inglod-Prelog system can be used to assign the (R) or (S) configuration to a chiral carbon.

Compounds described herein comprise atoms in both their natural isotopic abundance and in non-natural abundance. The disclosed compounds can be isotopically-labeled or isotopically-substituted compounds identical to those described, but for the fact that one or more atoms are replaced by an atom having an atomic mass or mass number different from the atomic mass or mass number typically found in nature. Examples of isotopes that can be incorporated into compounds of the invention include isotopes of hydrogen, carbon, nitrogen, oxygen, sulfur, fluorine and chlorine, such as ²H, ³H, ¹³C, ¹⁴C ¹⁵N, ¹⁸O, ¹⁷O, ³⁵S, ¹⁸F and ³⁶Cl, respectively. Compounds further comprise prodrugs thereof, and pharmaceutically acceptable salts of said compounds or of said prodrugs which contain the aforementioned isotopes and/or other isotopes of other atoms are within the scope of this invention. Certain isotopically-labeled compounds of the present invention, for example those into which radioactive isotopes such as ³H and ¹⁴C are incorporated, are useful in drug and/or substrate tissue distribution assays. Tritiated, i.e., ³H, and carbon-14, i.e., ¹⁴C, isotopes are particularly preferred for their ease of preparation and detectability. Further, substitution with heavier isotopes such as deuterium, i.e., ²H, can afford certain therapeutic advantages resulting from greater metabolic stability, for example increased in vivo half-life or reduced dosage requirements and, hence, may be preferred in some circumstances. Isotopically labeled compounds of the present invention and prodrugs thereof can generally be prepared by carrying out the procedures below, by substituting a readily available isotopically labeled reagent for a non-isotopically labeled reagent.

The compounds described in the invention can be present as a solvate. In some cases, the solvent used to prepare the solvate is an aqueous solution, and the solvate is then often referred to as a hydrate. The compounds can be present as a hydrate, which can be obtained, for example, by crystallization from a solvent or from aqueous solution. In this connection, one, two, three or any arbitrary number of solvent or water molecules can combine with the compounds according to the invention to form solvates and hydrates. Unless stated to the contrary, the invention includes all such possible solvates.

The term “co-crystal” means a physical association of two or more molecules which owe their stability through non-covalent interaction. One or more components of this molecular complex provide a stable framework in the crystalline lattice. In certain instances, the guest molecules are incorporated in the crystalline lattice as anhydrates or solvates, see e.g. “Crystal Engineering of the Composition of Pharmaceutical Phases. Do Pharmaceutical Co-crystals Represent a New Path to Improved Medicines?” Almarasson, O., et. al., The Royal Society of Chemistry, 1889-1896, 2004. Examples of co-crystals include p-toluenesulfonic acid and benzenesulfonic acid.

It is also appreciated that certain compounds described herein can be present as an equilibrium of tautomers. For example, ketones with an α-hydrogen can exist in an equilibrium of the keto form and the enol form.

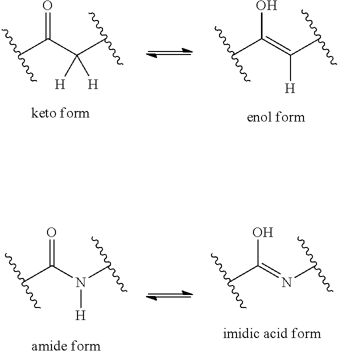 [SMILES: *CC(*)=O ; */C=C(/*)O ; *NC(*)=O ; */N=C(/*)O]

Unless stated to the contrary, the invention includes all such possible tautomers.

It is known that chemical substances form solids which are present in different states of order which are termed polymorphic forms or modifications. The different modifications of a polymorphic substance can differ greatly in their physical properties. The compounds according to the invention can be present in different polymorphic forms, with it being possible for particular modifications to be metastable. Unless stated to the contrary, the invention includes all such possible polymorphic forms.

Any undefined valency on an atom of a structure shown in this application implicitly represents a hydrogen atom bonded to the atom. When a group “R” is depicted as a “floating group” on a ring system, for example, in the formula:

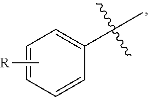

then R may replace any hydrogen atom attached to any of the ring atoms, including a depicted, implied, or expressly defined hydrogen, so long as a stable structure is formed. When a group “R” is depicted as a “floating group” on a fused ring system, as for example in the formula:

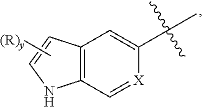

then R may replace any hydrogen attached to any of the ring atoms of either of the fused rings unless specified otherwise. Replaceable hydrogens include depicted hydrogens (e.g., the hydrogen attached to the nitrogen in the formula above), implied hydrogens (e.g., a hydrogen of the formula above that is not shown but understood to be present), expressly defined hydrogens, and optional hydrogens whose presence depends on the identity of a ring atom (e.g., a hydrogen attached to group X, when X equals —CH—), so long as a stable structure is formed. In the example depicted, R may reside on either the 5-membered or the 6-membered ring of the fused ring system. In the formula above, the subscript letter “y” immediately following the group “R” enclosed in parentheses, represents a numeric variable. Unless specified otherwise, this variable can be 0, 1, 2, or any integer greater than 2, only limited by the maximum number of replaceable hydrogen atoms of the ring or ring system.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B—F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

The above definitions supersede any conflicting definition in any of the reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. INSECT ODORANT SENSING

Insects interpret their chemical environment through the use of a family of cell-surface odorant receptors (ORs) to sense volatile chemicals known as odorants. The ability of an insect to respond to these chemical stimuli is necessary for the insect to find plant nectar, mate, feed, and for oviposition.

In contrast to mammalian odorant receptors (“ORs”) which act as G-Protein Coupled Receptors (GPCRs), insect ORs are atypical transmembrane heterodimers (Benton et al. (2006)), consisting of an extremely well-conserved OR co-receptor (“ORco”) ion channel that is nearly identical across all insect taxa and a non-conserved tuning OR that is nearly always species-specific and provides coding specificity to each complex (Vosshall and Hansson, 2011), which instead act broadly as ligand gated ion-channels (Sato et. al, Wicher al, 2008). ORco functions as a non-selective cation channel and is expressed in the majority of olfactory receptor neurons (ORNs). As the destructive behaviors of many insects are principally driven by olfaction, ORco represents a novel target for behavior-based control strategies. For odorant reception to take place, a member of the ORco family of OR co-receptors must be present to couple to another highly diverse OR (ORX) that is responsible for sensing different odors. Each insect species has many ORs, but only one OR83b family member now renamed ORco. There have been no reported naturally occurring ORco ligands to date.

The OR co-receptor (Orco) is required for all OR-based chemoreception in insects, which is the only lineage to possess this unique and highly conserved ion channel that is present in most ORNs. In fact, it is understood that ORco is so highly conserved between insects that an ORCo of one insect can be used in combination with a tuning OR from another insect and maintain activity. For example, ORco from Drosophila can be utilized in combination with AgOR10 or AgOR65 without affecting odorant sensing. Insect ORs are distinct from their mammalian counterparts in that they are not related to any known GPCRs and possess an inverse 7-TM topology. Recently it was shown that Orco is a non-selective cation channel, but it is unclear what roles, if any, second messengers may play. In heterologous expression, Orco is capable of forming functional channels independent of any tuning OR, although the in vivo consequence of this capacity is unknown. Tuning ORs expressed in the absence of Orco have no demonstrable functional capacity in heterologous systems or in vivo, as Orco is required not only for proper signal transduction, but also for trafficking of the OR complex to the ORN membrane.

The compositions disclosed herein act as ORco family activators and are believed to activate all ORX/ORco complexes across all insect taxa. The host-seeking behavior of blood-feeding insects and the plant-feeding behavior of agricultural pests is principally driven through their sense of smell. In the former case, this blood-feeding behavior serves as the foundation for their ability to transit disease and in the latter case, the plant-feeding behavior forms the basis for their ability to act as an agricultural pest. The capacity to disrupt olfactory-mediated behavior through direct chemical interference, as the disclosed compositions, would be a major advance in the fight against nuisance insects as well as vector-bome diseases and agricultural pests, and modulation of the ORco complex would render the insect incapable of performing its usual behaviors, such as host-seeking and nectar feeding.

1. Insects

a. Mosquitoes

Mosquito, from the Spanish or Portuguese meaning “little fly,” is a common insect in the family Culicidae. Mosquitoes resemble crane flies (family Tipulidae) and chironomid flies (family Chironomidae), with which they are sometimes confused by the casual observer.

Mosquitoes go through four stages in their life-cycles: egg, larva, pupa, and adult or imago. Adult females lay their eggs in water, which can be a salt-marsh, a lake, a puddle, a natural reservoir on a plant, or an artificial water container such as a plastic bucket. The first three stages are aquatic and last 5-14 days, depending on the species and the ambient temperature; eggs hatch to become larvae, then pupae. The adult mosquito emerges from the pupa as it floats at the water surface. Adults live for 4-8 weeks.

In the majority of female mosquitoes have mouthparts that are adapted for piercing the skin of plants and animals. While males typically feed on nectar and plant juices, the female needs to obtain nutrients from a “blood meal” before she can produce eggs.

Mosquito larvae have a well-developed head with mouth brushes used for feeding, a large thorax with no legs and a segmented abdomen. Larvae breathe through spiracles located on the eighth abdominal segment, or through a siphon, and therefore must come to the surface frequently. The larvae spend most of their time feeding on algae, bacteria, and other micro-organisms in the surface microlayer. They dive below the surface only when disturbed. Larvae swim either through propulsion with the mouth brushes, or by jerky movements of the entire body. Larvae develop through four stages, or instars, after which they metamorphose into pupae. At the end of each instar, the larvae molt, shedding their exoskeleton, or skin, to allow for further growth. Length of the adult varies but is rarely greater than 16 mm (0.6 in), and weight up to 2.5 mg (0.04 grain). All mosquitoes have slender bodies with three sections: head, thorax and abdomen.

The pupa is comma-shaped, as in Anopheles when viewed from the side. The head and thorax are merged into a cephalothorax with the abdomen circling around underneath. As with the larvae, pupae must come to the surface frequently to breathe, which they do through a pair of respiratory trumpets on the cephalothorax. However, pupae do not feed during this stage. After a few days, the dorsal surface of the cephalothorax splits and the adult mosquito emerges. The pupa is less active than larva.

The duration from egg to adult varies among species and is strongly influenced by ambient temperature. Mosquitoes can develop from egg to adult in as little as five days but usually take 10-14 days in tropical conditions. The variation of the body size in adult mosquitoes depends on the density of the larval population and food supply within the breeding water. Adult flying mosquitoes frequently rest in a tunnel that they build right below the roots of the grass.

Adult mosquitoes usually mate within a few days after emerging from the pupal stage. In most species, the males form large swarms, usually around dusk, and the females fly into the swarms to mate. Males live for about a week, feeding on nectar and other sources of sugar. Females will also feed on sugar sources for energy but usually require a blood meal for the development of eggs. After obtaining a full blood meal, the female will rest for a few days while the blood is digested and eggs are developed. This process depends on the temperature but usually takes 2-3 days in tropical conditions. Once the eggs are fully developed, the female lays them in an olfactory dependent process known as oviposition and resumes host seeking. The cycle repeats itself until the female dies. Their lifespan depends on temperature, humidity, and also their ability to successfully obtain a blood meal while avoiding host defenses.

The head is specialized for acquiring sensory information and for feeding. The head contains the eyes and a pair of long, many-segmented antennae. The antennae along with the maxillary palpi and proboscis are important for detecting host odors as well as odors of oviposition sites where females lay eggs. In all mosquito species, the antennae of the males in comparison to the females are noticeably bushier and contain auditory receptors to detect the characteristic whine of the female. The compound eyes are distinctly separated from one another. Their larvae only possess a pit-eye ocellus. The compound eyes of adults develop in a separate region of the head. New ommatidia are added in semicircular rows at the rear of the eye; during the first phase of growth, this leads to individual ommatidia being square, but later in development they become hexagonal. The hexagonal pattern will only become visible when the carapace of the stage with square eyes is molted. The head also has an elongated, forward-projecting “stinger-like” proboscis used for feeding (as well as chemosensory processes), and two sensory palps. The maxillary palps of the males are longer than their proboscis whereas the females' maxillary palps are much shorter. As with many members of the mosquito family, the female is equipped with an elongated proboscis that she uses to collect blood to feed her eggs.

The thorax is specialized for locomotion. Three pairs of legs and a pair of wings are attached to the thorax. The insect wing is an outgrowth of the exoskeleton. The Anopheles mosquito can fly for up to four hours continuously at 1 to 2 kilometers per hour (0.62 to 1.2 mph) travelling up to 12 km (7.5 mi) in a night.

The abdomen is specialized for food digestion and, in the female, for egg development. This segmented body part expands considerably when a female takes a blood meal. The blood is digested over time serving as a source of protein for the production of eggs, which gradually fill the abdomen. In the male, the abdomen contains testes where sperm develop. In various aspects, sperm can express Orco and, therefore, could be a potential target of the disclosed methods (e.g., to reduce reproduction).

The mosquito, as with all blood-feeding arthropods, has mechanisms to effectively block the hemostasis system with their saliva, which contains a mixture of secreted proteins. Mosquito saliva negatively affects vascular constriction, blood clotting, platelet aggregation, angiogenesis and immunity and creates inflammation. Universally, hematophagous arthropod saliva contains at least one anticlotting, one anti-platelet, and one vasodilatory substance. Mosquito saliva also contains enzymes that aid in sugar feeding and antimicrobial agents to control bacterial growth in the sugar meal. The composition of mosquito saliva is relatively simple as it usually contains fewer than 20 dominant proteins. Despite the great strides in knowledge of these molecules and their role in bloodfeeding achieved recently, scientists still cannot ascribe functions to more than half of the molecules found in arthropod saliva. One promising application is the development of anti-clotting drugs based on saliva molecules, which might be useful for approaching heart-related disease, because they are more user-friendly blood clotting inhibitors and capillary dilators.

Two important events in the life of female mosquitoes are egg development and blood digestion. After taking a blood meal the midgut of the female synthesizes proteolytic enzymes that hydrolyze the blood proteins into free amino acids. These are used as building blocks for the synthesis of egg yolk proteins.

b. Other Insect Disease Vectors

In addition to mosquitoes, the inventors contemplate application of the compounds and methods of the present invention against other insect disease vectors, including those that promote non-human disease. For example, aphids are the vectors of many viral diseases in plants. Fleas (such as the human flea, Pulex irritans, and the oriental rat flea, Xenopsylla cheopis) transmit bubonic plague, murine typhus and tapeworms. The glassy-winged sharpshooter transmits the Xylella fastidiosa bacterium among plants, resulting in diseases of grapes, almonds, and many other cultivated plants. Phlebotomine sand flies transmit leishmaniasis, bartonellosis, sandfly fever and pappataci fever. Ticks of the genus Ixodes are vectors of Lyme disease and babesiosis, and along with lice, transmit various members of the bacterial genus Rickettsia. Triatomine bugs such as Rhodnius prolixus are vectors of Chagas disease. Several genera of Tsetse flies are vectors of human African trypanosomiasis (also known as “African sleeping sickness”).

c. Agricultural Pests

The following is a list of agricultural pests for crops such as wheat, barley, oats, jowar, nuts, maize, soybean, sorghum, pea, potato, cucumber, tomato, grams, rabi, rice fruits, ornamental plants, including flowers, and trees which may be targeted using the methods and compositions of the present invention.

Termites. Odontotermes obesus Rambur and Microtermes obesi Holmgren. Social insects that live underground in colonies; attack young seedlings as well as grownup plants; the attacked plants rather wither and ultimately die.

Stem-borer. Sesamia inferens Walker. Moths are straw-coloured, lay eggs in clusters inside the leaf-sheaths; pinkish-brown caterpillars bore into stems and kill central shoots; causing dead-hearts

Gujhia weevil. Tanymecus indius Faust. Adults are earthern-grey weevils; grubs feed on roots, whereas the adults cut growing-points or nibble at margins of leaves; severer at the seeding stage.

Cutworms. Agrotis ipsilon Hufner and A. flammantra Schiffer-Mueller. Caterpillars are general feeders.

Thrip. Anaphothrips flavinctus Karny. Nymphs and adults lacerate tender leaves, causing characteristics whitish streaks; low temperature favourable to rapid multiplication.

Wheat aphids. Schizaphis (Toxoptera) graminum Rondani, Rhopalosiphum maidis Fitch and Sitobion avenae Fabricius. Nymphs and adults suck sap from leaves, tender shoots and immature grain; multiply extremely fast, forming large colonies.

Surface grasshopper. Chrotogonus trachypterus Blanchard. Adults stout, mud-like in colour; polyphagous, feeding on foilage and tender shoots.

Shoot fly. Atherigona naqvii Steyskal. The fly has assumed the status of a pest recently; maggots attack seedlings and kill the central shoots, causing dead-hearts.

Galerucid beetle. Madurasia obscurella Jacoby. Adult beetles feed on foilage and make small circular holes in the leaves; active during July-October.

Jassid. Empoasca herri Pruthi. Nymphs and adults remain on the underside of the leaves and suck the sap; leaves turn brown and crumple.

Plume moth borer. Exelastis atomosa Walsingham. A specific pest of red-gram; slender buff-colored moths, having plumose wings; greenish-brown hairy caterpillars feed on flowers and later on bore into pods to feed on the developing seeds inside.

Gram pod fly. Agromyza obtusa Mallas. A serious pest of red-grain; the small metallic-black fly lays eggs on pods; maggots bore into the pods and feed on the seeds; occasionally early in the season, grubs mine leaves.

Hairy caterpillars. Amsacta moorei Butlei, Albistriga Walker, Diacrisia obliqua Walker, Euproctis fratema Moore, E. scintillans Walker Polyphagous. Caterpillars feed gregariously and voraciously on foliage.

Cowpea stem fly. Melangromyza phaseoli Coquillett. A small blue-black fly, thrusts eggs into the epedermis of soft stems; pale-yellow maggots after mining leaves travel towards stem through the petiole and kill the young plants; the vigour of old plants is adversely affected.

Aphids. Aphis craccivora Kochi and A. cardui L. Colonies of nymphs and adults infest the tender growing shoots, flowers and young pods and suck the sap; infested parts dry and no pod or seed formation takes place.

Whitefly. Bemisia tabaci Gennadius. The flies suck the sap from leaves and tender growing parts, which dry and wither. They act as the vector of yellow mosaic of legumes.

Sphinx moth. Agrius convolvuli Linnaeus. Stout dark-brown moth; homed caterpillars defoliate plants by feeding voraciously.

Leaf caterpillars. Azazia rubicans Biosduval. Sporadic; the adult moth resembles a dry leaf; green caterpillars feed on leaves and tender plant parts.

Gram pod borer. Helicoverpa (Heliothis) obsoleta Fabricius Polyphagous. Moth yellowish brown; caterpillar green, with dark broken grey lines, feed on foilage, later on bore into pods and feed on the seeds within.

Gram caterpillars. Helicoverpa (Heliothis) armigera Hubner and H. zea, Boddie (obsoleta Fabricius). Polyphagous; moths stout, light brown; caterpillars yellowish, make holes in pods and feed on the seeds within.

Other pod borers. Etiella zinckenella Treitdche. Adult, greyish brown, with a distinct pale white band along the front margin of the forewings; tiny greenish caterpillars, with 5 black spots on the prothoracic shield, enter the pods and eat the seeds; more serious on green pea, specially in nothem India. Adisura athinsoni Moore. A serious pest in Karnataka; moths pale-yellowish brown; the brownish-green caterpillars feed on the seeds by boring into the ripening pods. Maruca testutalis Geyer. A minor pest; adults with fuscous forewings, having transverse white markings; pale-brownish caterpillars bore into the pods of various pulses (kharif pulses as well) to eat seeds inside

Cut worms. Agrotis psilon Hubner, A. flammatra Schiffer-Mueller, A. segetum Schiffer-Mueiller, A. spinifere Hubner.

Aphids. Aphis crassivora Koch, A. medicagenis Koch and Macrosiphum pisi Hubner Polyphagous. Nocturnal, stout larvae, feed on leaves of young plants and cut the older ones at the ground level. Colonies of nymphs and adults attack tender shoots, flowers and young pods and suck the sap; infested parts dry up. A. medicagenis is black, whereas M. pisi is green, and A. crassivora is brownish.

Pea leaf-miner. Phytomza atzicornis Meigen. A major pest of pea; polyphagous; maggots make zigzag mines in the leaves; eat green matter and pupate inside; infected leaves become whitish and dry up.

Pea stem fly. Melanagromyza phaseoli Coquillett. A major pest of pea, it also attacks kharif pulses; maggots attack young seeds inside the pods. The same as for the gram podd borer.

Pea semi-loopers. Plasia orichalcea Fabricius and P. nigrisigna Walker. Polyphagous; moths with a golden patch on the forewings (P. orichalces); green caterpillars feed on leaves during December to March.

Blue butterfly. Cosmolyee baeticus. Short pale-green caterpillars feed on the leaves, flowers and pods of pea.

Lucerne caterpillar. Laphygma exigua Hubner. Occasionally a serious pest of pea; dark-brown moths lay eggs on the lower portion of the young plants; caterpillars feed on the leaves.

Stem-borer beetles. Oberea brevis Gahan Nupserha bicolor Thomson. Pale brown longicorn beetles; grubs bore into the stems of growing plants.

Gray weevils. Myllocerus spp. Adults feed on leaves, nibbling the leaf margins in the initial stage.

Shoot fly. Atherigona soccata Rodani. Damage caused during the early seeding stage, larvae cut the growing points, causing dead-hearts; tillers do develop after the central shoot is killed, but the yield from these tillers is rather poor; commoner is early-sown rabi or late-sown kharif crops.

Stem borers. Chilo zonellus (partellus) Swinhoe Ragi and Sesamia inferens Walker. Moth, dirty brownish, nocturnal, caterpillars feed on foilage and bore into the stems, causing dead-hearts; also tunnel the stem and bore into earheads.

Sorghum midge. Contarinia sorghicola Coquillett. The insect has assumed the status of a serious pest recently; cosmopolitan; the tiny pinkish fly lay eggs inside the glumes and the larvae feed on the ovaries, thus preventing seed formation.

Aphids. Phopalosiphum maidis Fitch and Aphis sacchari Zehntner. Nymphs and adults suck the sap from the leaves and shoots, exclude honeydew, on which a sooty mould grows, giving the leaves a black appearance and interfering with photosynthesis.

Deccan wingless grasshopper/Boliver Phadka grasshopper. Colemania sphenaroides/Hieroglyphus Bolivar. Eggs are laid in the soil 75-200 mm deep; hoppers and adults feed on foilage, at times causing severe defoliation of the crops; adults of C. sphenaroides are wingless, whereas those of H. nigrorepletus are short winged and can fly short distances only.

Earhead bug. Calocoris angustatus Lethierry. Nymphs and adult bugs suck the sap from tender grains at the milky stage, making them chaffy.

Sorghum shoot bug. Peregrinus maidis Ashmead. Nymphs and adult bugs suck the sap from the leaves and whorls, which turn pale green.

Hairy caterpillars. Amsacta moorei Butler, Estigmene lactinae Cramer. General feeders, frequently causing severe defoliation; caterpillars of A. moorei are red whereas those of E. lactinae are black.

Earhead caterpillars. Eublemma (Heliothis) armigera Hubner and other species. Occur throughout the country; caterpillars feed on maturing grains.

Mites. Oligonychus indicus Hirst and Schizotetranychus andropogoni Hirst. Colonies of nymphs and adults suck the sap from the undersurface of the leaves, causing reddish-brown spots and patches.

Blister beetles. Lytta tenuicollis Pallasi and Zonabris pustulata Thunberg. Adult beetles feed on pollen and flowers.

Leaf roller. Marasmia trapezalis Guenee. Slender, yellowish-green caterpillars fold and roll the leaves near the tips and feed inside on the chlorophyll.

Shoot fly. Atherigone approximata Malloch. The flies cut the growing-points, causing dead-hearts during the seedling stage, whereas in the advanced stage; they feed on earheads and cut down peduncles.

Bajra midge. Geromyia pennisetti Harris. The larvae destroy the ovaries seriously, affecting the development of seeds.

Ragi white borer. Saluria inficita Walker. A specific pest of ragi; creamy white caterpillars bore into the stems close to the soil surface; adults are dark brown, with a pale-white band along the margin of each forewing.

Black hairy caterpillar. Estigmene exigua Hubner. Also known as woolly bear caterpillar; feed on leaves and earheads; the adults are creamy white moths with characteristic crimson marks on the head and the body.

Lucerne caterpillar. Spcdoptera exigua Hubner. Smooth, brownish-green caterpillars feed on foilage, moving in large numbers from field to field; common in nurseries.

Ragi-root aphid. Tetraneura hirsuta Baker. Minute, pale-white insect, found damaging roots, resulting in a gradual drying up of plants; infestation by the presence of black ants.

Ragi jassid. Cicadulina bipunctella bipunctella. Nymphs and adults suck the sap from the leaves and stems; an important vector of ragi mosaic virus.

Almond weevil. Myllocerus laetivirens Marshall; Mylocerus undecimpustulatus Faust and M. discolor Boheman Amblyrrhinus poricollis Boheman. Polyphagous pest; young weevils feed on roots, whereas the adult weevils feed on the foilage; initially they cut irregular holes and gradually eat up entire leaves leaving only the midribs.

Almond beetle. Mimastra cyanura Hope. Adult beetles appear in swarms during May, defoliate the trees, causing huge losses; peak activity is reached during July-August.

San Jose Scale. Quadraspidiotus perniciosus Comstock. Ash-coloured insects infest leaves, twigs and fruits and suck the sap; nursery plants may die if the attack is severe; active from March to December (3-4 generations).

Woolly aphid. Eriosoma lanigerum Hausmann. A cosmopolitan sucking insect; colonies look like white cottony patches on branches, twigs and main roots below ground; muliplication is very rapid; active from March to December, maximum activity during July-August.

Root borer. Dorysthenes hugelli Redtenbacher. Shining, chestnut-red beetles lay eggs in soil during July-August; grubs feed exclusively on thick roots and other organic matter, their longetivity is 3½ years; sandy soil preferred by the pest.

Tent caterpillar. Malacosoma indicum Walker. Caterpillars feed gregsriously on leaves at night and hide during the day in small tent-like structures of webs; moths lay eggs in bands (strips) around small twigs in May; caterpillars hatch out in the next spring.

Leopard moth. Zeuzera sp. White moths of attractive patterns are seen at dusk during may to July; eggs are laid singly in cracks of barks; pinkish-white young caterpillars bore into branches and stems during July-August and feed within 22 months.

Apple blossom thrip. Taenniothrips rhopalantennalis Shunister. Minute insects lay eggs in flower buds and nymphs and adults scrape tissues therefrom so there is no fruit-setting.

Leaf-defoliating and fruit-eating beetles. Adoretus duvauceli Blanchard, A. versutus Harold Anomala lineatopennis Blanchard, B. rufiventris Redtenbacher, Holotrichia longiplennis Blanchard, Hilyotrogus holosericus Redtenbacher, Lucanus lunifer Hope, Lachnosterna coriacea Hope, Macronota 4-lineata Hope, Melolonthafurcicauda Ancy, Mimela passerinii Arrow, M. pectoralis Blanchard and Mylabris mevilenta Marshall. Beetles lay eggs on soil during rainy season; grubs feed on vegetation under ground till next summer; beetles come out in June and feed on foilage and some species also attack the tender fruits usually during night. The affected fruits lose their market value.

Apple leaf-rollers. Cacoecia sarcosttega Meyrick, C. ecicyota Meyrick, C. pomivora Meyrick, C. termias Meyrick, and C. subsidiaria Meyrick. Polyphagous; larvae feed on the leaves, buds and flowers; after rolling or webbing them together, caterpillars feed within on soft tissues; fruit-setting is adversely affected.

Apple hawk moth. Langia zeuzeroides Moore. Sporadic; caterpillars defoilate trees during April to August; egg (2.5×2.0 mm), full fed larva (125×10 mm), pupa (50×20 mm) and moth (wing expanse 112×132 mm) are conspicuously big.

Apple leaf-miner. Gracillaria zachrysa Meyrick. Young caterpillars make several mines on leaf surface; later they leave mines, roll young leaves longitudinally into tubular or cone-shaped pouch and feed within; the maximum damage during summer (April-May) and in autumn (September-October).

Blossom thrip. Tacniothrips rhopalantennalis Shunister. Eggs laid in flower-buds before the buds open; nymphs feed on pet als and vital flower parts by lacerating tissues and sucking the sap; fruit formation is considerably reduced.

Hairy caterpillars. Euproctis signata Blanchard, E. fraterna Moore, and E. flava Fabricius. Caterpillars feed voraciously and defoliate trees; E. signata is commoner on apple trees.

Indian Gypsy moth, Lymantria obfuscata Walker. Round, greyish-brown eggs are laid in clusters during June-July under the bark on tree trunks and are covered with yellowish-brown hairs; these hatch after 8-9 months; larvae feed gregareously at night and defoliate the trees completely.

Apricot chalcid. Eurytoma samsonowi Vasiljev. Adults emerge from dry fruits in the end of February; lay eggs inside young fruits; grubs feed on the developing seeds, fruit growth is arrested and fruits fall prematurely; pupation takes place inside the seeds; maximum activity in April-May.

Apricot weevil. Emperorhinus defoliator Marshall. Adults defoliate the trees during summer.

Apricot chafer beetle. Anomala polita Blanchard. Adult feed on shoots and leaves.

Tissue-borers. Tryporyza incertulas Walker, Tryporyza innotata Snellen, Sesamia inferens Walker, Procerus indius Kapur, Chilo infuscatellus Snellen, C. simplex Butler, and C. zonellus Swinhoe. Caterpillars bore into stems and pupate within; the central shoot withers and produces a dead-heart; affected plants turn yellow and there is no grain formation; ear-heads appear white and chaffy; active throughout the year, except between April and May and between October and November.

Gundhi bugs. Leptocorisa varicornis Fabricius and L. acuta Thunberg. Nymphs and adults suck the milky sap of tender grains; affected earheads stand erect like normal ones, but without any grain formation; often the crop is completely destroyed; early varieties, if transplanted late, become more susceptible; active during May to November.

Paddy gall fly. Pachdiplosis oryzae Wood Mason. Maggots attack the base of the growing-point and produce long, tubular silvery galls (silver shoots); plant growth is adversely affected; active during May to September-November.

Rice hispa. Dicladispa armigera (Olivier). Small blue-black beetles, covered with spines; the grubs make long winding tunnels into leaves, whereas adults scrape the chlorophyl, affected leaves turn whitish and membranous and ultimately dry up.

Blue leaf beetle. Leptispa pygmaea Baly. Found in association with hispa, especially in Kamataka.

Paddy caseworm. Nymphula depunctalis Guenee. A small white moth, with yellow and dark specks on the wings; greenish caterpillars cut the leaves and form tabular cases around them; several tubes may be seen floating on water or hanging from the plant; the larvae feed on green tissues.

Swarming caterpillar. Spodoptera mauritia Boisduval. Sporadic, caterpillars appear in big swarms, causing heavy losses, specially when cold weather is suddenly followed by a spell of warmth or drought (30-40 days) is followed by heavy rains; normally appear in July-August.

Armyworms. Mythimna unipuncta Haworth and M. albistigma. Caterpillars march from field to field and voraciously feed on foilage; appear after heavy rains or early floods.

Rice grasshoppers. Hieroglyphus banian Fabricius, H. Nigrorepletus Beliver, H. furcifer Serv., H. oryzaevorus Carl Acrida exultata Linnaeus, A. turrita Linnaeus Aelopus famulus Kirby, A. Aularaches miliaris Loxya bidentata Willemse, O. multidentata Will, and O. velox Fabricius. Appear immediately after rains; nymphs and adults devour leaves and tender shoots and also newly-formed ear-heads; active from July to October-November.

Paddy jassids. Nephotettix apicalis Motschulsky and N. impicticeps Fabricius. Adults small, green, with black spots on forewings; nymphs and adults suck plant sap; affected plants turn yellow and growth is adversely affected.

White leaf hoppers. Tettigella spectra Distant. Adults larger than those of Nephotettix spp. and white; both nymphs and adults suck sap from young leaves; infested leaves turn yellow.

Fulgorid bug. Nilaparvartha lugens Stal. Minor pest; recorded feeding or ripening ear-heads.

Paddy thrip. Cloethrips oryzae Williams. Nymphs and adult lacerate tissues; affected leaves present yellowish streaks; tips curl and wither.

Whorl maggot. Hydrellia sp. Minor pest; common during kharif, maggots feed in the worls of developing leaves.

Paddy mealy bug. Ripersia oryzae Green. Colonies of reddish-white soft insects infest succulent paddy stems, hidden by outer leaf-sheaths, suck cell sap; growth gets stunted; affects ear-head formation.

Rice root aphid. Tetraneura hirsuta Baker. Colonies of nymphs and adults suck sap from roots just below soil surface, affected plants become pale and wither.

Paddy leaf-roller. Cnaphalocrocis medinalis Guenee. Sporadic pest; caterpillars roll the leaf tips and feed inside.

Paddy skippers. Pelopides mathias Fabricius. Adult, a dark-brown butterfly; caterpillar, smooth and green, feeds on leaves.

Paddy root weevil. Echinocnemus oryzae Marshal. Small grey weevil, grubs attack paddy roots and affect the growth of plants.

Other pests include the Asiatic Garden Beetle, Asparagus Beetles, Bean Leaf Beetle, Beet Webworm, Bluegrass Billbug, Brown Marmorated Stink Bug, Cabbage and Seedcorn Maggot, Cabbage Looper, Cabbage Webworm, Carpenter Ant, Carpenter Bee, Carpet Beetles, Catalpa Sphinx Caterpillar, Celery Leaftier, Cereal Leaf Beetle, European Corn Borer, Click Beetle, Colorado Potato Beetle, Confused Flour Beetle, Corn Earworm, Cucumber Beetle, Cutworms, Diamondback Moth, Eggplant Lace Bug, Flea Beetles, Fungus Gnat, Green Peach Aphid, Hornworms, Hunting Billbug, Imported Cabbageworm, Indian Meal Moth, Japanese Beetle, Lace Bugs, Leaf-Footed Bugs, Mexican Bean Beetle, Onion Thrips, Parsleyworm, Pepper Maggot, Pepper Weevil, Pickleworm, Potato Aphid, Potato Tuberworm, Raspberry Crown Borer, Rednecked Cane Borer, Rhubarb Curculio, Root-knot Nematode, Rose Chafer, Rose Scale, Sap Beetles, Sawtoothed Grain Beetle, Wireworms, Squash Bug, Squash Vine Borer, Tarnished Plant Bug, Twig Girdler/Twig Pruner, Vegetable Weevil, Virginia Pine, Sawfly, Wheel Bug, White Grubs, Whitefringed Beetles, Winter Grain Mite, and Yellow Ant.

2. Mosquito-Borne Disease

Mosquitoes are vectors that carry disease-causing viruses and parasites from person to person without manifesting the disease themselves. The principal mosquito borne diseases are the viral diseases yellow fever, dengue fever Chikungunya and West Nile, transmitted mostly (but not exclusively) by the genus Aedes or Culex, and human malaria carried by the genus Anopheles. Though originally a public health concern, HIV is now (thankfully) thought to be almost impossible for mosquitoes to transmit.

Mosquitoes are estimated to transmit disease to more than 700 million people annually in Africa, South America, Central America, Mexico and much of Asia, with millions of resulting deaths. At least 2 million people annually die of these diseases.

Methods used to prevent the spread of disease, or to protect individuals in areas where disease is endemic include vector control aimed at mosquito eradication, disease prevention, using prophylactic drugs and developing vaccines and prevention of mosquito bites, with insecticides, nets and repellents. Since most such diseases are carried by “elderly” females (that have survived long enough to acquire pathogens and become infective), scientists have suggested focusing on these to avoid the evolution of resistance.

a. Protozoa

The mosquito genus Anopheles carries the malaria parasite (see Plasmodium). Worldwide, malaria is a leading cause of premature mortality, particularly in children under the age of five. It is widespread in tropical and subtropical regions, including parts of the Americas (22 countries), Asia, and Africa. Each year, there are approximately 350-500 million cases of malaria, killing between one and three million people, the majority of whom are young children in sub-Saharan Africa. Ninety percent of malaria-related deaths occur in sub-Saharan Africa. Malaria is commonly associated with poverty, and can indeed be a cause of poverty and a major hindrance to economic development.

Five species of the Plasmodium parasite can infect humans; the most serious forms of the disease are caused by Plasmodium falciparum:. Malaria caused by Plasmodium vivax, Plasmodium ovale and Plasmodium malariae causes milder disease in humans that is not generally fatal. A fifth species, Plasmodium knowlesi, is a zoonosis that causes malaria in macaques but can also infect humans.

Malaria is naturally transmitted by the bite of a female Anopheles mosquito. When a mosquito bites an infected person, a small amount of blood is taken, which contains malaria parasites. These develop within the mosquito, and about one week later, when the mosquito takes its next blood meal, the parasites are injected with the mosquito's saliva into the person being bitten. After a period of between two weeks and several months (occasionally years) spent in the liver, the malaria parasites start to multiply within red blood cells, causing symptoms that include fever, and headache. In severe cases the disease worsens, leading to hallucinations, coma, and death.

A wide variety of antimalarial drugs are available to treat malaria. In the last 5 years, treatment of P. falciparum infections in endemic countries has been transformed by the use of combinations of drugs containing an artemisinin derivative. Severe malaria is treated with intravenous or intramuscular quinine or, increasingly, the artemisinin derivative artesunate. Several drugs are also available to prevent malaria in travelers to malaria-endemic countries (prophylaxis). Resistance has developed to several antimalarial drugs, most notably chloroquine.

Malaria transmission can be reduced by preventing mosquito bites by distribution of inexpensive mosquito nets and insect repellents, or by mosquito-control measures such as spraying insecticides inside houses and draining standing water where mosquitoes lay their eggs.

Although many are under development, the challenge of producing a widely available vaccine that provides a high level of protection for a sustained period is still to be met.

b. Helminthiasis

Some species of mosquito can carry the filariasis worm, a parasite that causes a disfiguring condition (often referred to as elephantiasis) characterized by a great swelling of several parts of the body; worldwide, around 40 million people are living with a filariasis disability. The thread-like filarial nematodes (roundworms) are members of the superfamily Filarioidea, also known as “filariae.” There are 9 known filarial nematodes which use humans as the definitive host. These are divided into 3 groups according to the niche within the body that they occupy: lymphatic filariasis, subcutaneous filariasis, and serous cavity filariasis. Lymphatic filariasis is caused by the worms Wuchereria bancrofti, Brugia malayi, and Brugia timori. These worms occupy the lymphatic system, including the lymph nodes, and in chronic cases these worms lead to the disease elephantiasis. Subcutaneous filariasis is caused by loa loa (the African eye worm), Mansonella streptocerca, Onchocerca volvulus, and Dracunculus medinensis (the guinea worm). These worms occupy the subcutaneous layer of the skin, in the fat layer. Serous cavity filariasis is caused by the worms Mansonella perstans and Mansonella ozzardi, which occupy the serous cavity of the abdomen. In all cases, the transmitting vectors are either blood sucking insects (flies or mosquitoes), or copepod crustaceans in the case of Dracunculus medinensis.

Individuals infected by filarial worms may be described as either “microfilaraemic” or “amicrofilaraemic,” depending on whether or not microfilaria can be found in their peripheral blood. Filariasis is diagnosed in microfilaraemic cases primarily through direct observation of microfilaria in the peripheral blood. Occult filariasis is diagnosed in amicrofilaraemic cases based on clinical observations and, in some cases, by finding a circulating antigen in the blood.

c. Viruses

The viral disease yellow fever, an acute hemorrhagic disease, is transmitted mostly by Aedes aegypti mosquitoes. The virus is a 40 to 50 nm enveloped RNA virus with positive sense of the Flaviviridae family. The yellow fever virus is transmitted by the bite of female mosquitoes (the yellow fever mosquito, Aedes aegypti, and other species) and is found in tropical and subtropical areas in South America and Africa, but not in Asia. The only known hosts of the virus are primates and several species of mosquito. The origin of the disease is most likely to be Africa, from where it was introduced to South America through the slave trade in the 16th century. Since the 17th century, several major epidemics of the disease have been recorded in the Americas, Africa and Europe. In the 19th century, yellow fever was deemed one of the most dangerous infectious diseases.

Clinically, yellow fever presents in most cases with fever, nausea, and pain and it generally subsides after several days. In some patients, a toxic phase follows, in which liver damage with jaundice (giving the name of the disease) can occur and lead to death. Because of the increased bleeding tendency (bleeding diathesis), yellow fever belongs to the group of hemorrhagic fevers. The WHO estimates that yellow fever causes 200,000 illnesses and 30,000 deaths every year in unvaccinated populations; around 90% of the infections occur in Africa.

A safe and effective vaccine against yellow fever has existed since the middle of the 20th century and some countries require vaccinations for travelers. Since no therapy is known, vaccination programs are, along with measures to reduce the population of the transmitting mosquito, of great importance in affected areas. Since the 1980s, the number of cases of yellow fever has been increasing, making it a reemerging disease.

Dengue fever and dengue hemorrhagic fever (DHF) are acute febrile diseases also transmitted by Aedes aegypti mosquitoes. These occur in the tropics, can be life-threatening, and are caused by four closely related virus serotypes of the genus Flavivirus, family Flaviviridae. It is also known as breakbone fever, since it can be extremely painful. It occurs widely in the tropics, and increasingly in southern China. Unlike malaria, dengue is just as prevalent in the urban districts of its range as in rural areas. Each serotype is sufficiently different that there is no cross-protection and epidemics caused by multiple serotypes (hyperendemicity) can occur. Dengue is transmitted to humans by the Aedes (Stegomyia) aegypti or more rarely the Aedes albopictus mosquito. The mosquitoes that spread dengue usually bite at dusk and dawn but may bite at any time during the day, especially indoors, in shady areas, or when the weather is cloudy. The WHO says some 2.5 billion people, two fifths of the world's population, are now at risk from dengue and estimates that there may be 50 million cases of dengue infection worldwide every year. The disease is now endemic in more than 100 countries.

Other viral diseases like epidemic polyarthritis, Rift Valley fever, Ross River Fever, St. Louis encephalitis, West Nile virus (WNV), Japanese encephalitis, La Crosse encephalitis and several other encephalitis type diseases are carried by several different mosquitoes. Eastern equine encephalitis (EEE) and Western equine encephalitis (WEE) occurs in the United States where it causes disease in humans, horses, and some bird species. Because of the high mortality rate, EEE and WEE are regarded as two of the most serious mosquito-borne diseases in the United States. Symptoms range from mild flu-like illness to encephalitis, coma and death. Culex and Culiseta are also involved in the transmission of disease. WNV has recently been a concern in the United States, prompting aggressive mosquito control programs.

d. Transmission

A mosquito's period of feeding is often undetected; the bite only becomes apparent because of the immune reaction it provokes. When a mosquito bites a human, she injects saliva and anti-coagulants. For any given individual, with the initial bite there is no reaction but with subsequent bites the body's immune system develops antibodies and a bite becomes inflamed and itchy within 24 hours. This is the usual reaction in young children. With more bites, the sensitivity of the human immune system increases, and an itchy red hive appears in minutes where the immune response has broken capillary blood vessels and fluid has collected under the skin. This type of reaction is common in older children and adults. Some adults can become desensitized to mosquitoes and have little or no reaction to their bites, while others can become hyper-sensitive with bites causing blistering, bruising, and large inflammatory reactions, a response known as Skeeter Syndrome.

3. Insect Olfactory Receptors

The ability to detect and respond to the chemical environment is a critical sensory input into many essential behaviors of hematophagous (blood-feeding) insects (Zwiebel and Takken, 2004). The search for vertebrate blood meals typically involves a flight of some distance to reach the host. This behavior consists of a series of behavioral stages, beginning with the activation of a receptive insect by the host chemical odor (kairomone) and ending when the insect alights on the host (Takken, 1991). At close range, attraction is mediated by several odorants, one of which is CO₂. In combination with other host-derived organic chemicals, CO₂ acts as a synergist as it greatly enhances the attraction triggered by other volatiles (Gilles, 1980). Moreover, it appears that mosquitoes respond to changes in the concentration of CO₂, rather than its presence or absence. In Ae. aegypti, changes in the firing rate of CO₂ receptors have been observed with increases in concentration of as little as 0.01% (Kellogg, 1970), while alterations in behavior have been observed after increases of 0.03-0.05% (Eiras and Jepson, 1991). Furthermore, a close examination of the role of CO₂ revealed that the turbulence of the odor plume in the laboratory greatly affected the responsiveness of Ae. aegypti and An. gambiae s.s. (Dekker et al., 2001a).

An. gambiae has also been shown to be attracted to acetone, lactic acid (Acree et al., 1968), carboxylic acids (Meijerink and van Loon, 1999), ammonia, 4-methyl-phenol, 1-octen-3-ol, and other components of sweat (Cork and Park, 1996; Meijerink et al., 2001), as well as to the odor of human feet, expired air and several unidentified components of Limburger cheese (De Jong and Knols, 1995). Furthermore, the often-cited differences in human attractiveness for mosquitoes (Curtis, 1986) is almost certainly olfactory based (Qiu et al., 2006a; Schreck et al., 1990). This within-host differential behavior is most particularly expressed in anthropophilic culicids such as Ae. aegypti and An. gambiae s.s. (de Jong and Knols, 1995; Lindsay et al., 1993; Schreck et al., 1990). Host age, but not gender, may affect these inter-individual differences (Camevale et al., 1978); race also appears to have no effect (Schreck et al., 1990). Young children have been shown to be less attractive to Anophelines than adults (Muirhead-Thomson, 1951; Thomas, 1951). Studies on the chemical composition of human volatiles (Bemier et al., 1999; Krotoszynski et al., 1977; Labows, 1979) revealed the existence of a large number (>350) of chemicals, and work is in progress to study the most important components of these volatiles regulating mosquito behavior. Lastly, it is also clear that responses to CO₂ affect inter-individual differences in attractiveness (Brady et al., 1997) and, thus, CO₂ serves as a universal attractant to many mosquito species (Gillies, 1980; Takken et al., 1997; Takken and Knols, 1999). It has been reported that CO₂ stimulation synergizes with host body odor and has an activating effect on host-seeking anopheline mosquitoes, inducing take-off and sustained flight behaviors (Dekker et al., 2001b; Gillies, 1980; Mboera and Takken, 1997).

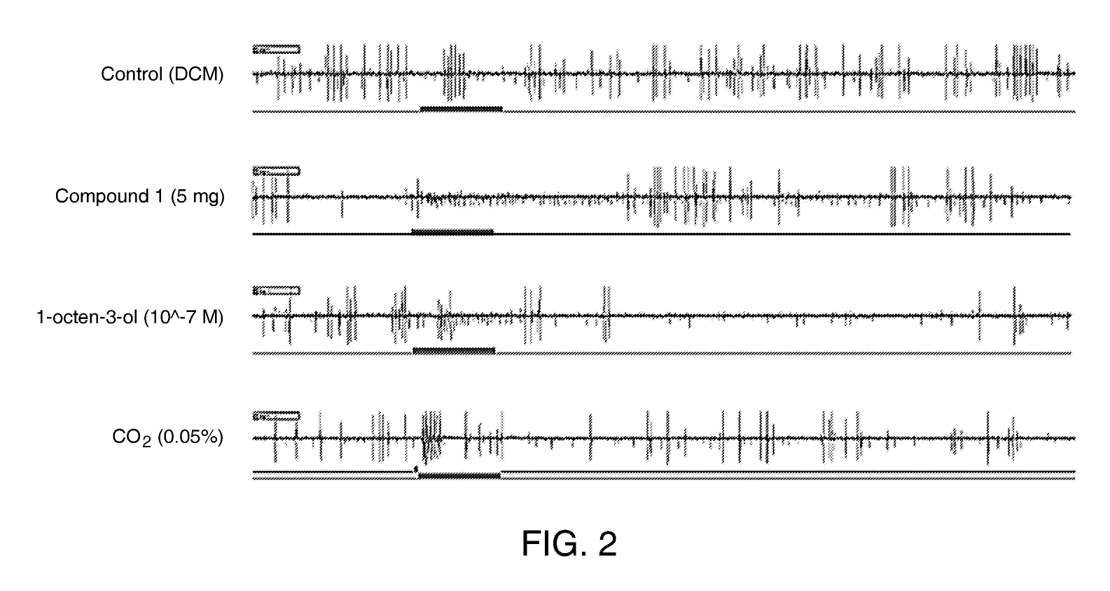

In a process that is analogous to the sense of smell in humans as well as other insects, mosquito olfactionis initiated by the process of chemosensory signal transduction by which chemical signals (typically environmental cues) are translated into neuronal activity and, ultimately, behavioral outputs. In An. gambiae, this takes place within specialized hair-like structures called sensilla that are dispersed throughout the antennae and other head appendages on adult and larval-stage anopheline mosquitoes (Zwiebel and Takken, 2004) (FIG. 2).

Until recently, much of the inventors' view of insect olfactory signal transduction at the molecular level has been strongly influenced by observations made in vertebrates, crustaceans and nematodes (Hildebrand and Shepherd, 1997; Krieger and Breer, 1999). The canonical model involves a family of heptahelical G-protein-coupled receptors (GPCRs) that activate downstream effectors via heterotrimeric GTP-binding (G) proteins and traditional second messengers. It has long been assumed, although not fully accepted (see below), that the canonical model of olfactory signal transduction would also hold true in insects, in which several of the “usual” molecular suspects have been identified and, in part, functionally characterized. These include arrestins (Merrill et al., 2002; 2003; 2005), odorant-binding proteins (OBPs) (Pelosi and Maida, 1995), a heterotrimeric G-protein (Laue et al., 1997) as well as a CNG (Baumann et al., 1994; Krieger et al., 1999) and an IP3-gated ion channel (Stengl, 1994). In one study using the cockroach, it was demonstrated that pheromone exposure of insect antennal preparations caused a rapid increase in IP3 levels (Breer et al., 1990), which in a follow-up study could be inhibited by pertussis toxin (Boekhoff et al., 1990), indicating that the IP3 increase is dependent on either a God or a Goto G-protein subunit. More recently, the inventors carried out a molecular survey of G-protein expression in the olfactory appendages of An. gambiae, in which Gaq localization consistent with involvement in olfactory signal transduction was observed along the dendrites of most olfactory sensory neurons (Rutzler et al., 2006). Furthermore, pheromone receptor neuron activity of Bombyx mori could be stimulated with fluoride ions (Laue et al., 1997), which are known to activate heterotrimeric G proteins via binding to the a subunit in combination with magnesium ions (Antonny et al., 1993). However, despite this growing wealth of information, the precise mode of insect olfactory signal transduction remains largely obscure and is therefore the subject of ongoing investigation that has raised serious issues with regard to the validity of GPCR-based paradigms.

Because olfaction was mediated by GPCRs in both vertebrates and at least one invertebrate, it was assumed that insects would also utilize these proteins in olfactory signal transduction. Indeed, using a variety of approaches, a large family of candidate ORs has been identified in D. melanogaster (Clyne et al., 1999) (Gao and Chess, 1999; Vosshall et al., 1999). In the first of these studies, putative D. melanogaster ORs (Dors) were identified using a novel computer algorithm that searched for conserved physicochemical features common to known transmembrane proteins (Kim et al., 2000) rather than relying on a sequence homology-based screen (which might miss a divergent member of a particular family). The structures that were ultimately identified using these strategies led to the identification of a highly divergent family of receptors, displaying between 10% and 75% identity and bearing no significant homology to any other GPCR family (Smith, 1999). Another chemosensory receptor family was also described in D. melanogaster and An. gambiae and is presumed to comprise gustatory (taste) receptors (Clyne et al., 2000; Hill et al., 2002; Scott et al., 2001). The other circumstantial criterion to infer olfactory function has been provided by various in situ expression pattern studies that have demonstrated that the majority of these genes were selectively and stereotypically expressed in the fly olfactory sensory neurons (Clyne et al., 1999) (Elmore and Smith, 2001; Gao and Chess, 1999; Vosshall, 2001; Vosshall et al., 1999). Two-color (double-labeling) in situ hybridization suggests that, with two notable caveats (Goldman et al., 2005), most D. melanogaster ORNs are likely to express a single DOR gene (Vosshall et al., 2000), which is analogous to mammalian systems (Mombaerts, 1999), but in stark contrast to the C. elegans system. One apparent exception to the one ORN-one receptor principle is the non-conventional DORco. Unlike most other DORs, DORco is expressed throughout the majority of antennal and maxillary palp ORNs of D. melanogaster. Putative DORco orthologs have been identified in a wide range of insect species and share many characteristics, including high sequence identity (Pitts et al., 2004), characteristic broad expression pattern (Krieger et al., 2003) and conserved functions (Jones et al., 2005). DORco family members are considered non-conventional ORs as they act as general dimerization partners for other members of the DOR family (Larsson et al., 2004). In addition, Benton, Vosshall and co-workers have identified a novel set of ionotropic glutamate receptors as a new class of insect chemosensory receptors (IRs) that are expressed in DOr83− ORNs associated with coeloconic sensilla where they act in parallel with “classical” insect ORs to respond to ammonia and other environmental cues (Benton et al., 2009; Liu et al., 2010).

Studies have also suggested that insect ORs manifest a novel topology relative to vertebrate ORs (Benton et al., 2006). In the absence of actual structural information insect ORs have been structurally characterized largely based on bioinformatic models derived from vertebrates (Clyne et al., 2000; Vosshall et al., 1999). Indeed, while sequence-based phylogenies recognize that insect ORs in general comprise a distinct family of heptahelical receptors that are an expanded lineage of ancestral chemosensory receptors (Mombaerts, 1999; Robertson et al., 2003) there is a growing awareness that insect ORs are likely to represent a structurally unique set of sensory proteins. These studies provide compelling evidence in support of the view that Drosophila ORs are heteromeric complexes between the non-conventional DOR83b and conventional, odorant binding DORs that adopt a novel membrane topology in which the N-terminus is intracellular rather than the extra-cellular localization that is typical of vertebrate ORs and GPCRs (Benton et al., 2006). Independent validation (Lundin et al.) together with recent computational analyses employing hidden Markov modeling that “strongly rejects” classifying arthropod ORs as GPCRs (Wistrand et al., 2006) raise significant concerns regarding the nature of the signaling pathways that are downstream of odorant activation in insects. Indeed, two recent studies provide provocative evidence to suggest that Drosophila ORs manifest properties of both ligand-gated (Sato et al.) and cyclic-nucleotide-gated ion channels (Wicher et al., 2008). While these hypotheses still differ in their particulars, there is growing awareness that insect olfactory transduction may diverge from vertebrate paradigms and act as non-GPCR-mediated ion-channels. In any case, while current hypotheses may differ, the growing possibility that insect olfactory transduction may diverge from vertebrate paradigms and act via non-GPCR-mediated mechanisms such as ion channels is compelling.

In the first report of insect ORs outside of the model insect system D. melanogaster, members of the inventors' laboratory, as part of a collaborative effort with Drs. John Carlson and Hugh Robertson, were responsible for the identification of a set of candidate Or genes selectively expressed in olfactory tissues of An. gambiae (AgORs) (Fox et al., 2001). Moreover, that report also demonstrated that at least one of the initial set of AgORs displays female-specific expression, a feature that may be especially relevant for disease transmission. In a subsequent study, as part of the effort to annotate the recently completed genomic sequence of An. gambiae (Holt et al., 2002), the inventors (in collaboration with other groups) utilized bioinformatics and molecular approaches to describe the entire An. gambiae GPCR gene family (AgGPCRs); of the 275 putative AgGPCRs, 79 candidate AgORs were described (Hill et al., 2002). Furthermore, a similar bioinformatic approach (using a non-public database) has been used to identify nine candidate Or genes in the heliothine moth Heliothis virescens (Krieger et al., 2002), some of which share sequence homology with AgORs. More recently, a large family of candidate Or genes have been identified in the genome sequence of the honey bee, Apis mellifera (Robertson and Wanner, 2006), Ae. aegypti (Bohbot et al., 2007) and the red flour beetle, Tribolium casteneum (Engsontia et al., 2008).

Thus far, insect ORs have been extensively deorphanized in a number of heterologous systems. The first successful functional studies of insect ORs were carried out for DOR₄3a using a Xenopus oocyte expression system (Wetzel et al., 2001), and over-expression in D. melanogaster (Storkuhl and Kettler, 2001) showed increased sensitivity to a set of four odorants. The Carlson laboratory has used a novel experimental approach that takes advantage of a genetic strain of D. melanogaster in which a chromosomal deletion has resulted in the loss of the endogenous receptors (DOR₂2a/b) from the ab3A ORN. The resultant formation of a “empty neuron” system facilitates the specific targeting of exogenous OR genes into the empty neuron, thereby allowing electrophysiological assessment of the ability of the novel receptor to carry out chemosensory signal transduction within the ab3A neuron upon stimulation with a diverse set of odorants (Dobritsa et al., 2003). This system has been used effectively to functionally characterize nearly all the DORs (Hallem et al., 2004a) (Hallem and Carlson, 2006), leading to a highly developed map of the multidimensional “odor space” of the DORs. As part of a long-standing collaboration between the Carlson lab and that of the inventors, nearly all of the AgORs have also been functionally characterized in Xenopus oocytes, human embryonic kidney cells and the Drosophila empty neuron (Hallem et al., 2004b; Lu et al., 2007; Xia et al. 2008; Wang et al. 2010; Carey et al. 2010). These studies, along with the success in functionally expressing over 40 AgORs in Xenopus and cell culture systems, have lead to significant advances in understanding the molecular basis for olfactory sensitivity in larval (Xia et al., 2008) and adult (Lu et al., 2007) An. gambiae. For example, CO₂ which acts as universal attractant for many species of mosquitoes (Takken and Knols, 1999), elicits avoidance in Drosophila where it has been identified as an active component of the “stress odorant” that targets a discrete population of sensory neurons (Suh et al., 2007) and where a pair of highly conserved putative gustatory receptors {Gr21a and Gr63a) have been shown to both be both necessary and sufficient to mediate olfactory sensitivity to CO₂ in Drosophila (Jones et al., 2007; Kwon et al., 2007). As part of a comprehensive study of the olfactory processes on the maxillary palp in An gambiae, the inventors have identified three Gr21a/63a homologs (AgGrs22-24) as the molecular partners required that together comprise the anopheline CO₂ receptor (Lu et al., 2007).

### C. COMPOUNDS

In one aspect, the invention relates to a compound having a structure represented by a formula:

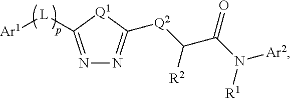

wherein p is an integer selected from 0 and 1; wherein each of Q¹ and Q² is independently selected from O, S, and NR³; wherein R³, when present, is selected from hydrogen, C1-C5 alkyl, and Cy¹; wherein Cy¹, when present, is selected from C1-C5 cycloalkyl and C1-C5 heterocycloalkyl and wherein Cy¹, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino; wherein L is a divalent organic group having from 1 to 9 non-hydrogen members; wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocycloalkyl ring; wherein R² is selected from hydrogen and optionally substituted C1-C4 alkyl; and wherein Ar¹ is selected from aryl and heteroaryl and wherein Ar¹ is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino, or a derivative thereof. In a further aspect, Ar¹ is a structure having a formula selected from:

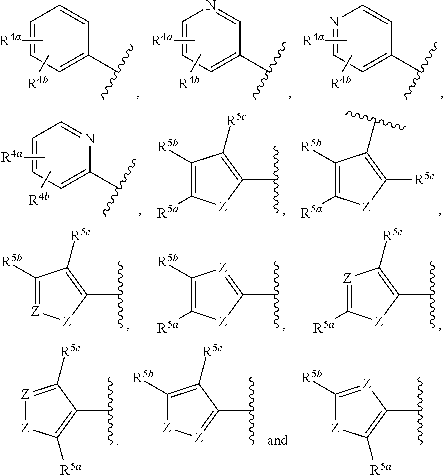

wherein each Z is independently selected from O, S, and NR⁶; wherein R⁶, when present, is optionally substituted and selected from C1-C5 alkyl, C1-C5 alkenyl, Ar³ and (C1-C4 alkyl)Ar³; wherein Ar³, when present, is selected from aryl and heteroaryl and wherein Ar³, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino; wherein each of R^{4a}, R^{4b}, R^{5a}, R^{5b}, and R^{5c} are independently selected from hydrogen, halogen, —OH, —NO₂, C1-C5 alkyl, C1-C5 alkenyl, carboxyl, carboxy(C1-C4 alkyl), phenyl, benzyl, benzyloxy, amino, C1-C4 alkylamino, C1-C4 dialkylamino, and C1-C4 alkyloxy; or wherein R^{4a} and R^{4b} are positioned on adjacent carbons and are taken together to be optionally substituted C1-C4 alkanediyl or optionally substituted C1-C4 alkenediyl; or wherein any two of R^{5a}, R^{5b}, and R^{5c} are positioned on adjacent carbons and are taken together to be optionally substituted C1-C4 alkanediyl or optionally substituted C1-C4 alkenediyl.

In a further aspect, the compound has a structure represented by a formula:

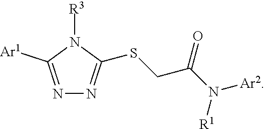

In a further aspect, the compound has a structure represented by a formula selected from:

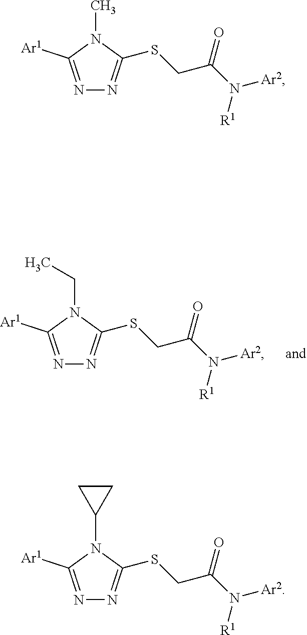

In a further aspect, the compound has a structure represented by a formula:

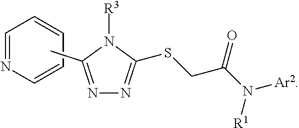

In a further aspect, the compound has a structure represented by a formula selected from:

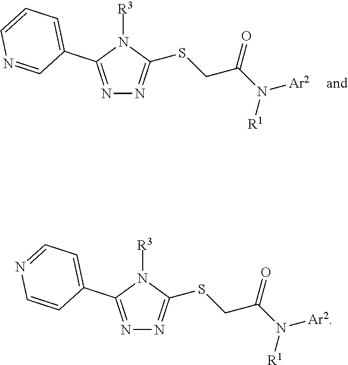

In a further aspect, the compound has a structure represented by a formula:

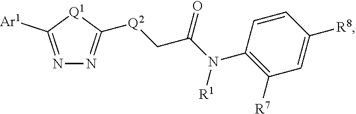

wherein each of R⁷ and R⁸ are independently selected from hydrogen, halogen, —OH, —NO₂, optionally substituted C1-C5 alkyl, and optionally substituted C1-C5 alkenyl.

In a further aspect, wherein the compound has a structure represented by a formula:

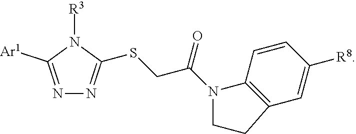

In a further aspect, wherein the compound has a structure represented by a formula:

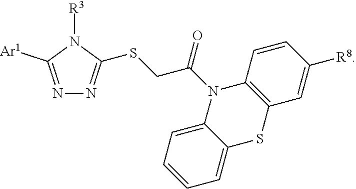

In a further aspect, the compound has a structure represented by a formula:

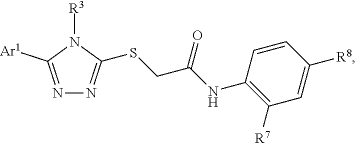

wherein each of R⁷ and R⁸ are independently selected from hydrogen, halogen, —OH, —NO₂, optionally substituted C1-C5 alkyl, and optionally substituted C1-C5 alkenyl.

In a further aspect, the compound has a structure represented by a formula:

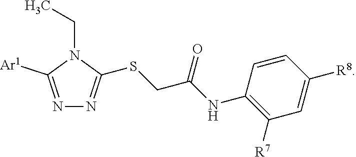

In a further aspect, the compound has a structure represented by a formula:

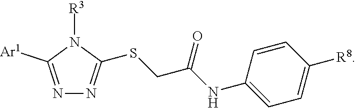

In a further aspect, the compound has a structure represented by a formula:

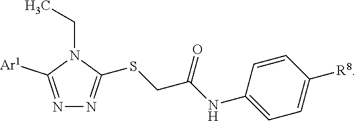

In a further aspect, the compound is selected from:

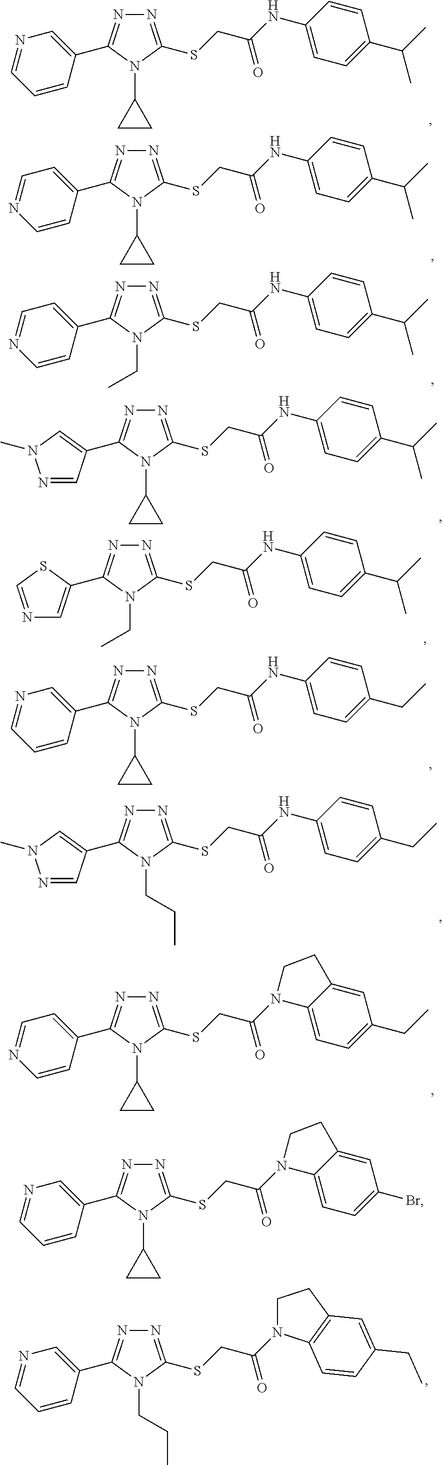

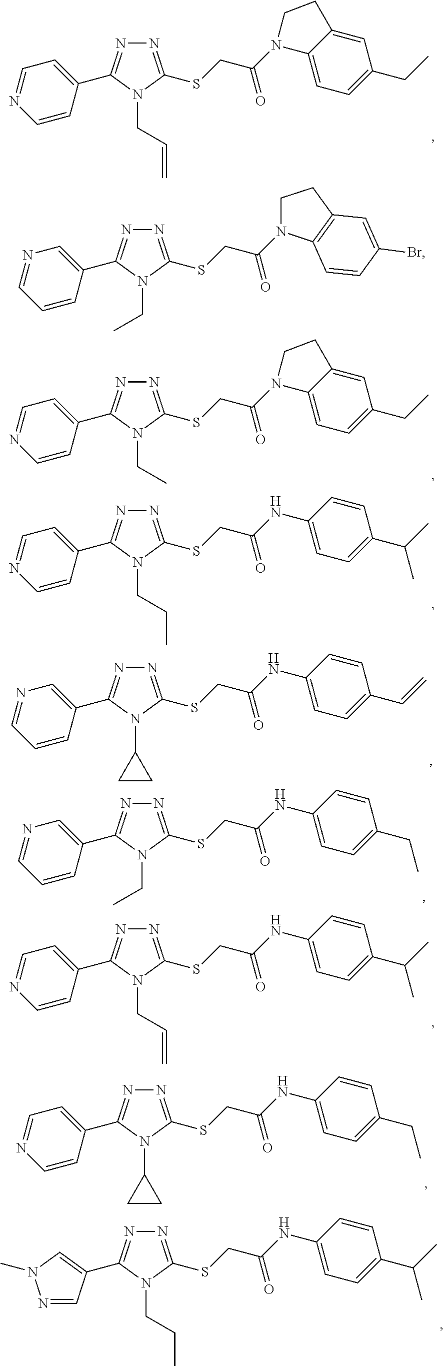

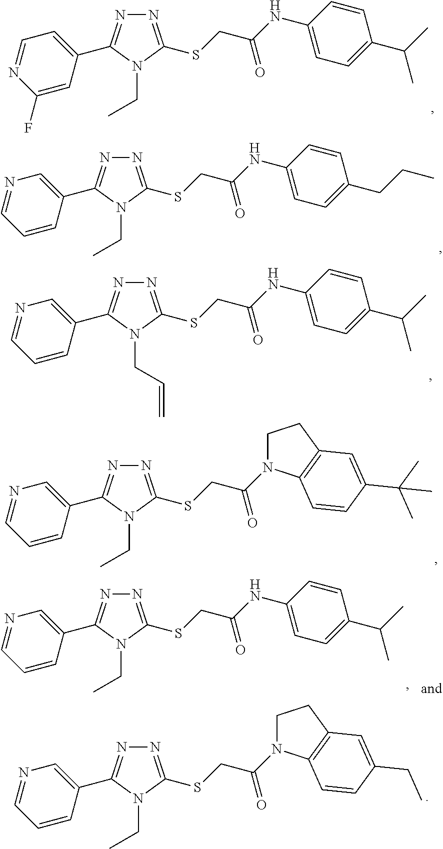

In a further aspect, p is an integer selected from 0 and 1. In a still further aspect, p is 0. In yet a further aspect, p is 1.

In a further aspect, the compound is an insect odorant receptor co-receptor (Orco) agonist.

In a further aspect, the compound binds to and/or modulates insect Orco ion channels.

It is contemplated that each disclosed derivative can be optionally further substituted. It is also contemplated that any one or more derivative can be optionally omitted from the invention. It is understood that a disclosed compound can be provided by the disclosed methods. It is also understood that the disclosed compounds can be employed in the disclosed methods of using.

1. Structure

Suitable substituents are described below.

a. L Groups

In one aspect, L is a divalent organic groups having from 1 to 9 non-hydrogen members. For example, L can have 1, 2, 3, 4, 5, 6, 7, 8, or 9 non-hydrogen members. In a further aspect, L is selected from:

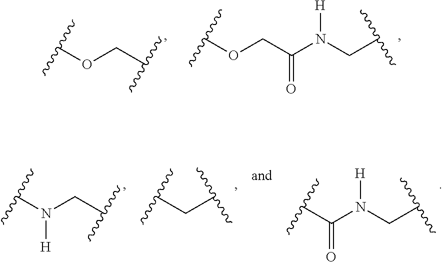

In a further aspect, L is selected from:

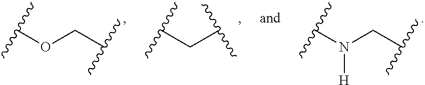

In a further aspect, L is present when p is 1. In a further aspect, L is absent when p is O.

b. Q¹ and Q² Groups

In one aspect, each of Q¹ and Q² is independently selected from O, S, and NR³. In a further aspect, each of Q¹ and Q² is independently selected from O and S. In a still further aspect, each of Q¹ and Q² is O. In yet a further aspect, each of Q¹ and Q² is S. In an even further aspect, each of Q¹ and Q² is NR³.

In a further aspect, Q¹ is O and Q² is selected from O, S, and NR³. In a still further aspect, Q¹ is O and Q² is selected from O and S. In yet a further aspect, Q¹ is O and Q² is S. In an even further aspect, Q¹ is 0 and Q² is NR³.

In a further aspect, Q¹ is S and Q² is selected from O, S, and NR³. In a still further aspect, Q¹ is S and Q² is selected from O and S. In yet a further aspect, Q¹ is S and Q² is O. In an even further aspect, Q¹ is S and Q² is NR³.

In a further aspect, Q¹ is NR³ and Q² is selected from O, S, and NR³. In a still further aspect, Q¹ is NR³ and Q² is selected from O and S. In yet a further aspect, Q¹ is NR³ and Q² is O. In an even further aspect, Q¹ is NR³ and Q² is S.

c. Z Groups

In one aspect, each Z is independently selected from O, S, and NR⁶. In a further aspect, each Z is independently selected from O and S. In a still further aspect, each Z is O. In yet a further aspect, each Z is S. In an even further aspect, each Z is NR⁶.

d. R¹ Groups

In one aspect, R¹ is selected from hydrogen, optionally substituted C1-C4 alkyl, and an alkyloxy carbonyl group or R¹ is taken together with a substituent of Ar² to form a five-, six-, or seven-membered heterocycloalkyl ring. In a further aspect, the alkyloxy carbonyl group has a structure selected from:

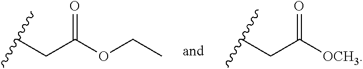

In a further aspect, R¹ is hydrogen.

In a further aspect, R¹ is selected from methyl, ethyl, n-propyl, i-propyl, n-butyl, i-butyl, s-butyl, t-butyl, and a structure selected from:

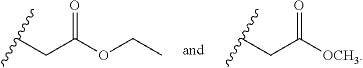

In a further aspect, R is taken together with a substituent of Ar² to form a five-, six-, or seven-membered heterocycloalkyl ring. In a further aspect, R¹ is taken together with a substituent of Ar² to be optionally substituted (C1-C4) alkanediyl or optionally substituted (C1-C4) alkenediyl. In a further aspect, R¹ is hydrogen or is taken together with Ar² to be (C1-C4) alkanediyl, (C1-C4) alkenediyl, or a substituted version of either of these groups.

In a further aspect, R¹ is substituted with 0, 1, 2, or 3 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, R¹ is substituted with 0, 1, or 2 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, R¹ is substituted with 0 or 1 group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In an even further aspect, R¹ is monosubstituted with a group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, R¹ is unsubstituted.

e. R² Groups

In one aspect, R² is selected from hydrogen and optionally substituted (C1-C4) alkyl. In a further aspect, R² is hydrogen.

In a further aspect, R² is selected from methyl, ethyl, n-propyl, i-propyl, n-butyl, i-butyl, s-butyl, and t-butyl. In a still further aspect, R² is selected from methyl, ethyl, n-propyl, and i-propyl. In yet a further aspect, R² is selected from methyl and ethyl. In an even further aspect, R² is ethyl. In a still further aspect, R² is methyl.

In a further aspect, R² is substituted with 0, 1, 2, or 3 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, R² is substituted with 0, 1, or 2 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, R² is substituted with 0 or 1 group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In an even further aspect, R² is monosubstituted with a group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, R² is unsubstituted.

f. R³ Groups

In one aspect, R³, when present, is selected from hydrogen, (C1-C5) alkyl, and Cy¹. In a further aspect, R³, when present, is optionally substituted. In a still further aspect, R³, when present, is hydrogen.

In a further aspect, R³, when present, is selected from hydrogen and Cy¹. In a still further aspect, R³, when present, is Cy¹.

In a further aspect, R³, when present, is C1-C5 alkyl. In a still further aspect, R³, when present, is selected from methyl, ethyl, n-propyl, i-propyl, n-butyl, i-butyl, s-butyl, and t-buty. In yet a further aspect, R³, when present, is selected from methyl, ethyl, n-propyl, and i-propyl. In an even further aspect, R³, when present, is selected from methyl and ethyl. In a still further aspect, R³, when present, is ethyl. In yet a further aspect, R³, when present, is methyl.

In a further aspect, R³ is substituted with 0, 1, 2, or 3 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, R³ is substituted with 0, 1, or 2 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, R³ is substituted with 0 or 1 group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In an even further aspect, R³ is monosubstituted with a group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, R³ is unsubstituted.

g. R^{4A}, R^{4B}, R^{5A}, R^{5B}, and R^{5C} Groups

In one aspect, each of R^{4a}, R^{4b}, R^{5a}, R^{5b}, and R^{5c} are independently selected from hydrogen, halogen, —OH, —NO₂, C1-C5 alkyl, C1-C5 alkenyl, carboxyl, carboxy(C1-C4 alkyl), phenyl, benzyl, benzyloxy, amino, C1-C4 alkylamino, (C1-C4)(C1-C4) dialkylamino, and C1-C4 alkyloxyl, or R^{4a} and R^{4b} are positioned on adjacent carbons and are taken together to be optionally substituted C1-C4 alkanediyl or optionally substituted C1-C4 alkenediyl, or any two of R^{5a}, R^{5b}, R^{5c} are positioned on adjacent carbons and are taken together to be optionally substituted C1-C4 alkanediyl or optionally substituted C1-C4 alkenediyl. In a further aspect, each of R^{4a}, R^{4b}, R^{5a}, R^{5b}, and R^{5c} are hydrogen.

In a further aspect, each of R^{4a}, R^{4b}, R^{5a}, R^{5b}, and R^{5c} are independently selected from hydrogen, halogen, —OH, —NO₂, C1-C5 alkyl, C1-C5 alkenyl, carboxyl, carboxy(C1-C4 alkyl), phenyl, benzyl, benzyloxy, amino, C1-C4 alkylamino, (C1-C4)(C1-C4) dialkylamino, and C1-C4 alkyloxyl. In a still further aspect, each of R^{4a}, R^{4b}, R^{5a}, R^{5b}, and R^{5c} are independently selected from hydrogen, —Cl, —F, —OH, —NO₂, —NH₂, methyl, ethyl, n-propyl, i-propyl, ethenyl, propenyl, —CO₂CH₃, —CO₂CH₂CH₃, —CO₂CH₂CH₂CH₃, —CO₂CH(CH₃)₂, phenyl, benzyl, benzyloxy, —NHCH₃, —NHCH₂CH₃, —NHCH₂CH₂CH₃, —NHCH(CH₃)₂, —N(CH₃)₂, —N(CH₂CH₃)₂, —N(CH₂CH₂CH₃)₂, —N(CH(CH₃)₂)₂, —N(CH₃)(CH₂CH₃), —N(CH₃)(CH₂CH₂CH₃), —N(CH₃)(CH(CH₃)₂), —OCH₃, —OCH₂CH₃, —OCH₂CH₂CH₃, and —OCH(CH₃)₂. In yet a further aspect, each of R^{4a}, R^{4b}, R^{5a}, R^{5b}, and R^{5c} are independently selected from hydrogen, —Cl, —F, —OH, —NO₂, —NH₂, methyl, ethyl, ethenyl, —CO₂CH₃, —CO₂CH₂CH₃, phenyl, benzyl, benzyloxy, —NHCH₃, —NHCH₂CH₃, —N(CH₃)₂, —N(CH₂CH₃)₂, —N(CH₃)(CH₂CH₃), —OCH₃, and —OCH₂CH₃. In an even further aspect, each of R^{4a}, R^{4b}, R^{5a}, R^{5b}, and R^{5c} are independently selected from hydrogen, —Cl, —F, —OH, —NO₂, —NH₂, methyl, —CO₂CH₃, phenyl, benzyl, benzyloxy, —NHCH₃, —N(CH₃)₂, and —OCH₃.

In a further aspect, each of R^{4a}, R^{4b}, R^{5a}, R^{5b}, and R^{5c} are independently selected from hydrogen, halogen, —OH, —NO₂, C1-C5 alkyl, C1-C5 alkenyl, carboxyl, carboxy(C1-C4 alkyl), amino, C1-C4 alkylamino, (C1-C4)(C1-C4) dialkylamino, and C1-C4 alkyloxyl. In a still further aspect, each of R^{4a}, R^{4b}, R^{5a}, R^{5b}, and R^{5c} are independently selected from hydrogen, —Cl, —F, —OH, —NO₂, —NH₂, methyl, ethyl, n-propyl, i-propyl, ethenyl, propenyl, —CO₂CH₃, —CO₂CH₂CH₃, —CO₂CH₂CH₂CH₃, —CO₂CH(CH₃)₂, —NHCH₃, —NHCH₂CH₃, —NHCH₂CH₂CH₃, —NHCH(CH₃)₂, —N(CH₃)₂, —N(CH₂CH₃)₂, —N(CH₂CH₂CH₃)₂, —N(CH(CH₃)₂)₂, —N(CH₃)(CH₂CH₃), —N(CH₃)(CH₂CH₂CH₃), —N(CH₃)(CH(CH₃)₂), —OCH₃, —OCH₂CH₃, —OCH₂CH₂CH₃, and —OCH(CH₃)₂. In yet a further aspect, each of R^{4a}, R^{4b}, R^{5a}R^{5b}, and R^{5c} are independently selected from hydrogen, —Cl, —F, —OH, —NO₂, —NH₂, methyl, ethyl, ethenyl, —CO₂CH₃, —CO₂CH₂CH₃, —NHCH₃, —NHCH₂CH₃, —N(CH₃)₂, —N(CH₂CH₃)₂, —N(CH₃)(CH₂CH₃), —OCH₃, and —OCH₂CH₃. In an even further aspect, each of R^{4a}, R^{4b}, R^{5a}, R^{5b}, and R^{5c} are independently selected from hydrogen, —Cl, —F, —OH, —NO₂, —NH₂, methyl, —CO₂CH₃, —NHCH₃, —N(CH₃)₂, and —OCH₃.

In a further aspect, R^{4a} and R^{4b} are positioned on adjacent carbons and are taken together to be optionally substituted C1-C4 alkanediyl or optionally substituted C1-C4 alkenediyl.

In a further aspect, any two of R^{5a}, R^{5b}, R^{5c} are positioned on adjacent carbons and are taken together to be optionally substituted C1-C4 alkanediyl or optionally substituted C1-C4 alkenediyl.

In a further aspect, each of R^{4a}, R^{4b}, R^{5a}, R^{5b}, and R^{5c} are substituted with 0, 1, 2, or 3 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, each of R^{4a}, R^{4b}, R^{5a}, R^{5b}, and R^{5c} are substituted with 0, 1, or 2 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, each of R^{4a}, R^{4b}, R^{5a}R^{5b}, and R^{5c} are substituted with 0 or 1 group independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In an even further aspect, each of R^{4a}, R^{4b}, R^{5a}, R^{5b}, and R^{5c} are monosubstituted with a group independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, each of R^{4a}, R^{4b}, R^{5a}, R^{5b}, and R^{5c} are unsubstituted. h. R⁶ GROUPS

In one aspect, R⁶, when present, is optionally substituted and selected from C1-C5 alkyl, C1-C5 alkenyl, Ar³, and (C1-C4 alkyl)Ar³. In a further aspect, R⁶, when present, is selected from Ar³ and (C1-C4 alkyl)Ar³. In a still further aspect, R⁶, when present, is Ar³. In yet a further aspect, R⁶, when present, is (C1-C4 alkyl)Ar³.

In a further aspect, R⁶, when present, is optionally substituted and selected from C1-C5 alkyl and C1-C5 alkenyl. In a still further aspect, R⁶, when present, is optionally substituted and selected from C1-C4 alkyl and C1-C4 alkenyl. In yet a further aspect, R⁶, when present, is optionally substituted and selected from methyl, ethyl, ethenyl, propyl, and propenyl. In a still further aspect, R⁶, when present, is optionally substituted and selected from methyl, ethyl, and ethenyl. In yet a further aspect, R⁶, when present, is optionally substituted methyl.

In a further aspect, R⁶, when present, is optionally substituted C1-C5 alkyl. In a still further aspect, R⁶, when present, is optionally substituted and selected from methyl, ethyl, n-propyl, i-propyl, n-butyl, i-butyl, s-butyl, and t-butyl. In yet a further aspect, R⁶, when present, is optionally substituted and selected from methyl, ethyl, and propyl. In a still further aspect, R⁶, when present, is optionally substituted and selected from methyl and ethyl. In yet a further aspect, R⁶, when present, is optionally substituted methyl. In an even further aspect, R⁶, when present, is optionally substituted ethyl.

In a further aspect, R⁶, when present, is optionally substituted C1-C5 alkenyl. In a still further aspect, R⁶, when present, is optionally substituted C1-C4 alkenyl. In yet a further aspect, R⁶, when present, is optionally substituted and selected from ethenyl and propenyl. In a still further aspect, R⁶, when present, is optionally substituted ethenyl. In yet a further aspect, R⁶, when present, is optionally substituted propenyl.

In a further aspect, R⁶, when present, is substituted with 0, 1, 2, or 3 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, R⁶, when present, is substituted with 0, 1, or 2 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, R⁶, when present, is substituted with 0 or 1 group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In an even further aspect, R⁶, when present, is monosubstituted with a group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, R⁶, when present, is unsubstituted.

a. R⁷ and R⁸ Groups

In one aspect, each of R⁷ and R⁸ are independently selected from hydrogen, halogen, —OH, —NO₂, optionally substituted (C1-C5) alkyl, and optionally substituted (C1-C5) alkenyl. In a further aspect, each of R⁷ and R⁸ are independently selected from hydrogen, —OH, and —NO₂. In a still further aspect, each of R⁷ and R⁸ are hydrogen.

In a further aspect, each of R⁷ and R⁸ are independently selected from hydrogen and halogen. In a still further aspect, each of R⁷ and R⁸ are independently selected from hydrogen, chlorine, and fluorine. In yet a further aspect, each of R⁷ and R⁸ are independently selected from hydrogen and chlorine. In a still further aspect, each of R⁷ and R⁸ are independently selected from hydrogen and fluorine.

In a further aspect, each of R⁷ and R⁸ are independently selected from hydrogen and (C1-C5) alkenyl. In a still further aspect, each of R⁷ and R⁸ are independently selected from hydrogen and (C1-C4) alkenyl. In yet a further aspect, each of R⁷ and R⁸ are independently selected from hydrogen, ethenyl, and propenyl. In an even further aspect, each of R⁷ and R⁸ are independently selected from hydrogen and ethenyl. In a still further aspect, each of R⁷ and R⁸ are independently selected from hydrogen and propenyl.

In a further aspect, each of R⁷ and R⁸ are independently selected from hydrogen, methyl, ethyl, n-propyl, i-propyl, n-butyl, i-butyl, s-butyl, and t-butyl. In a still further aspect, each of R⁷ and R⁸ are independently selected from hydrogen, methyl, ethyl, n-propyl, and i-propyl. In yet a further aspect, each of R⁷ and R⁸ are independently selected from hydrogen, methyl, and ethyl. In an even further aspect, each of R⁷ and R⁸ are independently selected from hydrogen and ethyl. In a still further aspect, each of R⁷ and R⁸ are independently selected from hydrogen and methyl.

In a further aspect, R⁷ is selected from hydrogen, methyl, ethyl, n-propyl, i-propyl, n-butyl, i-butyl, s-butyl, and t-butyl. In a still further aspect, R⁷ is selected from hydrogen, methyl, ethyl, n-propyl, and i-propyl. In yet a further aspect, R⁷ is selected from hydrogen, methyl, and ethyl. In an even further aspect, R⁷ is selected from hydrogen and ethyl. In a still further aspect, R⁷ is selected from hydrogen and methyl.

In a further aspect, R⁸ is optionally substituted C1-C5 alkyl. In a still further aspect, R⁸ is selected from methyl, ethyl, n-propyl, i-propyl, n-butyl, i-butyl, s-butyl, and t-butyl. In yet a further aspect, R⁸ is selected from methyl, ethyl, n-propyl, and i-propyl. In an even further aspect, R⁸ is selected from methyl and ethyl. In a still further aspect, R⁸ is ethyl. In yet a further aspect, R⁸ is methyl.

In a further aspect, each of R⁷ and R⁸ are substituted with 0, 1, 2, or 3 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, each of R⁷ and R⁸ are substituted with 0, 1, or 2 groups independently selected from halogen, —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, each of R⁷ and R⁸ are substituted with 0 or 1 group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In an even further aspect, each of R⁷ and R⁸ are monosubstituted with a group selected from halogen, —OH, —SH, —CN, —NO₂, —NH₂, C1-C4 alkyl, C1-C4 alkoxy, C1-C4 alkylamino, and (C1-C4)(C1-C4) dialkylamino. In a still further aspect, each of R⁷ and R⁸ are unsubstituted.

b. Ar¹ Groups

In one aspect, Ar¹ is selected from aryl and heteroaryl and substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino.

In a further aspect, Ar¹ is selected from aryl and heteroaryl and substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar¹ is selected from aryl and heteroaryl and monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar¹ is selected from aryl and heteroaryl and unsubstituted.

In a further aspect, Ar¹ is aryl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar¹ is aryl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar¹ is aryl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar¹ is unsubstituted aryl.

In a further aspect, Ar¹ is phenyl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar¹ is phenyl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar¹ is phenyl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar¹ is unsubstituted phenyl.

In a further aspect, Ar¹ is heteroaryl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar¹ is heteroaryl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar¹ is heteroaryl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar¹ is unsubstituted heteroaryl.

In a further aspect, Ar¹ is pyridinyl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar¹ is pyridinyl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar¹ is pyridinyl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar¹ is unsubstituted pyridinyl. In a still further aspect, Ar¹ is selected from 3-pyridinyl and 4-pyridinyl.

In a further aspect, Ar¹ is pyrazolyl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar¹ is pyrazolyl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar¹ is pyrazolyl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar¹ is unsubstituted pyrazolyl.

In a further aspect, Ar¹ is methylpyrazolyl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar¹ is methylpyrazolyl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar¹ is methylpyrazolyl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar¹ is unsubstituted methylpyrazolyl.

In a further aspect, Ar¹ is selected from:

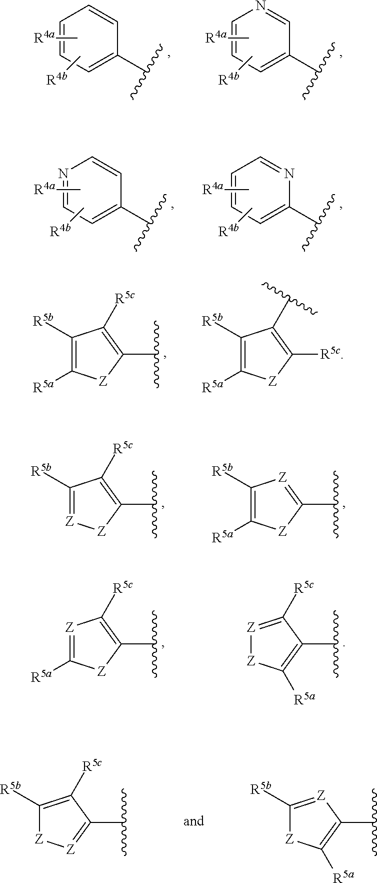

In a further aspect, Ar¹ is selected from:

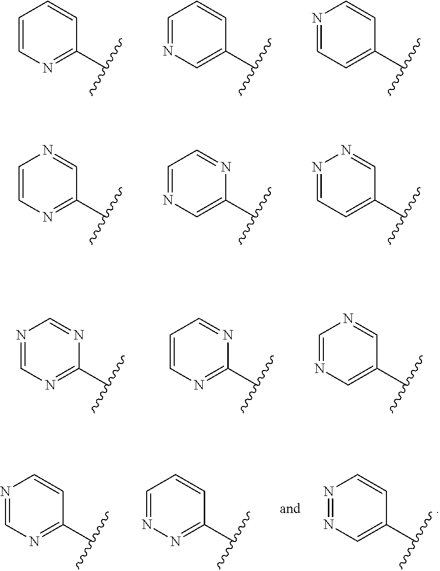

In a further aspect, Ar¹ is selected from:

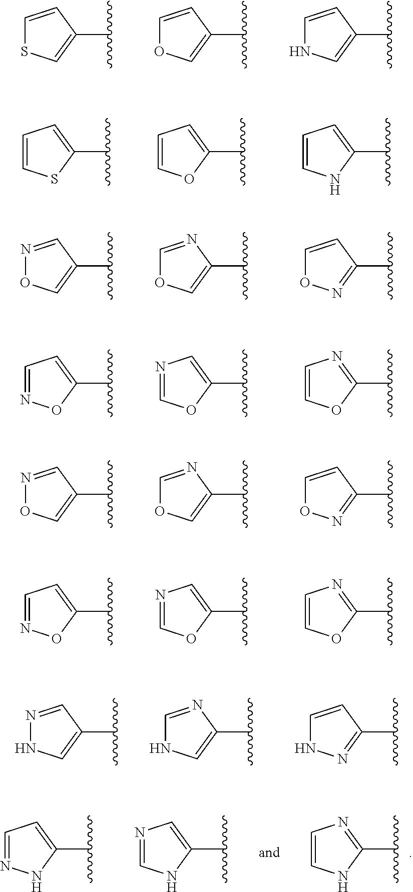

In a further aspect, Ar¹ is selected from:

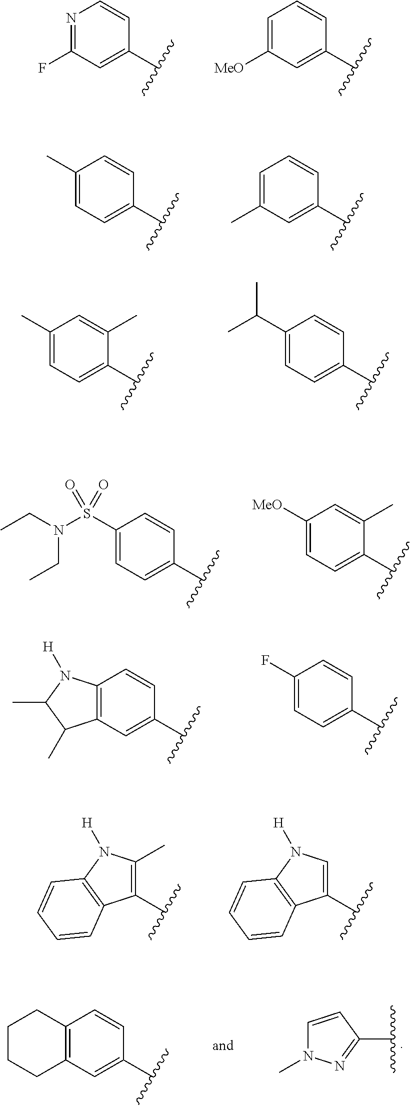

c. Ar² Groups

In one aspect, Ar² is selected from monocyclic aryl, bicyclic aryl, monocyclic heteroaryl, bicyclic heteroaryl, and tricyclic heteroaryl or R¹ is taken together with a substituent of Ar² to form a five-, six-, or seven-membered heterocycloalkyl ring. In a further aspect, Ar² is substituted. In a still further aspect, Ar² is unsubstituted.

In a further aspect, Ar² is selected from monocyclic aryl and monocyclic heteroaryl. In a still further aspect, Ar² is selected from bicyclic aryl, bicyclic heteroaryl, and tricyclic heteroaryl. In yet a further aspect, Ar² is selected from monocyclic aryl and bicyclic aryl. In an even further aspect, Ar² is selected from monocyclic heteroaryl, bicyclic heteroaryl, and tricyclic heteroaryl.

In a further aspect, Ar² is substituted with 0, 1, 2, or 3 groups independently selected from halogen, —OH, —SH, —CN, —NO₂, —NH₂, C1-C5 alkyl, C1-C4 alkoxy, C1-C4 alkylamino, and (C1-C4)(C1-C4) dialkylamino, carboxyl, carboxy(C1-C4)alkyl, phenyl, benzyl, benzyloxy, C1-C5 alkenyl, and C1-C6 sulfonamido. In a still further aspect, Ar² is substituted with 0, 1, or 2 groups independently selected from halogen, —OH, —SH, —CN, —NO₂, —NH₂, C1-C5 alkyl, C1-C4 alkoxy, C1-C4 alkylamino, and (C1-C4)(C1-C4) dialkylamino, carboxyl, carboxy(C1-C4)alkyl, phenyl, benzyl, benzyloxy, C1-C5 alkenyl, and C1-C6 sulfonamido. In yet a further aspect, Ar² is substituted with 0 or 1 group selected from halogen, —OH, —SH, —CN, —NO₂, —NH₂, C1-C5 alkyl, C1-C4 alkoxy, C1-C4 alkylamino, and (C1-C4)(C1-C4) dialkylamino, carboxyl, carboxy(C1-C4)alkyl, phenyl, benzyl, benzyloxy, C1-C5 alkenyl, and C1-C6 sulfonamido. In an even further aspect, Ar² is monosubstituted with a group selected from halogen, —OH, —SH, —CN, —NO₂, —NH₂, C1-C5 alkyl, C1-C4 alkoxy, C1-C4 alkylamino, and (C1-C4)(C1-C4) dialkylamino, carboxyl, carboxy(C1-C4)alkyl, phenyl, benzyl, benzyloxy, C1-C5 alkenyl, and C1-C6 sulfonamido.

In a further aspect, Ar² has a structure represented by a formula selected from:

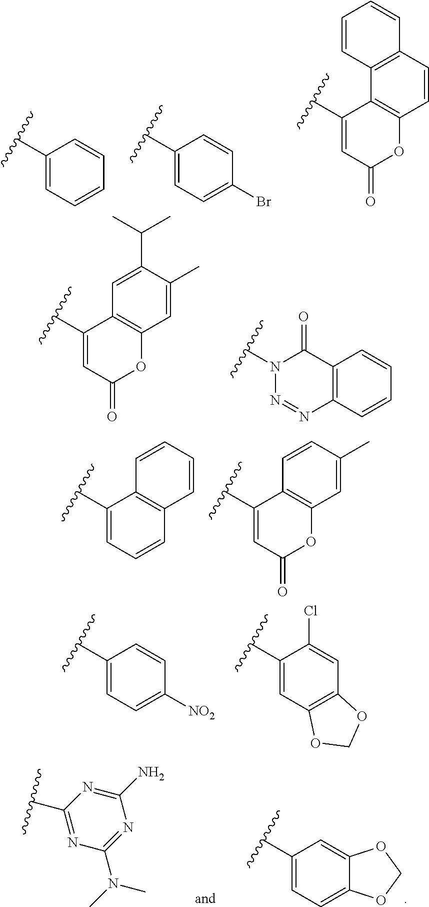

d. Ar³ Groups

In one aspect, Ar³ is selected from aryl and heteroaryl and substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino.

In a further aspect, Ar³ is selected from aryl and heteroaryl and substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar³ is selected from aryl and heteroaryl and monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar³ is selected from aryl and heteroaryl and unsubstituted.

In a further aspect, Ar³ is aryl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar³ is aryl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar³ is aryl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar³ is unsubstituted aryl.

In a further aspect, Ar³ is phenyl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar³ is phenyl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar³ is phenyl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar³ is unsubstituted phenyl.

In a further aspect, Ar³ is heteroaryl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar³ is heteroaryl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar³ is heteroaryl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar³ is unsubstituted heteroaryl.

In a further aspect, Ar³ is pyridinyl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar³ is pyridinyl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar³ is pyridinyl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar³ is unsubstituted pyridinyl. In a still further aspect, Ar³ is selected from 3-pyridinyl and 4-pyridinyl.

In a further aspect, Ar³ is pyrazolyl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar³ is pyrazolyl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar³ is pyrazolyl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar³ is unsubstituted pyrazolyl.

In a further aspect, Ar³ is methylpyrazolyl substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino. In a still further aspect, Ar³ is methylpyrazolyl substituted with 0 or 1 group selected from —OH, —SH, —CN, —NO₂, —NH₂, C1-C4 alkyl, C1-C4 alkoxy, C1-C4 alkylamino, and (C1-C4)(C1-C4) dialkylamino. In yet a further aspect, Ar³ is methylpyrazolyl monosubstituted with a group selected from —OH, —SH, —CN, —NO₂, —NH₂, C1-C4 alkyl, C1-C4 alkoxy, C1-C4 alkylamino, and (C1-C4)(C1-C4) dialkylamino. In an even further aspect, Ar³ is unsubstituted methylpyrazolyl.

2. Example Compounds

In various aspects, a compound is selected from:

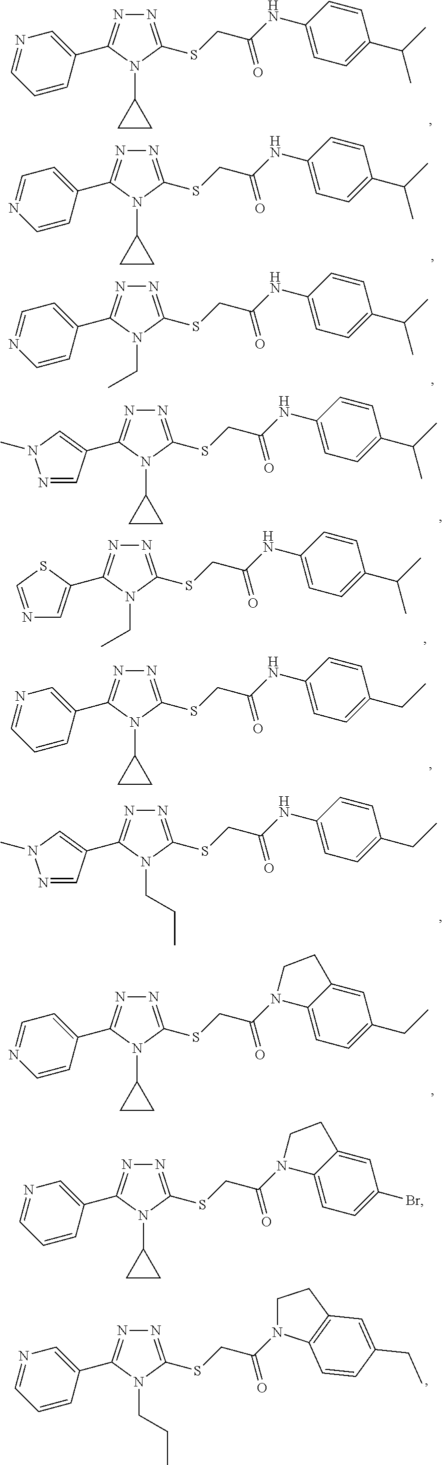

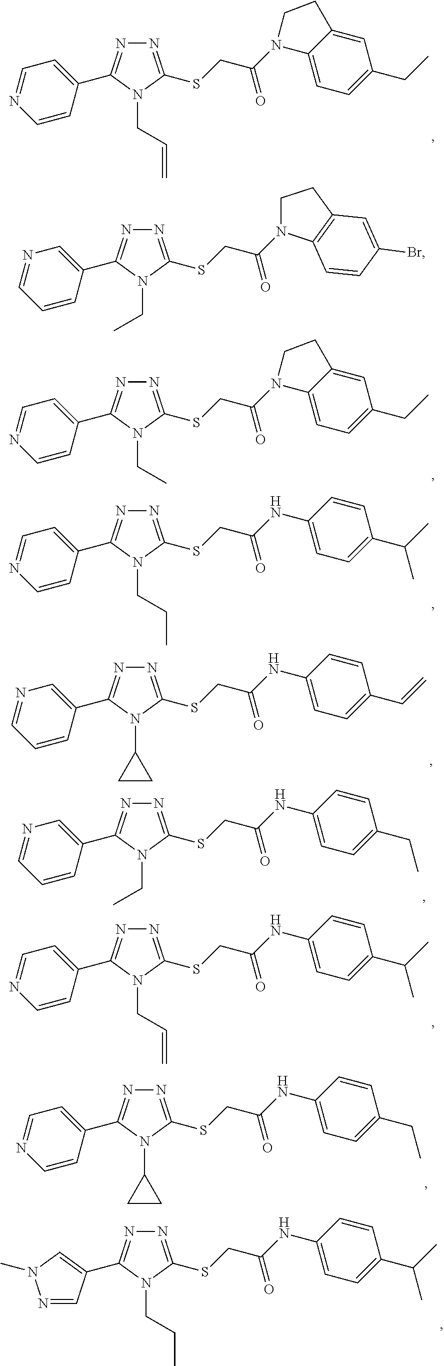

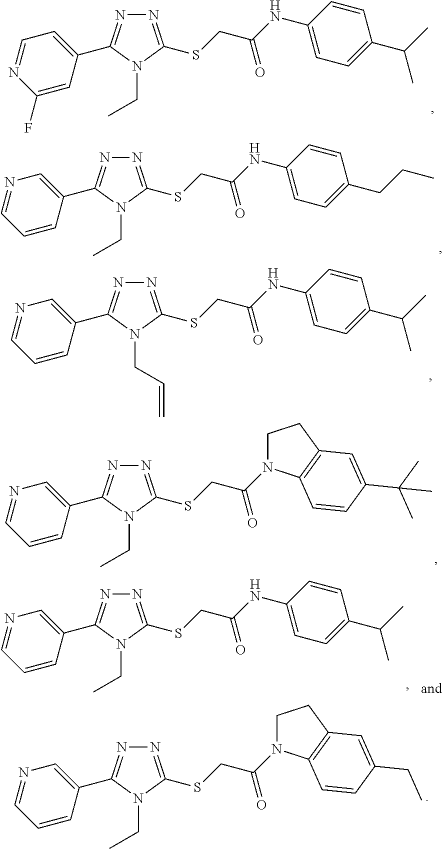

In a further aspect, a compound is selected from:

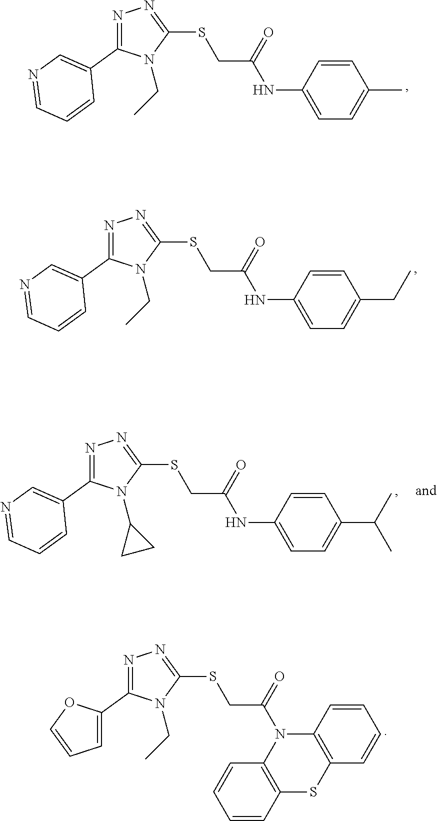 [SMILES: CCn1c(SCC(=O)Nc2ccc(C)cc2)nnc1-c1cccnc1 ; CCc1ccc(NC(=O)CSc2nnc(-c3cccnc3)n2CC)cc1 ; CC(C)c1ccc(NC(=O)CSc2nnc(-c3cccnc3)n2C2CC2)cc1 ; CCn1c(SCC(=O)N2c3ccccc3Sc3ccccc32)nnc1-c1ccco1]

It is understood that the disclosed compounds can be used in connection with the disclosed methods, compositions, kits, and uses.

### D. METHODS OF MAKING THE COMPOUNDS

In one aspect, the invention relates to methods of making compounds useful as inhibitors of insect odorant sensory receptors. In one aspect, the invention relates to the disclosed synthetic manipulations. In a further aspect, the disclosed compounds comprise the products of the synthetic methods described herein. In a further aspect, the disclosed compounds comprise a compound produced by a synthetic method described herein. In a still further aspect, the invention comprises a pharmaceutical composition comprising a therapeutically effective amount of the product of the disclosed methods and a pharmaceutically acceptable carrier. In a still further aspect, the invention comprises a method for manufacturing a medicament comprising combining at least one compound of any of disclosed compounds or at least one product of the disclosed methods with a pharmaceutically acceptable carrier or diluent.

The compounds of this invention can be prepared by employing reactions as shown in the disclosed schemes, in addition to other standard manipulations that are known in the literature, exemplified in the experimental sections or clear to one skilled in the art. The following examples are provided so that the invention might be more fully understood, are illustrative only, and should not be construed as limiting. For clarity, examples having fewer substituents can be shown where multiple substituents are allowed under the definitions disclosed herein.

It is contemplated that each disclosed method can further comprise additional steps, manipulations, and/or components. It is also contemplated that any one or more step, manipulation, and/or component can be optionally omitted from the invention. It is understood that a disclosed method can be used to provide the disclosed compounds. It is also understood that the products of the disclosed methods can be employed in the disclosed compositions, kits, and uses.

1. Route I

In one aspect, intermediates useful for the preparation of compounds of the present invention can be prepared generically by the synthetic scheme as shown below.

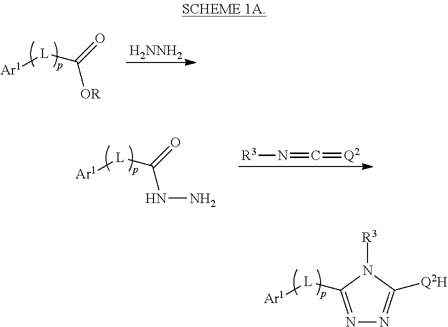

Compounds are represented in generic form, with substituents as noted in compound descriptions elsewhere herein. A more specific example is set forth below.

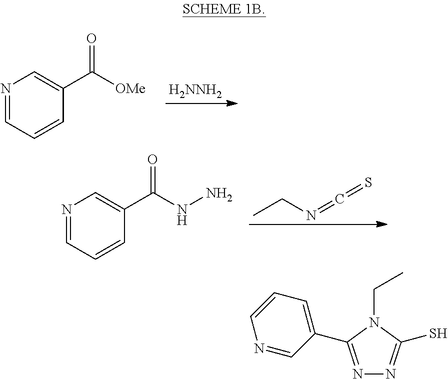

In this example, methyl nicotinate is treated with hydrazine to yield nicotinohydrazide. This product is reacted with isothiocyanatoethane to provide 4-ethyl-5-(pyridin-3-yl)-4H-1,2,4-triazole-3-thiol.

Thus, in one aspect, the invention relates to a method for preparing a compound, the method comprising the steps of: (a) providing a compound having a structure represented by a formula:

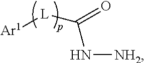

wherein Ar¹ is selected from aryl and heteroaryl and substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino; and reacting with R³—N═C═S or R³⁻N═C═O, thereby yielding a product having the formula:

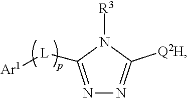

wherein Q¹ is selected from O, S, and NR³; wherein R³ is selected from hydrogen, (C1-C5) alkyl, and Cy¹.

In a further aspect, providing comprises treating a compound having a structure represented by a formula:

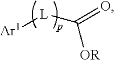

wherein R is optionally substituted and selected from alkyl, heteroalkyl, aryl, and heteroaryl, with hydrazine, thereby yielding a product having the formula:

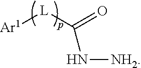

2. Route II

In one aspect, compounds of the present invention can be prepared generically by the synthetic scheme as shown below.

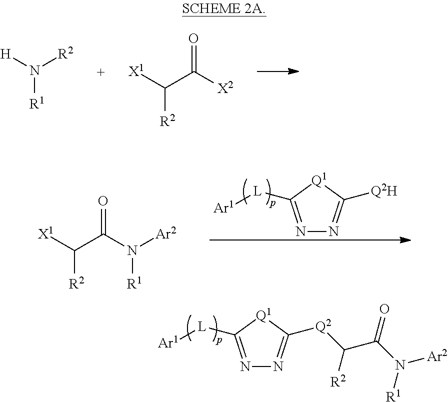

Compounds are represented in generic form, with substituents as noted in compound descriptions elsewhere herein. A more specific example is set forth below.

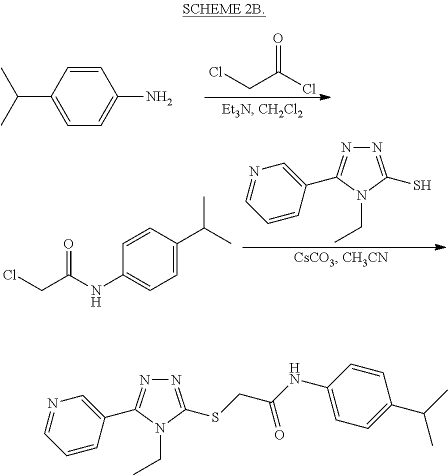

In this example, 4-isopropylaniline is treated with 2-chloroacetyl chloride to form the corresponding amide. This product can then be reacted with, for example, 4-ethyl-5-(pyridin-3-yl)-4H-1,2,4-triazole-3-thiol from Route I, above, to yield 2-((4-ethyl-5-(pyridin-3-yl)-4H-1,2,4-triazol-3-yl)thio)-N-(4-isopropylphenyl)acetamide.

Thus, in one aspect, the invention relates to a method for preparing a compound, the method comprising the steps of: providing a compound having a structure represented by a formula:

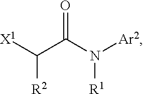

wherein X¹ is a leaving group; R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocycloalkyl ring; and wherein R² is selected from hydrogen and optionally substituted (C1-C4) alkyl, reacting with a compound having a structure represented by a formula:

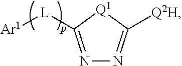

wherein p is an integer selected from 0 and 1; wherein L is a divalent organic groups having from 1 to 9 non-hydrogen members; wherein each of Q¹ and Q² is independently selected from O, S, and NR³; and wherein Ar¹ is selected from aryl and heteroaryl and substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino, thereby yielding a product having the formula:

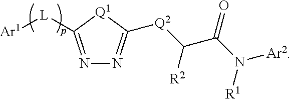

In a further aspect, providing comprises treating a compound having a structure represented by a formula:

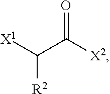

wherein X¹ is a leaving group; wherein X² is selected from chloro and bromo; and wherein R² is selected from hydrogen and optionally substituted (C1-C4) alkyl, with a compound having the formula:

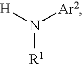

wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocycloalkyl ring, thereby yielding a product having the formula:

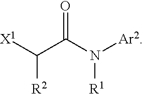

In a further aspect, the method further comprises oxidation to yield a product having the formula:

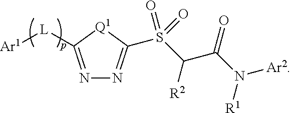

In a further aspect, the method further comprises reduction to yield a product having the formula:

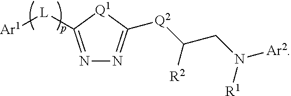

3. Route III

In one aspect, compounds of the present invention can be prepared generically by the synthetic scheme as shown below.

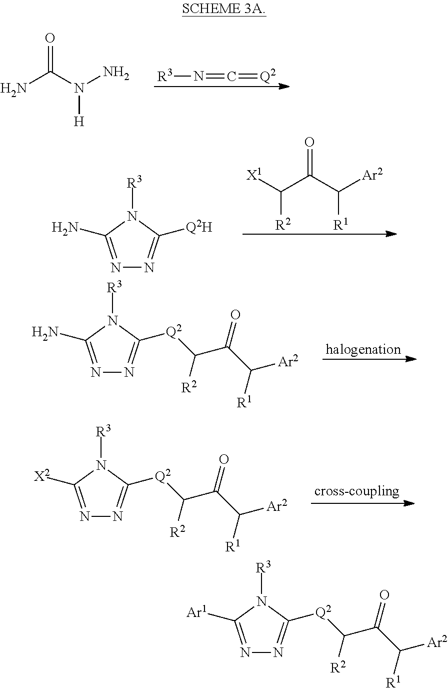

Compounds are represented in generic form, with substituents as noted in compound descriptions elsewhere herein. A more specific example is set forth below.

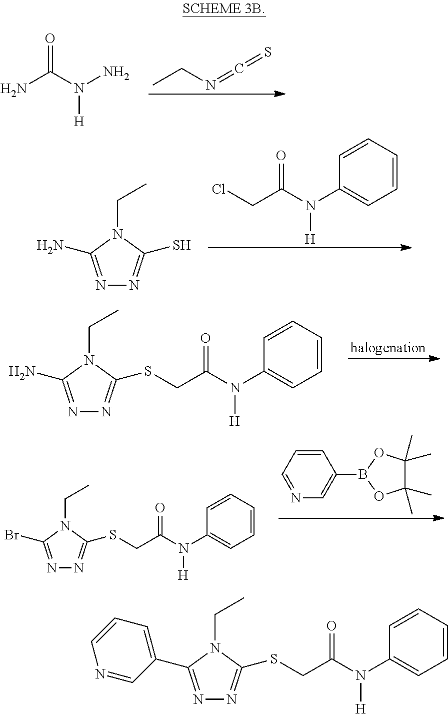

In this example, hydrazinecarboxamide is treated with isothiocyanatoethane to provide 5-amino-4-ethyl-4H-1,2,4-triazole-3-thiol. This product can be reacted with, for example, 2-chloro-N-phenylacetamide to yield 2-((5-amino-4-ethyl-4H-1,2,4-triazol-3-yl)thio)-N-phenylacetamide. Halogenation affords 2-((5-bromo-4-ethyl-4H-1,2,4-triazol-3-yl)thio)-N-phenylacetamide, which can be reacted in a transition met al mediated cross-coupling reaction (e.g., Suzuki coupling) to provide 2-((4-ethyl-5-(pyridin-3-yl)-4H-1,2,4-triazol-3-yl)thio)-N-phenylacetamide. For example, halogenation can be accomplished by reaction with a diazotiation reagent such as isoamylnitrite or sodium nitrite, followed by reaction with an appropriate halogen source such as copper (I) bromide, affords.

Thus, in one aspect, the invention relates to a method for preparing a compound, the method comprising the steps of: providing a compound having a structure represented by a formula:

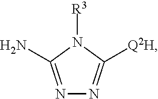

wherein Q² is selected from O, S, and NR³; and wherein R³ is selected from hydrogen, (C1-C5) alkyl, and Cy¹, reacting with a compound having a structure represented by a formula:

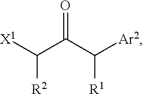

wherein X¹ is a leaving group; wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocycloalkyl ring; and wherein R² is selected from hydrogen and optionally substituted (C1-C4) alkyl, thereby yielding a product having the formula:

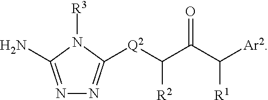

In a further aspect, providing comprises treating a compound having a structure represented by a formula:

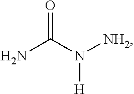

with R³—N═C═S, R³—N═C═O, thereby yielding a product having the formula:

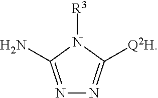

In a further aspect, the method further comprises halogenation to yield a product having the formula:

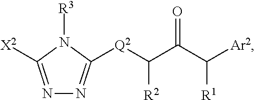

wherein X² is selected from chloro, bromo, and iodo.

In a further aspect, the method further comprises transition met al-mediated cross-coupling reaction to yield a product having the formula:

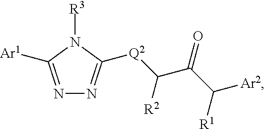

wherein Ar¹ is selected from aryl and heteroaryl and substituted with 0, 1, or 2 groups independently selected from —OH, —SH, —CN, —NO₂, —NH₂, C1-C4 alkyl, C1-C4 alkoxy, C1-C4 alkylamino, and (C1-C4)(C1-C4) dialkylamino.

### E. COMPOSITIONS

In one aspect, the invention relates to compositions comprising the disclosed compounds, or a functionally acceptable salt, hydrate, solvate, or polymorph thereof. In a further aspect, the invention relates to compositions produced by a disclosed method.

In a further aspect, the compound inhibits insect host sensing, plant sensing, or other olfactory driven behaviors. In a still further aspect, the composition inhibits insect host-sensing. In a yet further aspect, the compound agonizes Orco ion channels. In an even further aspect, the compound antagonizes Orco ion channels. In a still further aspect, the compound potentiates Orco ion channels.

In a further aspect, the compositions comprise a compound that binds to and/or modulates insect Orco proteins, combined with a suitable carrier.

In a further aspect, a compound that binds to and/or modulates insect ORX is substantially absent from the composition. In a still further aspect, the composition further comprises a compound that binds to and/or modulates insect ORX.

In a further aspect, the composition further comprises an insect repellant.

It is understood that the disclosed compositions can be prepared from the disclosed compounds. It is also understood that the disclosed compositions can be employed in the disclosed methods of using.

It is also contemplated that that the concentrations of the compound in the composition can vary. In non-limiting embodiments, for example, the compositions may include in their final form, for example, at least about 0.0001%, 0.0002%, 0.0003%, 0.0004%, 0.0005%, 0.0006%, 0.0007%, 0.0008%, 0.0009%, 0.0010%, 0.0011%, 0.0012%, 0.0013%, 0.0014%, 0.0015%, 0.0016%, 0.0017%, 0.0018%, 0.0019%, 0.0020%, 0.0021%, 0.0022%, 0.0023%, 0.0024%, 0.0025%, 0.0026%, 0.0027%, 0.0028%, 0.0029%, 0.0030%, 0.0031%, 0.0032%, 0.0033%, 0.0034%, 0.0035%, 0.0036%, 0.0037%, 0.0038%, 0.0039%, 0.0040%, 0.0041%, 0.0042%, 0.0043%, 0.0044%, 0.0045%, 0.0046%, 0.0047%, 0.0048%, 0.0049%, 0.0050%, 0.0051%, 0.0052%, 0.0053%, 0.0054%, 0.0055%, 0.0056%, 0.0057%, 0.0058%, 0.0059%, 0.0060%, 0.0061%, 0.0062%, 0.0063%, 0.0064%, 0.0065%, 0.0066%, 0.0067%, 0.0068%, 0.0069%, 0.0070%, 0.0071%, 0.0072%, 0.0073%, 0.0074%, 0.0075%, 0.0076%, 0.0077%, 0.0078%, 0.0079%, 0.0080%, 0.0081%, 0.0082%, 0.0083%, 0.0084%, 0.0085%, 0.0086%, 0.0087%, 0.0088%, 0.0089%, 0.0090%, 0.0091%, 0.0092%, 0.0093%, 0.0094%, 0.0095%, 0.0096%, 0.0097%, 0.0098%, 0.0099%, 0.0100%, 0.0200%, 0.0250%, 0.0275%, 0.0300%, 0.0325%, 0.0350%, 0.0375%, 0.0400%, 0.0425%, 0.0450%, 0.0475%, 0.0500%, 0.0525%, 0.0550%, 0.0575%, 0.0600%, 0.0625%, 0.0650%, 0.0675%, 0.0700%, 0.0725%, 0.0750%, 0.0775%, 0.0800%, 0.0825%, 0.0850%, 0.0875%, 0.0900%, 0.0925%, 0.0950%, 0.0975%, 0.1000%, 0.1250%, 0.1500%, 0.1750%, 0.2000%, 0.2250%, 0.2500%, 0.2750%, 0.3000%, 0.3250%, 0.3500%, 0.3750%, 0.4000%, 0.4250%, 0.4500%, 0.4750%, 0.5000%, 0.5250%, 0.0550%, 0.5750%, 0.6000%, 0.6250%, 0.6500%, 0.6750%, 0.7000%, 0.7250%, 0.7500%, 0.7750%, 0.8000%, 0.8250%, 0.8500%, 0.8750%, 0.9000%, 0.9250%, 0.9500%, 0.9750%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 60%, 65%, 70%, 75%, 80%, 85%, 90%, 95%, or 99% or any range derivable therein. In non-limiting aspects, the percentage can be calculated by weight or volume of the total composition. A person of ordinary skill in the art would understand that the concentrations can vary depending on the addition, substitution, and/or subtraction of the compounds, agents, or active ingredients, to the disclosed methods and compositions.

### F. METHODS OF THERMALLY VOLATIZING A COMPOUND

In one aspect, the invention relates to methods comprising thermally volatizing an ORco ion channel agonist, thereby forming a volatilization product, and exposing an ORco ion channel to the volatilization product.

In one aspect, the invention relates to methods comprising thermally volatizing a compound having a structure represented by a formula:

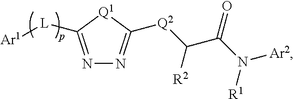

wherein p is an integer selected from 0 and 1; wherein each of Q¹ and Q² is independently selected from O, S, and NR³; wherein R³, when present, is selected from hydrogen, C1-C5 alkyl, and Cy¹; wherein Cy¹, when present, is selected from C1-C5 cycloalkyl and C1-C5 heterocycloalkyl and wherein Cy¹, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino; wherein L is a divalent organic group having from 1 to 9 non-hydrogen members; wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocycloalkyl ring; wherein R² is selected from hydrogen and optionally substituted C1-C4 alkyl; and wherein Ar¹ is selected from aryl and heteroaryl and wherein Ar¹ is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino, or a derivative thereof, thereby forming a volatilization product.

In a further aspect, thermally volatizing is via a torch, ionizing radiation, hot plate, sunlight, electrical pulse, a laser, an oven, a gas heating element, an electric-powered heating element, chemical reaction, and microwave irradiation, or a mixture thereof.

In a further aspect, thermally volatizing is at a temperature of from about 50° C. to about 200° C. In a still further aspect, thermally volatizing is at a temperature of from about 60° C. to about 200° C. In yet a further aspect, thermally volatizing is at a temperature of from about 70° C. to about 200° C. In an even further aspect, thermally volatizing is at a temperature of from about 80° C. to about 200° C. In a still further aspect, thermally volatizing is at a temperature of from about 90° C. to about 200° C. In yet a further aspect, thermally volatizing is at a temperature of from about 100° C. to about 200° C. In an even further aspect, thermally volatizing is at a temperature of from about 110° C. to about 200° C. In a still further aspect, thermally volatizing is at a temperature of from about 120° C. to about 200° C. In yet a further aspect, thermally volatizing is at a temperature of from about 130° C. to about 200° C. In an even further aspect, thermally volatizing is at a temperature of from about 140° C. to about 200° C. In a still further aspect, thermally volatizing is at a temperature of from about 150° C. to about 200° C. In yet a further aspect, thermally volatizing is at a temperature of from about 160° C. to about 200° C. In an even further aspect, thermally volatizing is at a temperature of from about 170° C. to about 200° C. In a still further aspect, thermally volatizing is at a temperature of from about 180° C. to about 200° C.

In a further aspect, thermally volatizing is at a temperature of from at least about 50° C. In a still further aspect, thermally volatizing is at a temperature of from at least about 60° C. In yet a further aspect, thermally volatizing is at a temperature of from at least about 70° C. In an even further aspect, thermally volatizing is at a temperature of from at least about 80° C. In a still further aspect, thermally volatizing is at a temperature of from at least about 90° C. In yet a further aspect, thermally volatizing is at a temperature of from at least about 100° C. In an even further aspect, thermally volatizing is at a temperature of from at least about 110° C.

In a further aspect, at least 5 wt % of the compound in a system is volatized. In a still further aspect, at least 10 wt % of the compound in a system is volatized. In yet a further aspect, at least 15 wt % of the compound in a system is volatized. In an even further aspect, at least 20 wt % of the compound in a system is volatized. In a still further aspect, at least 25 wt % of the compound in a system is volatized. In yet a further aspect, at least 30 wt % of the compound in a system is volatized. In an even further aspect, at least 40 wt % of the compound in a system is volatized. In a still further aspect, at least 50 wt % of the compound in a system is volatized. In yet a further aspect, at least 60 wt % of the compound in a system is volatized. In an even further aspect, at least 70 wt % of the compound in a system is volatized. In a still further aspect, at least 80 wt % of the compound in a system is volatized. In yet a further aspect, at least 90 wt % of the compound in a system is volatized.

In a further aspect, the method further comprises employing a carrier gas to direct the volatized compound. In a still further aspect, the carrier gas is an inert gas. In yet a further aspect, the carrier gas is nitrogen. In an even further aspect, the carrier gas is air. In a still further aspect, the carrier gas is carbon dioxide.

In a further aspect, the compound is an ORco agonist. In a still further aspect, the compound is an ORco antagonist. In a yet further aspect, the compound potentiates Orco ion channels.

In a further aspect, the composition comprises VUAA0, VUAA1, VUAA4, or VUAnt1, or a mixture thereof. In a still further aspect, the composition comprises VUAA0, VUAA1, or VUAA4, or a mixture thereof. In yet a further aspect, the composition comprises VUAA0 or VUAA1, or a mixture thereof. In an even further aspect, the composition comprises VUAnt1. In a still further aspect, the composition comprises VUAA4. In yet a further aspect, the composition comprises VUAA1. In an even further aspect, the composition comprises VUAA0.

### G. METHODS OF DISRUPTING ODOR SENSING BEHAVIOR

In various aspects, the disclosed compounds and compositions can affect odorant sensing by acting as an agonist, antagonist, or as a potentiator. It is understood that an agonist will accentuate and amplify odor reception whereas an antagonist will turn off or reduce odor reception.

In one aspect, the invention relates to methods for disrupting odorant sensing in an animal having an ORco ion channel, the method comprising thermally volatizing an ORco ion channel agonist, thereby forming a volatilization product, and exposing the animal to the volatilization product.

In a further aspect, methods for disrupting odor sensing behavior in an animal having an ORco ion channel, the method comprising thermally volatizing a compound having a structure represented by a formula:

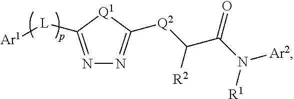

wherein p is an integer selected from 0 and 1; wherein each of Q¹ and Q² is independently selected from O, S, and NR³; wherein R³, when present, is selected from hydrogen, C1-C5 alkyl, and Cy¹; wherein Cy¹, when present, is selected from C1-C5 cycloalkyl and C1-C5 heterocycloalkyl and wherein Cy¹, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino; wherein L is a divalent organic group having from 1 to 9 non-hydrogen members; wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocycloalkyl ring; wherein R² is selected from hydrogen and optionally substituted C1-C4 alkyl; and wherein Ar¹ is selected from aryl and heteroaryl and wherein Ar¹ is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino, or a derivative thereof, thereby forming a volatilization product, and exposing the animal to the volatilization product.

In a further aspect, the compound inhibits insect host, plant, or other forms of chemosensory sensing.

In a further aspect, the compound is an ORco agonist. In a still further aspect, the compound is an ORco antagonist. In a yet further aspect, the compound potentiates Orco ion channels.

In a further aspect, the animal is an arachnid. In a still further aspect, the animal is a crop pest. In yet a further aspect, the animal is a crawling insect. In an even further aspect, the animal is an airborne insect. In a still further aspect, the animal is a blood-sucking insect. In yet a further aspect, the animal is a mosquito. In an even further aspect, the animal is a tick. In a still further aspect, the animal is a bed-bug. In yet a further aspect, the animal is a suborder Ixodida. In an even further aspect, the animal is of the order Diptera. In a still further aspect, the animal is of the order Hemiptera. In yet a further aspect, the animal is of the order Lepidoptera.

In a further aspect, the animal is an insect. In a still further aspect, the insect is a domestic insect. In yet a further aspect, the domestic insect is selected from a bedbug and a cockroach. In an even further aspect, the insect is a nuisance insect. In a still further aspect, the nuisance insect is selected from a midge and a skeeter. In yet a further aspect, the insect is an indoor/outdoor disease vector insect. In an even further aspect, the insect is selected from a termite, a stem-borer, a Gujhia weevil, a cutwork, a thrip, a wheat aphid, a surface grasshopper, a shoot fly, a Galerucid beetle, ajassid, a plume moth borer, a gram pod fly, a hairy caterpillar, a cowpea stem fly, an aphid, a whitefly, a sphinx moth, a leaf caterpillar, a gram pod borer, a gram caterpillar, a pod borer, a cut worm, a pea leaf-miner, a pea stem fly, a pea semi-looper, a blue butterfly, a luceme caterpillar, a stem-borer beetle, a gray weevil, a shoot fly, a sorghum midge, a deccan wingless grasphopper, a Boliver Phadka grasshopper, an earhead bug, a sorghum shoot bug, an earhead caterpillar, a mite, a blister beetle, a leaf roller, a Bahjra midge, a ragi white borer, a black hair caterpillar, a ragi-root aphid, a ragi jassid, an almond weevil, an almond beetle, a San Jose scale, a woolly aphid, a root borer, a tent caterpillar, a leopard moth, an apple blossom thrip, a leaf-defoliating and fruit-eating beetle, an apple leaf-roller, an apple hawk moth, an apple leaf-miner, a blossom thrip, an indian gypsy moth, an apricot chalcid, an apricot weevil, an apricot chafer beetle, a tissue-borer, a gundhi bug, a paddy gall fly, a rice hispa, a blue leaf beetle, a paddy caseworm, a swarming caterpillar, an armyworm, a rice grasshopper, a paddy jassid, a white leaf hopper, a flugorid bug, a paddy thrip, a whorl maggot, a paddy mealy bug, a rice root aphid, a paddy leaf-roller, a paddy skipper, a paddy root weevil, an Asiatic garden beetle, an asparagus beetle, a bean leaf beetle, a beet webworm, a bluegrasss billbug, a brown marmorated stink bug, a cabbage and seedcorn maggot, a cabbage looper, a cabbage webworm, a carpenter ant, a carpenter bee, a carpet beetle, a catalpa sphinx caterpillar, a celery leaftier, a cereal leaf beetle, an European corn borer, a click beetle, a Colorado potato beetle, a confused flour beetle, a corn earworm, a cucumber beetle, a cutworm, a diamondback moth, an eggplant lace bug, a flea beetle, a fungus gnat, a green peach aphid, a hornworm, a hunting billbug, an imported cabbageworm, an indian meal moth, a Japanese beetle, a lace bug, a leaf-footed bug, a Mexican bean beetle, an onion thrip, a parsleyworm, a pepper maggot, a pepper weevil, a pickleworm, a potato aphid, a potato tuberworm, a raspberry crown borer, a rednecked cane borer, a rhubarb curculio, a root-knot nematode, a rose chafer, a rose scale, a sap beetle, a sawtoothed grain beetle, a wireworm, a squash bug, a squash vine borer, a tarnished plant bug, a twig girdler, a twig pruner, a vegetable weevil, a Virginia pine, a sawfly, a wheel bug, a white grub, a whitefringed beetle, a winter grain mite, and a yellow ant.

In a further aspect, exposing comprises application to an agricultural environment. In a still further aspect, exposing comprises application to a potential host. In yet a further aspect, exposing comprises application to a water surface. In an even further aspect, exposing comprises application to a nest, burrow, colony, or other habitation of the animal.

In a further aspect, the method further comprises providing to an insect environment a compound that binds to and/or modulates insect ORX.

In a further aspect, the insect environment comprises an agricultural environment. In a still further aspect, the insect environment comprises a potential host. In a yet further aspect, the insect environment comprises an insect nest.

In a further aspect, the composition comprises VUAA0, VUAA1, VUAA4, or VUAnt1, or a mixture thereof. In a still further aspect, the composition comprises VUAA0, VUAA1, or VUAA4, or a mixture thereof. In yet a further aspect, the composition comprises VUAA0 or VUAA1, or a mixture thereof. In an even further aspect, the composition comprises VUAnt1. In a still further aspect, the composition comprises VUAA4. In yet a further aspect, the composition comprises VUAA1. In an even further aspect, the composition comprises VUAA0.

In another aspect, disclosed herein are methods of repelling insects comprising administering any of the compounds disclosed herein to an area, subject, or insect environment. In one aspect, the disclosed compounds can be administered individually or as an active ingredient in a larger composition or article. It is understood and herein contemplated that the subject, area, or insect environment can include domestic animals, such as companion animals (e.g., dogs, cats, rabbits), livestock, humans, and plants.

In one aspect the disclosed compounds, articles, and compositions can be used to disrupt transmission of insect-borne disease or crop destruction due to insect pests. Thus, in one aspect disclosed herein are methods of disrupting transmission of insect-borne disease or crop destruction due to insect pests comprising providing to an insect environment a compound that binds to and/or agonizes, antagonizes, or potentiates ORco.

### H. MEDIATING ORCO RESPONSE

In one aspect, the invention relates to a method for mediating Orco response, the method comprising providing an effective amount of a disclosed compound, or a salt or tautomer thereof, to a Orco receptor, an Orco/ORX complex, or an Orco/Orco complex, wherein the compound binds and/or modulates the receptor or complex. In a further aspect, the compound agonizes Orco ion channels. In a further aspect, the compound antagonizes Orco ion channels. In a further aspect, the compound potentiates Orco ion channels. In a still further aspect, the Orco ion channels are insect Orco ion channels.

In a further aspect, providing is performed in the absence of a compound that binds to and/or modulates ORX. In a further aspect, the method further comprising providing to an insect environment a compound that binds to and/or modulates ORX. In a still further aspect, the ORX is insect ORX.

### I. METHODS OF USING THE COMPOUNDS AND COMPOSITIONS

Also provided are various methods of using the disclosed compounds.

1. Devices

In one aspect, the invention relates to devices comprising: (a) means for thermally volatizing organic compounds; and (b) an ORco ion channel agonist. Examples of means for thermally volatizing organic compounds include, but are not limited to, a torch, ionizing radiation, hot plate, sunlight, electrical pulse, a laser, an oven, a gas heating element, an electric-powered heating element, and microwave irradiation, or a mixture thereof.

2. Articles

In one aspect, the invention relates to articles comprising the disclosed compounds. In a further aspect, the present invention contemplates the use of a disclosed compound in the manufacture of certain items such as articles. For example, an article may comprise a material that may be pre-made and then dipped, painted or sprayed with the agent. Alternatively, the materials may be formed in the presence of the agent so as to incorporate the agent integrally thereinto.

In a further aspect, a disclosed compound may be used to coat or impregnate various articles of manufacture, the use of which can help deliver the compound to a mosquito environment and/or protect a user of the article from mosquito contact. Such articles include netting, such as the type use to exclude insects from dwelling (i.e., in windows and door ways) or to exclude insects from a particular location, such as a bed or room.

In a further aspect, other articles of manufacture include clothing or fabric from which clothing can be produced. Clothing includes hats, veils, masks, shoes and gloves, as well as shirts, pants and underwear. Other articles include bedding, such as sheets, nets, blankets, pillow cases, and mattresses. Still additional articles include tarps, tents, awnings, door flaps, screens, or drapes.

In various aspects, the invention relates to an article comprising a compound that binds to and/or modulates insect Orco ion channels. In a further aspect, the article is formed as clothing or netting. In a still further aspect, the compound inhibits insect host sensing and other olfactory driven behaviors. In a yet further aspect, the compound agonizes insect Orco ion channels. In an even further aspect, the compound antagonizes insect Orco ion channels. In a still further aspect, the compound potentiates insect Orco ion channels.

In a further aspect, the invention relates to an article comprising a compound that binds to and/or modulates insect Orco ion channels, wherein a compound that binds to and/or modulates insect ORX is substantially absent from the composition. In a still further aspect, the article further comprises a compound that binds to and/or modulates insect ORX.

3. Kits

In one aspect, the invention relates to kits comprising an ORco ion channel agonist, and one or more of: (a) means for thermally volatizing organic compounds; and (b) an insect repellant. In a further aspect, the ORco ion channel agonist is a compound having a structure represented by a formula:

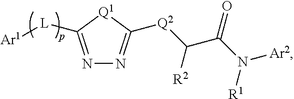

wherein p is an integer selected from 0 and 1; wherein each of Q¹ and Q² is independently selected from O, S, and NR³; wherein R³, when present, is selected from hydrogen, C1-C5 alkyl, and Cy¹; wherein Cy¹, when present, is selected from C1-C5 cycloalkyl and C1-C5 heterocycloalkyl and wherein Cy¹, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino; wherein L is a divalent organic group having from 1 to 9 non-hydrogen members; wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or wherein R¹ is taken together with a substituent of Ar² to form a five-, six-, or seven-membered heterocylcoalkyl ring; wherein R² is selected from hydrogen and optionally substituted C1-C4 alkyl; and wherein Ar¹ is selected from aryl and heteroaryl and wherein Ar¹ is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino, or a derivative thereof.

### J. REFERENCES

Acree et al., Science, 161:1346-1347, 1968.
Antonny et al., J. Biol Chem., 268:2393-2402, 1993.
Baumann et al., Embo. J., 13:5040-5050, 1994.
Benton et al., Cell, 136:149-162, 2009.
Benton et al., PLoS Biol., 4:e20, 2006.
Bemier et al., Anal. Chem., 71:1-7, 1999.
Boekhoff et al., J. Comparative Physiol. B, 160:99-103, 1990.
Bohbot et al., Insect. Mol. Biol, 16:525-537, 2007.
Brady et al., Ann. Trop. Med. Parasitol., 91:S121-122, 1997.
Breer et al., Nature, 345:65-68, 1990.
Camevale et al., Bull. World Health Organ., 56:147-154, 1978.
Clyne et al., Neuron., 22:327-338, 1999.
Clyne et al., Science, 287:1830-1834, 2000.
Cork and Park, Med. Vet. Entomol, 10:269-276, 1996.
CTFA Cosmetic Ingredient Handbook, Vol. 3, p. 3187-3192.
Curtis, Parasitology Today, 11:316-318, 1986.
De Jong and Knols, Acta Trop., 59:333-335, 1995.
De Jong and Knols, Experientia, 51:80-84, 1995.
Dekker et al., J. Med. Entomol, 38:868-871, 2001a.
Dekker et al., Physiol. Entomol, 26:124-134, 2001b.
Dobritsa et al., Neuron., 37:827-841, 2003.
Eiras and Jepson, Bull. Entomol. Res., 81:151-160, 1991.
Elmore and Smith, Insect Biochem. Mol. Biol, 31:791-798, 2001.
Engsontia et al., Insect Biochem. Mol. Biol, 38:387-397, 2008.
Fox et al., Proc. Natl. Acad. Sci. USA, 98:14693-14697, 2001.
Gao and Chess, Genomics, 60:31-39, 1999.
Gilles, Bull. Entomol. Res., 70:525-532, 1980.
Goldman et al., Neuron., 45:661-666, 2005.
Hallem and Carlson, Cell, 125:143-160, 2006.
Hallem et al., Cell, 117:965-979, 2004a.
Hallem et al., Nature, 427:212-213, 2004b.
Hildebrand and Shepherd, Annu. Rev. Neurosci., 20:595-631, 1997.
Hill et al., Science, 298:176-178, 2002.
Holt et al., Science, 298:129-149, 2002.
Jones et al., Curr. Biol., 15:R₁19-R₁21, 2005.
Jones et al., Nature, 445:86-90, 2007.
Kellogg, J. Insect. Physiol, 16:99-108, 1970.
Kim et al., Bioinformatics, 16:767-775, 2000.
Krieger and Breer, Science, 286:720-723, 1999.
Krieger et al., Eur. J. Neurosci., 16:619-628, 2002.
Krieger et al., Insect. Biochem. Mol. Biol, 29:255-267, 1999.
Krieger et al., J. Comp. Physiol. A Neuroethol. Sens. Neural Behav. Physiol., 189:519-526, 2003.
Krotoszynski et al., J. ChromatographicSci., 15:239-244, 1977.
Kwone et al., Proc. Natl. Acad. Set USA, 104:3574-3578, 2007.
Labows Jr., Perfumer & Flavorist, 4:12-17, 1979.
Larsson et al., Neuron., 43:703-714, 2004.
Laue et al., Cell Tissue Res., 288:149-158, 1997.
Lindsay et al., J. Med. Entomol., 30:308-373, 1993.
Lu et al., Curr. Biol, 17:1533-1544, 2007.
Lundin et al., FEBS Lett., 581(29):5601-5604, 2007.
Mboeraand Takken, Rev. Med. Vet. Entomol, 85:355-368, 1997.
McCutcheon's, Detergents and Emulsifiers, North American Edition, 1986.
Meijerink and van Loon, J. Insect Physiol, 45:365-373, 1999.
Meijerink et al., J. Insect Physiol, 47:455-464, 2001.
Merrill et al., InsectMolecul Biol, 12:641-650, 2003.
Merrill et al., J. Neurobiol., 63:15-28, 2005.
Merrill et al., Proc. NatlAcad. Sci. USA, 99:1633-1638, 2002.
Mombaerts, Annu. Rev. Neurosci., 22:487-509, 1999.
Muirhead-Thomson, Brit. Med. J., 1:1114-1117, 1951.
Pelosi andMaida, Comp. Biochem. Physiol. B Biochem. Mol. Biol, 111:503-514, 1995.
Pitts et al., Proc. Natl. Acad. Sci. USA, 101:5058-5063, 2004.
Qiu et al., Chem. Senses, 31:845-863, 2006b.
Qiu et al., Med. Vet. Entomol, 20:280-287, 2006a.
Remington's Pharmaceutical Sciences, 18th Ed. Mack Printing Company, 1289-1329, 1990.
Robertson and Wanner, Genome Res., 16:1395-1403, 2006.
Robertson et al., Proc. Natl. Acad. Sci. USA, 100(2): 14537-14542, 2003.
Rutzler et al., J. Comp. Neurol, 499:533-545, 2006.
Sato et al., Nature, 452(7190): 1002-1006, 2008.
Schreck et al., J. Am. Mosq. Control Assoc., 6:406-410, 1990.
Scott et al., Cell, 104:661-673, 2001.
Smith, Neuron., 22:203-204, 1999.
Stengl, J. Comp. Physiol. [A], 174:187-194, 1994.
Storkuhl and Kettler, Proc. Natl. Acad. Sci. USA, 98:9381-9385, 2001.
Suh et al., Curr. Biol, 17:905-908, 2007.
Takken and Knols, Annu. Rev. Entomol, 44:131-157, 1999.
Takken et al., J. Insect Behavior, 10:395-407, 1997.
Takken, Insect Sci. Applns., 12:287-295, 1991.
Thomas, Brit. Med. J., 2:1402, 1951.
Vosshall et al., Cell, 102:147-159, 2000.
Vosshall et al., Cell, 96:725-736, 1999.
Vosshall, Chem. Senses, 26:207-213, 2001.
Vosshall and Hansson, Chem. Senses, advanced access, pub. 3/25/11.
Wetzel et al., Proc. NatlAcad. Sci. USA, 98:9377-9380, 2001.
Wicher et al., Nature, 452(7190): 1007-1011, 2008.
Wistrand et al., Protein Sci., 15:509-521, 2006.
Xia et al., Proc. Natl. Acad. Sci. USA, 105:6433-6438, 2008.
Zwiebel and Takken, Insect Biochem. Molec. Biol, 34:645-652, 2004.

The following patent references are specifically incorporated herein by reference: U.S. Pat. No. 2,798,053; U.S. Pat. No. 3,755,560; U.S. Pat. No. 4,418,534; U.S. Pat. No. 4,421,769; U.S. Pat. No. 4,509,949; U.S. Pat. No. 4,599,379; U.S. Pat. No. 4,628,078; U.S. Pat. No. 4,835,206; U.S. Pat. No. 4,849,484; U.S. Pat. No. 5,011,681; U.S. Pat. No. 5,087,445; U.S. Pat. No. 5,100,660; U.S. Pat. No. 5,567,430; U.S. Pat. No. 5,698,210; U.S. Pat. No. 5,824,328; U.S. Pat. No. 5,846,553; U.S. Pat. No. 5,858,384; U.S. Pat. No. 5,858,386; U.S. Pat. No. 5,885,605; U.S. Pat. No. 5,902,596; U.S. Pat. No. 5,983,390; U.S. Pat. No. 6,001,382; U.S. Pat. No. 6,335,027; U.S. Pat. No. 6,337,078; U.S. Pat. No. 6,346,262; U.S. Pat. No. 6,350,461; U.S. Pat. No. 6,387,386; U.S. Pat. No. 6,391,328; U.S. Pat. No. 7,090,147; U.S. Pat. No. 7,306,167; U.S. Patent Publn. 2006/0260183; and U.S. Patent Publn. 2007/0160637.

### K. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Several methods for preparing the compounds of this invention are illustrated in the following Examples. Starting materials and the requisite intermediates are in some cases commercially available, or can be prepared according to literature procedures or as illustrated herein. The Examples are provided herein to illustrate the invention, and should not be construed as limiting the invention in any way. The Examples are typically depicted in free base form, according to the IUPAC naming convention. Examples are provided herein to illustrate the invention, and should not be construed as limiting the invention in any way.

### 1. General Methods

All non-aqueous reactions were performed in flame-dried or oven dried round-bottomed flasks under an atmosphere of argon. Stainless steel syringes or cannulae were used to transfer air- and moisture-sensitive liquids. Reaction temperatures were controlled using a thermocouple thermometer and analog hotplate stirrer. Reactions were conducted at room temperature (rt, approximately 23° C.) unless otherwise noted. Analytical thin-layer chromatography (TLC) was performed on E. Merck silica gel 60 F254 plates and visualized using UV, ceric ammonium molybdate, potassium permanganate, and anisaldehyde stains. Yields were reported as isolated, spectroscopically pure compounds.

### 2. Materials

Solvents were obtained from either an MBraun MB-SPS solvent system or freshly distilled (tetrahydrofuran was distilled from sodium-benzophenone; diethyl ether was distilled from sodium-benzophenone and used immediately). VUANT1 (VU0183254-2-[[4-ethyl-5-(2-furanyul)-4H-1,2,4-triazol-3-yl]thio]-1-(10OH-phenothiazin-10-yl)-ethanone, CAS No. 663412-40-6) was purchased from Molport. Commercial reagents were used as received.

### 3. Synthesis of 4-cyclopropyl-5-(pyridin-4-yl)-4H-1,2,4-triazole-3-thiol

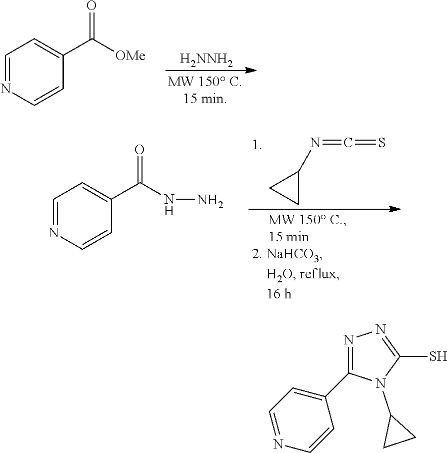 [SMILES: COC(=O)c1ccncc1 ; "H2NNH2" ; "MW 150° C.15 min." ; NNC(=O)c1ccncc1 ; S=C=NC1CC1 ; Sc1nnc(-c2ccncc2)n1C1CC1]

### a. Preparation of Isonicotinohydrazide

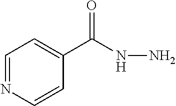

To a solution of methyl isonicotinate (100 mg, 0.73 mmol) in 0.3 mL of ethanol was added hydrazine hydrate (0.35 mL, 7.29 mmol). This reaction mixture was heated in a microwave reactor for 5 min at 150° C. The reaction was allowed to cool to room temperature and diluted with 10 mL of MeOH, then concentrated. The residue was purified by column chromatography with MeOH/CH₂Cl₂ (1:4) to afford 84 mg (75%) of the desired product. ¹H NMR (MeOD) δ 8.70 (dd, J=4.8, 1.6 Hz, 2H), 7.77 (dd, J=4.4, 1.6 Hz, 2H). LRMS calculated for C₆H₇N₃O (M+H) m/z: 137.05 Measured 137.1 m/z.

### b. Preparation of 4-cyclopropyl-5-(pyridin-4-yl)-4H-1,2,4-triazole-3-thiol

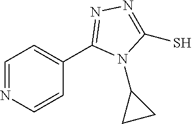 [SMILES: Sc1nnc(-c2ccncc2)n1C1CC1]

To a solution of isonicotinohydrazide (0.61 mmol) in 1.0 mL of ethanol was added isothiocyanatocyclopropane (0.74 mmol). This reaction mixture was heated in a microwave reactor for 15 min at 150° C., cooled to room temperature and concentrated. The residue was then re-dissolved 10 ml of H₂O and K₂CO₃ (0.74 mmol) was added, then the solution was brought to reflux. After 16 h, the reaction was allowed to cool to room temperature, diluted with methanol and concentrated. The residue was purified by column chromatography with methanol/CH₂Cl₂ (1:6) to afford the desired product.

### 4. Synthesis of 4-ethyl-5-(pyridin-3-yl)-4H-1,2,4-triazole-3-thiol

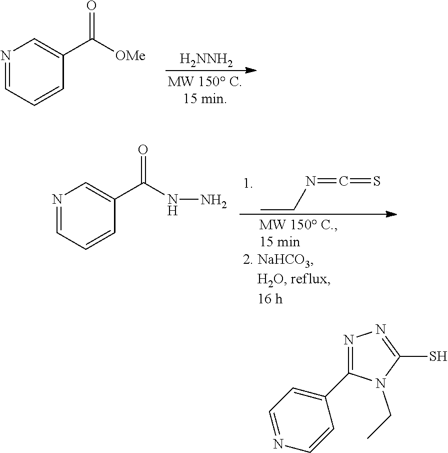

### a. Preparation of Nicotinohydrazide

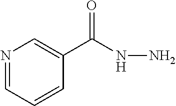

To a solution of methyl nicotinate (0.73 mmol) in 0.3 mL of ethanol was added hydrazine hydrate (0.35 mL, 7.29 mmol). This reaction mixture was heated in a microwave reactor for 5 min at 150° C. The reaction was allowed to cool to room temperature and diluted with 10 mL of MeOH, then concentrated. The residue was purified by column chromatography with MeOH/CH₂Cl₂ (1:4) to afford 84 mg (75%) of the desired product.

### b. Preparation of 4-ethyl-5-(pyridin-3-yl)-4H-1,2,4-triazole-3-thiol

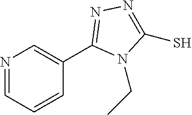

To a solution of nicotinohydrazide (0.61 mmol) in 1.0 mL of ethanol was added isothiocyanatocyclopropane (0.74 mmol). This reaction mixture was heated in a microwave reactor for 15 min at 150° C., cooled to room temperature and concentrated. The residue was then re-dissolved 10 ml of H₂O and K₂CO₃ (0.74 mmol) was added, then the solution was brought to reflux. After 16 h, the reaction was allowed to cool to room temperature, diluted with methanol and concentrated. The residue was purified by column chromatography with methanol/CH₂Cl₂ (1:6) to afford the desired product.

### 5. Synthesis of Compound 1 (VUAA0)

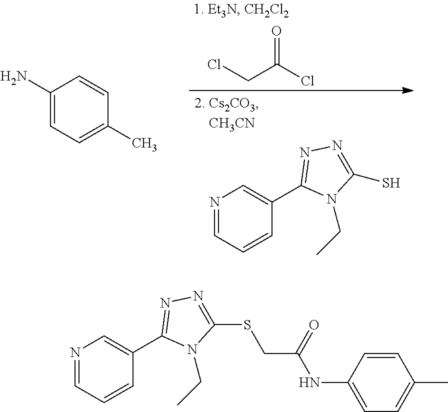

To a solution of p-toluidine (500 μL, 3.64 mmol) in 24.0 mL of CH₂Cl₂ was added triethyl amine (500 μL, 3.64 mmol) and chloroacetyl chloride (300 μL, 3.64 mmol). After 2 h, the solution was concentrated and redissolved in 24.0 mL of acetonitrile. To this solution was added 4-ethyl-5-(pyridin-3-yl)-4H-1,2,4-triazole-3-thiol (500 mg, 2.42 mmol) and cesium carbonate (1.58 g, 4.85 mmol). After 16 h, the reaction was concentrated and the residue was purified by column chromatography with MeOH/CH₂Cl₂ (1:4) to afford 724 mg (77%) of the desired product: ¹H NMR (CDCl₃) δ10.25 (s, 1H), 8.80 (d, J=1.77 Hz, 1H), 8.70 (dd, J=1.4. 4.9 Hz, 1H), 7.88 (dt, J=1.8, 8.0 Hz, 1H), 7.40 (m, 3H), 6.98 (d, J=8.3 Hz, 2H), 4.08 (s, 2H), 3.96 (dd, J=7.3, 14.6 Hz, 2H), 2.20 (s, 3H), 1.30 (t, J=7.2 Hz, 3H); ¹³C NMR (CDCl₃) δ165.9, 153.0, 152.3, 151.1, 148.6, 135.9, 135.4, 133.5, 129.0, 123.6, 123.0, 119.5, 40.0, 36.8, 20.6, 15.1; LRMS calculated for C₁₈H₁₉N₅OS (M+H)+m/z: 354.1 Measured 354.2 m/z.

### 6. Synthesis of Compound 2 (VUAA1)

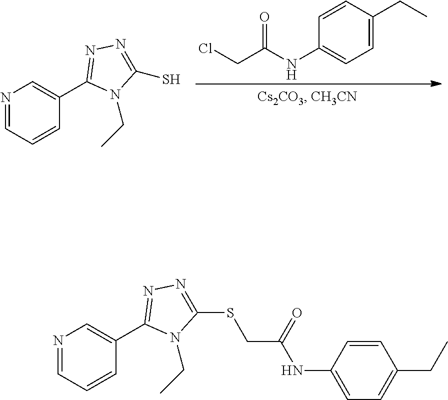 [SMILES: CCn1c(S)nnc1-c1cccnc1 ; CCc1ccc(NC(=O)CCl)cc1 ; CCc1ccc(NC(=O)CSc2nnc(-c3cccnc3)n2CC)cc1]

To a solution of 4-ethyl-5-(pyridin-3-yl)-4H-1,2,4-triazole-3-thiol (550 mg, 2.67 mmol) in 25 mL of MeCN was added cesium carbonate (1.8 g, 5.53 mmol) and 2-chloro-N-(4-ethylphenyl)acetamide (802 mg, 4.08 mmol). After 16 h, the reaction was concentrated and the residue was purified by column chromatography with MeOH/CH₂Cl₂ (1:4) to afford 827 mg (84%) of the desired product: ¹H NMR (CDCl₃) δ10.20 (s, 1H), 8.87 (d, J=1.7 Hz, 1H), 8.79 (q, J=1.6, 4.9 Hz, 1H), 7.98 (dt, J=2.1, 7.9 Hz, 1H), 7.52 (d, J=8.3 Hz, 2H), 7.49 (dd, J=4.8, 7.9 Hz, 1H), 7.13 (d, J=8.3, 2H), 4.02 (s, 2H), 4.01 (dd, J=7.2, 14.7 Hz, 2H), 2.59 (dd, J=7.6, 15.2 Hz, 2H), 1.40 (t, 7.3 Hz, 3H), 1.19 (t, 7.6 Hz, 3H); ¹³C NMR (d-DMSO) δHRMS calculated for C₁₉H₂₁N₅OS (M+H)+m/z: 368.1467 Measured 368.1545 m/z.

### 7. Synthesis of Compound 3 (VUAA4)

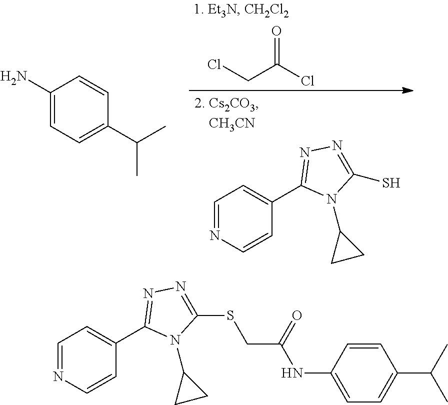

To a solution of 4-isopropylaniline (500 μL, 3.64 mmol) in 24.0 mL of CH₂Cl₂ was added triethyl amine (500 μL, 3.64 mmol) and chloroacetyl chloride (300 μL, 3.64 mmol). After 2 h, the solution was concentrated and redissolved in 24.0 mL of acetonitrile. To this solution was added 4-cyclopropyl-5-(pyridin-3-yl)-4H-1,2,4-triazole-3-thiol (500 mg, 2.42 mmol) and cesium carbonate (1.58 g, 4.85 mmol). After 16 h, the reaction was concentrated and the residue was purified by column chromatography with MeOH/CH₂Cl₂ (1:4) to afford 724 mg (77%) of the desired product: The title compound was prepared following general procedure 1, using 4-isopropylaniline and 4-cyclopropyl-5-(pyridin-3-yl)-4H-1,2,4-triazole-3-thiol: ¹H NMR (CDCl₃) δ9.98 (s, 2H), 8.79 (d, J=5.6 Hz, 2H), 7.72 (d, J=5.6 Hz, 2H), 7.50 (d, J=8.4 Hz, 2H), 7.15 (d, J=8.4 Hz, 2H), 4.04 (s, 1H), 3.26 (m, 1H), 2.85 (m, 1H), 1.24 (m, 2H), 1.18 (d, J=6.8 Hz, 6H), 0.82 (m, 2H); ¹³C NMR (CDCl₃) δ 166.2, 156.0, 154.3, 150.2, 144.9, 135.8, 134.1, 126.7, 122.2, 119.7, 35.8, 33.5, 25.8, 23.9, 9.3; LRMS calculated for C₂₀H₂₃N₅OS (M+H)+m/z: 382.16 Measured 382.3 m/z.

### 8. Single Sensillum Recordings

Single sensillum recordings (SSRs) were performed on single capitate peg (cp) sensillum along the maxillary palps that house three types of olfactory receptor neurons (ORNs). 5- to 7-d-old non-blood fed female Anopheles gambiae that were maintained on 10% sucrose at 12h/12h light/dark cycle were used. Mosquitoes were immobilized by chilling at −20° C. for 1 min before removing wings and legs and then fixing on a glass coverslip covered with double-sided sticky tape. Maxillary palps were extended and held onto the double-sided sticky tape with a piece of hair brush thread. Chloridized silver wires in drawn-out glass capillaries were filled with 0.1% KCl and used as reference and recording electrodes. The reference electrode was placed in the eye, and recording electrode was brought into contact with the sensillum under the microscope (Olympus BX51WI; 800× magnification) by use of a Piezo-Patch micromaniputor (PPM5000; World Precision Instruments). The signals were digitized by the IDAC4 interface box (Syntech, Hilversum, The Netherlands) and offline analysis carried out by using analyzed with AutoSpike v. 3.2 software (Syntech). The extracellular activity of individual capitate peg sensillum ORNs are physiologically distinct and can be characterized into cpA (large), cpB (medium), and cpC (small) based on their spike amplitudes and shape. Responses were quantified by subtracting the number of spikes 1 s before odor stimulation from the number of spikes 1 s after the onset of odor stimulation from individual preparations.

### 9. Huffing Procedure

Each compound was prepared as a 10⁻¹ M (VUAA1) or 10⁻² M (VUAnt) solution in either DCM or DMSO. A 25 μL (VUAA1) or 25 μL aliquot (VUAnt) was then applied to a filter paper strip and placed inside a glass Pasteur pipette. The compound was then delivered by heating the pipette by a propane or butane torch right at the place of treatment for approximately 1 seconds. The compound was then delivered by puffing the odor cartridges with a controlled 0.5-s stimulus of air (5 mL/s) into a humidified airstream (10 mL/s), which was passed over the sensillum.

Alternatively, 2-5 mgs of solid compound were measured into a glass Pasteur pipette. The glass pipette was then exposed to heat from a micro propane or butane torch for approximately 5 to 10 seconds. The compound was then delivered by puffing the odor cartridges with a controlled 0.5-s stimulus of air (5 mL/s) into a humidified airstream (10 mL/s), which was passed over the sensillum.

### 10. Compound Summary

The compound structures and corresponding numbers are illustrated in Table 1 below.

TABLE 1

| Cmpd. | | |
|---|---|---|
| No. | Abbreviation | Structure |
| 1 | VUAA0 | 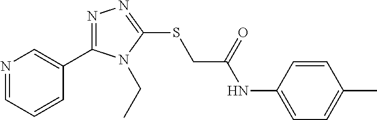 [SMILES: CCn1c(SCC(=O)Nc2ccc(C)cc2)nnc1-c1cccnc1] |
| 2 | VUAA1 | 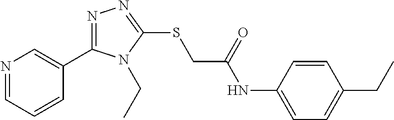 [SMILES: CCc1ccc(NC(=O)CSc2nnc(-c3cccnc3)n2CC)cc1] |
| 3 | VUAA4 | 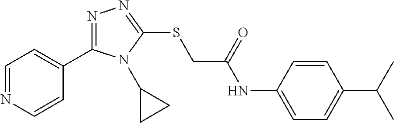 [SMILES: CC(C)c1ccc(NC(=O)CSc2nnc(-c3ccncc3)n2C2CC2)cc1] |
| 4 | VUAnt1 | 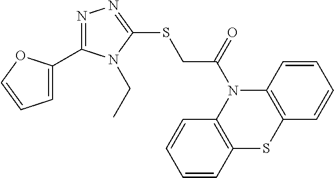 [SMILES: CCn1c(SCC(=O)N2c3ccccc3Sc3ccccc32)nnc1-c1ccco1] |

### 11. Electrophysiology Results

A summary of the results from electrophysiology huffing experiments are shown in Table 2 below. Each compound was subjected to in vivo single sensillar recordings (SSRs) from the maxillary palp of An. gambiae. Puffing refers to use of an airstream only for compound delivery. Huffing refers to the use of an airstream in combination with heat. Specifically, huffing involved direct combustion of the solid compound via propane or butane torch. Capitate peg neuron A (cpA), is a carbon dioxide sensor that does not contain Orco, was used as a negative control. Capitate peg neurons B/C (cpB/C) are neurons known to contain Orco. Carbon dioxide activates only cpA, while 1-octen-3-ol is a known activator of cpB/C.

TABLE 2

| | |
|---|---|
| Puffing | Huffing |

| Cmpd No. | cpA | cpB/C | cpA | cpB/C |
|---|---|---|---|---|
| 1 | − | − | − | +++ |
| 2 | − | − | − | + |
| 3 | − | − | − | − |
| 4 | − | − | + | + |
| 1-octen-3-ol | − | +++ | | |
| CO₂ | +++ | − | | |

− = <10 spikes/s;
+ = 10-20 spikes/s;
++ = 20-40 spikes/s;
+++ = >40 spikes/s

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising thermally volatizing a compound having a structure represented by a formula: 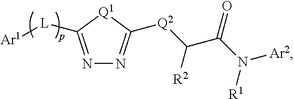
wherein p is an integer selected from 0 and 1;
wherein each of Q¹ and Q² is independently selected from O, S, and NR³;
wherein R³, when present, is selected from hydrogen, C1-C5 alkyl, and Cy¹;
wherein Cy¹, when present, is selected from C1-C5 cycloalkyl and C1-C5 heterocycloalkyl and wherein Cy¹, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino;
wherein L is a divalent organic group having from 1 to 9 non-hydrogen members;
wherein R¹ is selected from hydrogen, optionally substituted C1-C4 alkyl, and an alkyloxy carbonyl group and Ar² is selected from monocyclic aryl, bicyclic aryl, monocyclic heteroaryl, bicyclic heteroaryl, and tricyclic heteroaryl; or
wherein R¹ is taken together with a substituent of Ar² to form a five-, six-, or seven-membered heterocycloalkyl ring;
wherein R² is selected from hydrogen and optionally substituted C1-C4 alkyl; and
wherein Ar¹ is selected from aryl and heteroaryl and wherein Ar¹ is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino;
or a derivative thereof, thereby forming a volatilization product.

2. The method of claim 1, wherein p is 0.

3. The method of claim 1, wherein Ar¹ is a structure having a formula selected from: 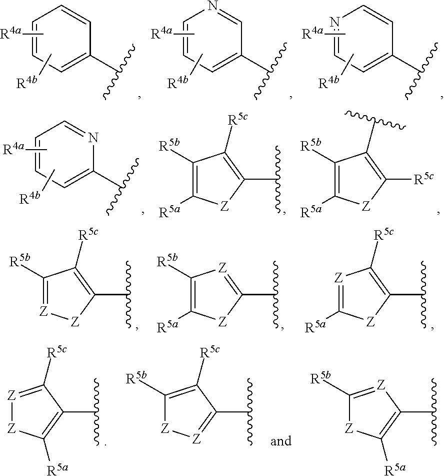
wherein each Z is independently selected from O, S, and NR⁶;
wherein R⁶, when present, is optionally substituted and selected from C1-C5 alkyl, C1-C5 alkenyl, Ar³ and (C1-C4 alkyl)Ar³;
wherein Ar³, when present, is selected from aryl and heteroaryl and wherein Ar³, when present, is substituted with 0, 1, or 2 groups independently selected from halogen, —OH, —SH, —CN, —NO₂, —NH₂, C1-C4 alkyl, C1-C4 alkoxy, C1-C4 alkylamino, (C1-C4)(C1-C4) dialkylamino;
wherein each of R^{4a}, R^{4b}, R^{5a}, R^{5b}, and R^{5c} are independently selected from hydrogen, halogen, —OH, —NO₂, C1-C5 alkyl, C1-C5 alkenyl, carboxyl, carboxy(C1-C4 alkyl), phenyl, benzyl, benzyloxy, amino, C1-C4 alkylamino, C1-C4 dialkylamino, and C1-C4 alkyloxy; or
wherein R^{4a} and R^{4b} are positioned on adjacent carbons and are taken together to be optionally substituted C1-C4 alkanediyl or optionally substituted C1-C4 alkenediyl; or
wherein any two of R^{5a}, R^{5b}, and R^{5c} are positioned on adjacent carbons and are taken together to be optionally substituted C1-C4 alkanediyl or optionally substituted C1-C4 alkenediyl.

4. The method of claim 1, wherein Ar¹ has a structure selected from:

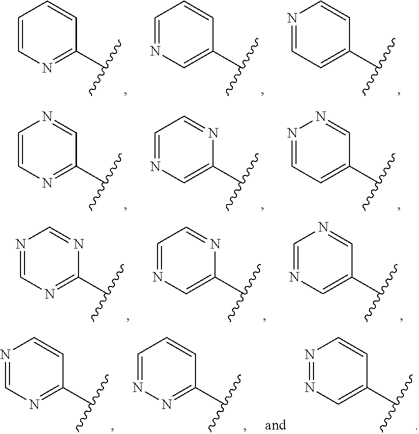

5. The method of claim 1, wherein Ar² has a structure selected from:

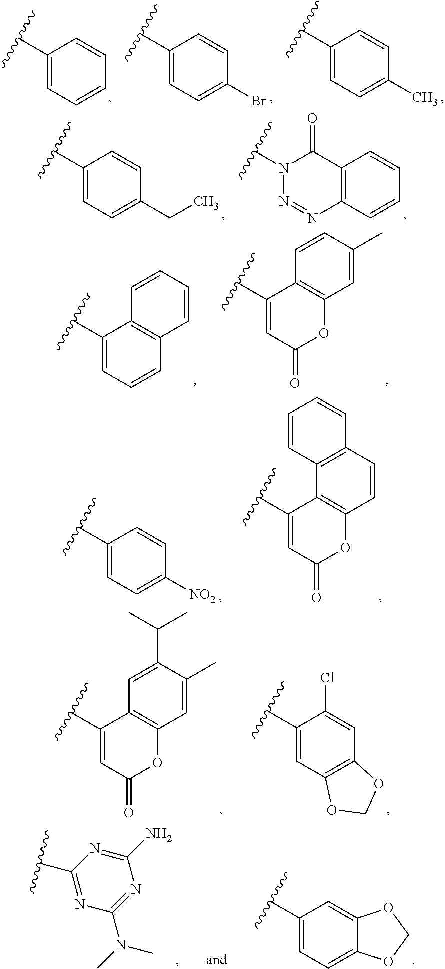

6. The method of claim 1, wherein the compound has a structure represented by a formula:

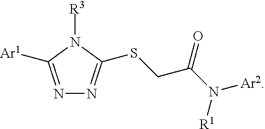

7. The method of claim 1, wherein the compound has a structure represented by a formula:

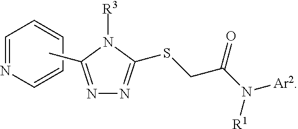

8. The method of claim 1, wherein the compound has a structure represented by a formula selected from:

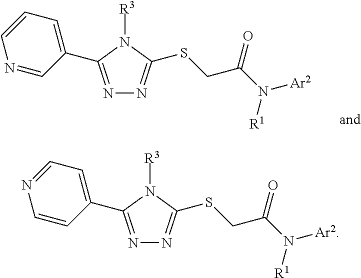

9. The method of claim 1, wherein the compound has a structure represented by a formula: 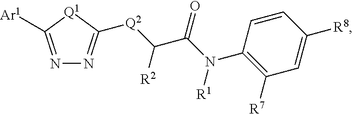
wherein each of R⁷ and R⁸ are independently selected from hydrogen, halogen, —OH, —NO₂, optionally substituted C1-C5 alkyl, and optionally substituted C1-C5 alkenyl.

10. The method of claim 9, wherein the compound has a structure represented by a formula:

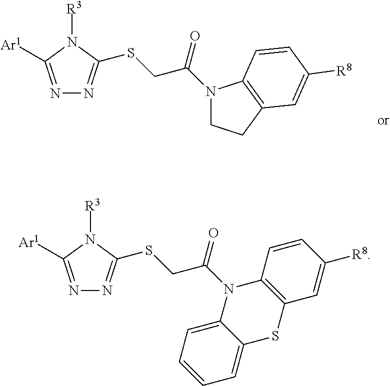

11. The method of claim 1, wherein the compound has a structure represented by a formula:

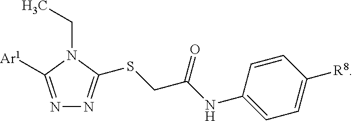

12. The method of claim 1, wherein the compound is selected from:

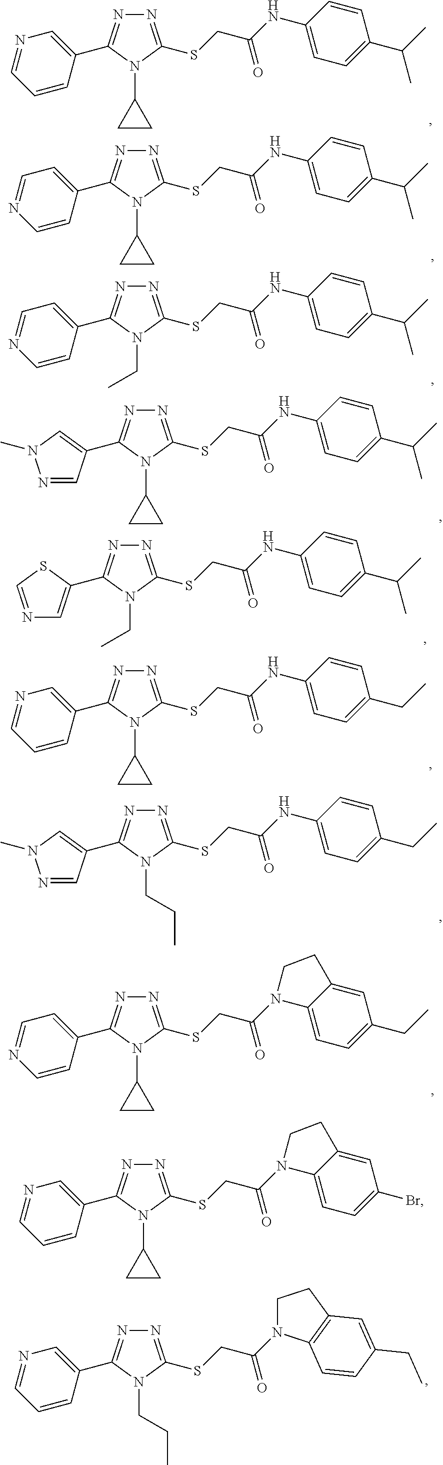

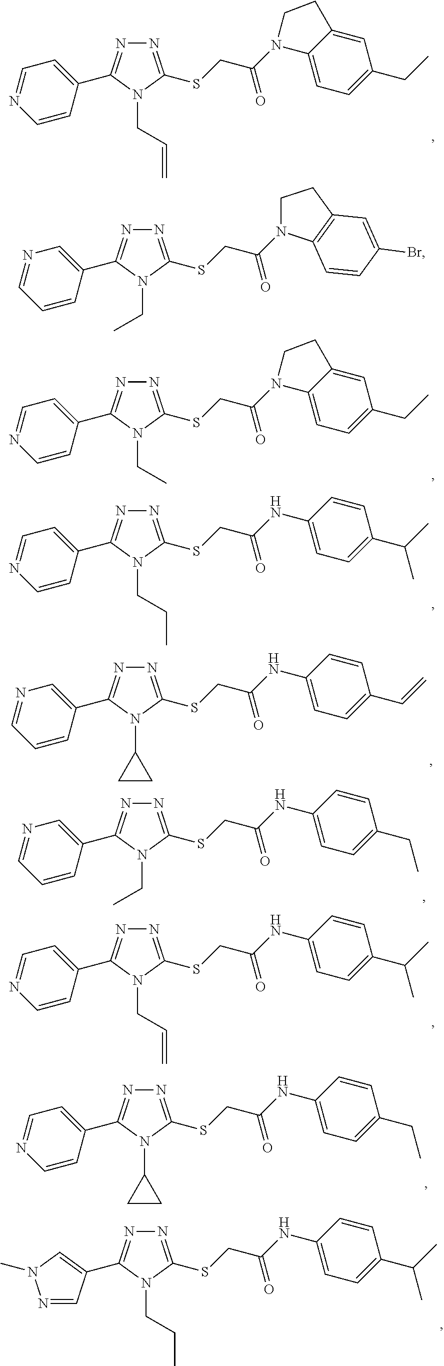

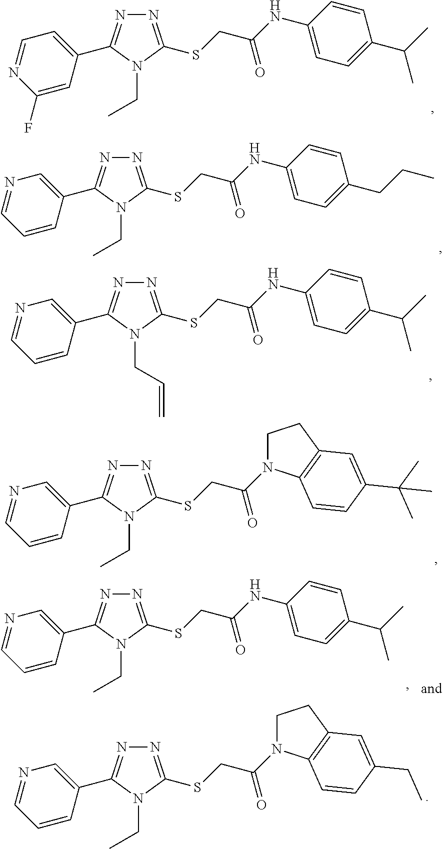

13. The method of claim 1, wherein thermally volatizing is via a torch, ionizing radiation, hot plate, sunlight, electrical pulse, a laser, an oven, a gas heating element, an electric-powered heating element, or microwave irradiation.

14. The method of claim 1, further comprising employing a carrier gas to direct the volatized compound.

15. The method of claim 1, further comprising exposing the volitization product to an insect.

16. A composition produced by the method of claim 1.

17. The composition of claim 16, further comprising an insect repellant.

18. A method comprising thermally volatizing an ORco ion channel agonist, thereby forming a volatilization product, and exposing an ORco ion channel to the volatilization product.

19. A device comprising:
(a) means for thermally volatizing organic compounds; and
(b) an ORco ion channel agonist.

20. The device of claim 19, wherein means for thermally volatizing organic compounds is selected from a torch and a microwave.
